(19) United States
(12) Patent Application Publication
(10) Pub. No.: US 2015/0205327 A1
(43) Pub. Date: Jul. 23, 2015

(54) Bag computer display panel mounts, telecommunications, wearable adaptations and accessories

(71) Applicant: Charles Augustus Daley, III, Rawai (TH)

(72) Inventor: Charles Augustus Daley, III, Rawai (TH)

(21) Appl. No.: 14/121,914

(22) Filed: Nov. 3, 2014

Related U.S. Application Data
(63) Continuation-in-part of application No. 13/987,618, filed on Aug. 15, 2013.
(60) Provisional application No. 61/963,071, filed on Nov. 22, 2013.
(60) Provisional application No. 61/965,626, filed on Feb. 4, 2014.
(60) Provisional application No. 61/998,083, filed on Jun. 18, 2014.
(60) Provisional application No. 61/999,575, filed on Jul. 31, 2014.
(60) Provisional application No. 62/070,524, filed on Aug. 28, 2014.

(51) Int. Cl. G06F 1/16; A45F 3/10

(52) U.S. Cl. CPC G06F 1/163; A45F 3/10; G06F 1/1698; G06F 1/1662; G06F 1/1616

(57) ABSTRACT

Disclosed in this application are: 1) several arrangements and features to slidably and/or pivotally attach a display panel to a holder, cover or computing unit panel on a bag computer; 2) telecommunications accessories and connections for various bag computer alternatives; 3) several wearable display arrangements based on the bag computer front wall and pivoting display panel format with the display propped against the operator and in his view; 4) several accessories for bag computers including a battery, a keyboard, covers and a document holder.

### CROSS-REFERENCE TO RELATED APPLICATIONS

This application is a Continuation-In-Part of U.S. copending patent application Ser. No. 13/987,618, filed on Aug. 15, 2013, the entire teachings of which are incorporated herein by reference.

This application claims the filing benefit under 35 U.S.C. §119(e) of U.S. Provisional Application No. 61/963,071, filed on Nov. 22, 2013, the entire teachings of which are incorporated herein by reference.

This application claims the filing benefit under 35 U.S.C. §119(e) of U.S. Provisional Application No. 61/965,626, filed on Feb. 4, 2014, the entire teachings of which are incorporated herein by reference.

This application claims the filing benefit under 35 U.S.C. §119(e) of U.S. Provisional Application No. 61/998,083, filed on Jun. 18, 2014, the entire teachings of which are incorporated herein by reference.

This application claims the filing benefit under 35 U.S.C. §119(e) of U.S. Provisional Application No. 61/999,575, filed on Jul. 31, 2014, the entire teachings of which are incorporated herein by reference.

This application claims the filing benefit under 35 U.S.C. §119(e) of U.S. Provisional Application No. 62/070,524, filed on Aug. 28, 2014, the entire teachings of which are incorporated herein by reference.

### TECHNICAL FIELD

The present invention relates to a computer designed for mobile use.

### BACKGROUND OF THE INVENTION

In several patents, including U.S. Pat. No. 7,881,048 the idea of a bag adapted to hold computer equipment was developed. This bag included a pivoting display panel on the outside front of the bag, a computing unit and input/output, such as a keyboard. Provision for electrical connections and telecommunications was also anticipated. The bag was pictured being worn by an operator in several different positions.

Of course, improvements to this arrangement may be envisioned.

The idea of a display panel mounted to the bag in a way where the display panel pulls vertically out of a pocket and then pivots into a viewing position was presented application Ser. No. 13/135,446. This led to variations of and/or improvements including The bag computer sliding attachment and retainer type display panel mount (shown on sheets 3, 6, 7, 8 and 9) and the bag computer simplified holder and retainer end to display panel mount (shown on sheets 10 and 11).

The ideas of an outside attached peripheral holder and electrical device connectable to the inside computing unit, bag mounted telecommunications and attachment of inside and outside electrical components through the bag wall were presented in application Ser. No. 11/796,920, U.S. Pat. No. 7,881,048 and U.S. Pat. No. 7,876,558. This led to development and improvements in the bag computer bag mounted communication assembly (shown on sheets 12 to 21)

The idea of the bag computer with its display panel in a vertical operating position being suspended by its strap from the operator with the bag's bottom contacting the operator's body so that the display is in view of the operator was presented in U.S. Pat. No. 7,881,048. This led to development and improvements in bag computer bag bottom operator body interface (shown on sheet 22), in folding wearable computer or remote control viewer (shown on sheets 25 to 29) and in one panel wearable computer (shown on sheet 30 and 31).

The idea of using a two panel computer and holder to attach a display panel to a bag computer mounting was presented in U.S. Pat. No. 7,978,464. This led to the addition of a keyboard and 270 degree hinge to the computer in bag computer pivoting display panel with keyboard (shown on sheet 23).

The idea of the bag computer using a display panel attached to the bag using and intermediate panel was presented in U.S. Pat. No. 7,881,048 and was improved upon in application Ser. No. 13/987,618. This led to further improvement with bag computer intermediate panel to display panel pivoting computer equipment mount (shown on sheet 24).

Bag computer accessories (shown on sheet 32 and 33) includes accessories adapted to use with the bag computer.

The idea of a display panel pivotally attached to the bag outside using a display panel with an axle/bearing hinge attached through the bag wall to a computing unit panel base inside the bag was first presented in application Ser. No. 11/796,920. This led to further improvement with display panel and axle/bearing hinge to computing unit panel mount (shown on sheets 34 to 36).

The idea of improving by simplification the bag computer display panel pivoting and propping, especially in the vertical operating position, originated in U.S. Pat. No. 12/927,884 and continued in application Ser. No. 13/987,618. This led to further improvement with bag computer vertical operating position prop (shown on sheets 37).

The idea of pivotally attaching a display panel to the distal end of a cover pivotally attached to a bag was presented in application Ser. Nos. 12/216,650, 11/796,920 and 13/987,618. A further alternative arrangement/improvement is described in bag computer display panel to cover 360 degree attachment loop mount (shown on sheets 38 and 39).

### BRIEF DESCRIPTION OF THE INVENTION

Bag computer sliding attachment and retainer type display panel mount (sheets 3, 6, 7, 8 and 9).

The arrangement of a bag front holder with a display panel deploying upward out of the holder and pivoting into an operating position while still being attached to the bag may have alternative forms.

A display panel may be equipped with a sliding attachment such as a hole or slot, so that it can slide along a guide. The guide may be a retainer which holds the display panel to the bag and may be a piece of sheet material or filament attached at both ends to a bag or the holder.

Further, the guide may be positioned within a holder so that the display panel is protected in the holder in at least one position along the retainer and exposed for use at another position along the retainer. The display panel may include a prop for holding the display panel at an operating position angle relative to the bag front.

This arrangement may be very simply made with a single material pattern cut to include the holder and retainer. The holder front may be a rigid contact surface and the sides may attach to the bag leaving the top and bottom of the holder open for display panel installation. The retainer can be detachably attached at its distal end for installing or removing the display panel.

Bag computer simplified holder and retainer end to display panel mount (sheets 10 and 11).

The arrangement of a bag front holder with a display panel deploying upward out of a holder and pivoting into an operating position while still being attached to the bag may have several forms. In one arrangement, one end of the retainer is attached to the bag or holder and the other end is attached to the display panel. The attachment to the bag or holder may be inside a holder so that the display panel may be stored for protection within a holder but still may be withdrawn from the holder for use without being detached from the bag. In an operating position, the display panel may include a prop for holding the display panel at an operating position angle relative to the bag front.

To simplify the construction of this arrangement and protect the electrical connection from the bag inside to the display panel, the retainer may have two layers to accommodate an electrical connection channel leading the bottom of the holder and through an electric access opening to the bag interior. The retainer may be integrated into the holder front as several layers.

Bag computer bag mounted communication assembly (sheets 12 to 21).

This shows a bag mounted communication assembly including an audio connector on one side of a bag wall and a telephone handset connector on the other side of this bag wall. The two are attached to each other through the bag wall thus holding the three parts (inside part, bag and outside part) together. The inside and outside parts may be electrically connected and, further, they may be electrically connected to a computing unit panel attached to the bag. The audio connector includes equipment for speaker and/or microphone connection, for example, a reel for an extension wire for a speaker and/or microphone or a wireless transceiver for a remote speaker and/or microphone. The telephone handset connector removably holds and electrically connects a telephone handset to other components. In this way, the telephone may be used alone in the operator's hand, may be connected to the speaker and/or microphone or may be connected to a computing unit mounted elsewhere on the bag. Likewise, computing unit panel may be electrically connected with and communicate with the handset, speaker and/or microphone.

The bag mounted communication assembly may be used with a bag computer include a display panel mounted to the distal edge of a cover/intermediate panel. The display panel may be or include a telephone handset that is removably attached to the cover/intermediate panel (analog of the telephone handset connector). When it is closed, the cover/intermediate panel may be arranged to cover the audio connector, in this case attached directly from the bag outside to the inside mounted computing unit panel though the bag front wall. In this way, the speaker and/or microphone is available to the operator without removing the display panel/handset from the cover/intermediate panel.

In another alternative of the bag mounted communication assembly, the audio connector may be attached to the inside surface of the cover/intermediate panel and electrically connected to the display panel/handset mounted on the cover/intermediate panel and/or to a computing unit panel mounted to the inside of the bag. The speaker and/or microphone is available to the operator as the cover/intermediate panel is opened

Diagrams of the bag mounted communication assembly show the physical and electrical connections between the bag, audio connector, speaker and/or microphone, telephone handset connector, telephone handset, computing unit panel components in the various embodiments.

The diagrams further show that there may be multiple connection paths between the components, for example, one for audio information and another for digital/internet information. The transmitters and/or receivers for the connection paths may be located in one of the several components to ease SIM replacements or component upgrading.

Bag computer bag bottom operator body interface (sheet 22).

The bag computer may be used in a variety of positions relative to the operator's body. One way has the display panel in a vertical operating position with the operator viewing the display over the top of the bag while it is worn. This position may be improved and the display maintained in a better position if the bag bottom is held to the operator's body in specific positions. Thus, the bottom area of the bag may include a fixture adapted to hold the bag bottom to the operator.

Bag computer pivoting display panel with keyboard (sheet 23).

A display panel may include a computer body panel pivotally attached to it. The computer body panel may be held to the bag in typical bag computer fashion using the bag's front wall holder. The hinge between the display panel and computer body may be arranged to pivot at least about 270 degrees. The body panel may include a keyboard on the side facing away from the display panel when the panel and body are closed together in a storage position. In this way, the computer is suitable for bag mounting and, alternatively, may be used with its keyboard on a table when the display panel and body are pivoted into a proper operating position.

Bag computer intermediate panel to display panel pivoting computer equipment mount (sheet 24).

When mounting a display panel to a bag using a cover/intermediate panel, the pivoting computer equipment mount connecting the display panel to the cover/intermediate panel distal edge may be adapted to be durable, to pivot 360 degrees and to allow removal of the display panel. Such a pivoting mount may be of flexible fabric and may be long enough to stretch completely around the distal end of the cover/intermediate panel. The attachment from the flexible fabric attachment flap (retainer) distal end to the display panel may include a matching quick release attachment for removing the display panel. Further, this pivoting computer equipment mount may include a prop to hold the display panel at various angles relative to the cover/intermediate panel.

Folding wearable computer or remote control viewer. (sheet 25 to 29).

In this two panel wearable computer and holder combination the holder protects and holds the computer to a strap that holds the computer/holder combination to the operator's body. The computer has a display panel pivotally attached to a computer body. The computer body is configured to attach to the holder. The holder is open on 2 of 6 sides so that the display panel can be opened to about 180 degrees. Controls may be on the display panel back side which may include protective padding and recessed controls. The computer body may act as a prop or may be just a prop for supporting the display panel on the operator's body and this prop may be adapted at its bottom (e.g. legs) to temporarily adhere to the operator's body. The two panel wearable computer may be suspended from the operator by its strap while its bottom contacts the operator's body and holds the display in an operating position without the use of the operator's hands.

The wearable computer may be in the form of a pivoting prop and strap supporting a display panel in radio communication with a remote radio connected with a separate computer. In this way, the wearable computer is a simple remote control for the separate computer allowing more mobile internet communication around the house or office.

The wearable computer, using the same general shape and function, may take the form of a holder for a removable tablet computer.

One panel wearable computer (sheet 30 and 31).

This is a one panel wearable computer made to be viewed without using the hands and manipulated with dirty hands, for example, in a kitchen. The top front area includes the display and the top back area has the controls where they can be used without smudging the display. The bottom front and back comprise a prop to hold the computer away from the body as a strap, attached between the top and bottom areas, suspends the computer from the operator's neck or shoulder. The computer is one piece, relatively smooth and washable. The bottom edge may be adapted to fit and stick to the operator's body front and the computer top edge may include a spacer so the computer may be temporarily stored against the operator chest without smudging the display.

Bag computer accessories (sheet 32 and 33).

The bag computer may include accessories which may be installed through the bag's top opening. These accessories may include a rigid document container, a battery shaped to fit the bag bottom and a battery canister adapted to connect to a computing unit panel and a battery charger. The bag may have hold down fixtures to keep the accessories in place.

Display panel and axle/bearing hinge to computing unit panel mount (sheets 34 to 36).

The display panel of the bag computer may be mounted via an axle/bearing hinge to the top front of the bag. However, the characteristics of this attachment may be improved if the axle bearing hinge is attached to a computing unit panel attached to the inside surface of the bag front wall. The display panel hinge may have an axle held in two housings, one including the display panel and the other including a flange adapted to attach the hinge to the bag and computing unit panel. The flange attaches through the bag wall to the computing unit to make a solid attachment. The flange may be mounted either to the top edge or the top front side of the computing unit panel.

The hinge for the display panel may include a brake to hold the display panel at angles relative to the bag. The brake may be comprised of a brake contact as part of one of two sleeves attached to either end of the axle. The axle may be moved back and forth along its own axis to engage or disengage the brake contact to the display panel housing and stop or allow rotation of the display panel relative to the mounting flange, computing unit panel and bag.

Bag computer vertical operating position prop (sheet 37).

A display panel stored against the bag front may be pivoted into one or more operating positions including a vertical operating position. The display panel's vertical angle may be increased to more than 180 degrees from the bag outside front and be variable with an improved vertical operating position prop. This prop may be a part of or fixed to an extension prop and, while in a vertical operating position, extend away from the display panel front side and between the display panel and bag to tilt the display panel distal end in a backward direction toward an operator viewing the display from in back of bag and over the of the bag top wall. The vertical operating position prop or the extension prop may be part of a clamp jaw used to attach the bag's display panel retainer to the display panel.

Bag computer display panel to cover 360 degree attachment loop mount (sheet 38 and 39).

A display panel may be attached to a bag by pivotally attaching it to the distal edge of a cover attached to the bag by its proximal edge. The attachment between the distal edge of the cover and the attachment edge of the display panel may be formed by passing the retainer of the cover (e.g. an attachment flap or filament) through the slide attachment (e.g. a bar or a hole) of the display panel. One retainer end is attached to the cover distal end and the other end may be removably attached, also, near the distal end of the cover thus forming a loop with the display panel slide attachment in it. The display panel may pivot 360 degrees and may be quickly removed from the cover. Both the cover and display panel may include electrical equipment (e.g. batteries, radio communications, controls, mountings for removable wireless communications, external recharging connections, etc).

### BRIEF DESCRIPTION OF THE SEVERAL VIEWS OF THE DRAWINGS

FIG. 1A This figure shows details a bag computer with a pull up type holder on the front and the display panel pivoted into an operating position about perpendicular to the bag front.

FIG. 1B This is a bag computer with a pull up type holder on the front and the display panel in the computer equipment storage area.

FIG. 2A This is a bag computer operator wearing the bag computer in a storage position.

FIG. 2B This is a bag computer operator wearing and operating the bag computer in an operating position. His hands are typing.

FIG. 2C This is a bag computer operator wearing and operating the bag computer in an operating position. His hands are operating controls on the display panel.

FIG. 2D This is a magnified view of the operator in FIG. 2C.

FIG. 3 This figure shows details a bag computer with a pull up type holder on the front and the display panel being moved from a storage position in the holder to an operating position about perpendicular to the bag front.

FIG. 4A This is an exploded view of the bag computer in FIG. 3 showing the various parts.

FIG. 4B This is the retainer part from FIG. 4A but instead of a sheet-like attachment flap it is an attachment filament.

FIG. 5 This shows details of the holder shown in FIG. 4A.

FIG. 6A This shows a front side view of the details of a bag computer display panel.

FIG. 6B This shows a side view of the details of a bag computer display panel.

FIG. 6C This shows a back side view of the details of a bag computer display panel.

FIG. 6D This shows the display panel may connect with an electrical connection on a computing unit panel.

FIG. 6E This shows the display panel may connect with an electrical connection on the audio connector.

FIG. 6F This shows the display panel may with an electrical connection on a battery.

FIG. 7A This shows a front side view of the details of a bag computer display panel meant to used with a sliding attachment.

FIG. 7B This shows a side view of the details of a bag computer display panel meant to used with a sliding attachment.

FIG. 7C This shows a back side view of the details of a bag computer display panel meant to used with a sliding attachment. A slide hole is used here instead of the slot in FIG. 7A.

FIG. 8A This is a side cross section view of the bag and display and how the sliding attachment works. The display panel is pulled up as far as possible.

FIG. 8B This is a magnified view of FIG. 8A of the top area of the display panel attachment.

FIG. 8C This is a magnified view of FIG. 8A of the bottom area of the display panel attachment.

FIG. 9A This is a side cross section view of the display panel in an operating position approximately perpendicular to the bag front.

FIG. 9B This is a magnified view of the display panel of FIG. 9A in an operating position showing how the sliding attachment holds the display panel to the bag.

FIG. 10A This is a side cross section view of the display panel in an operating position approximately perpendicular to the bag front. The display panel angle is held using a prop on the display panel.

FIG. 10B This is a magnified view of FIG. 10A showing detail of the pivoting and propping part of the display panel and sliding attachment.

FIG. 11A This is a side cross section view of the display panel in a storage position inside the holder.

FIG. 11B This is a magnified view of FIG. 11A showing detail of top area of the display panel and holder.

FIG. 11C This is a magnified view of FIG. 11A showing detail of bottom area of the display panel and holder.

FIG. 12 This is a perspective view of the bag computer showing the position of the cross section for figures.

FIG. 13A This is a side cross section view of the bag and display and how the sliding attachment works. The display panel is pulled up as far as possible. The sliding attachment is her attached to the bag instead of the holder. Compare to FIG. 8A.

FIG. 13B This is a magnified view of FIG. 13A showing detail of top area of the display panel and holder. The sliding attachment is her attached to the bag instead of the holder. Compare to FIG. 8B.

FIG. 13C This is a magnified view of FIG. 13A showing detail of bottom area of the display panel and holder. The sliding attachment is her attached to the bag instead of the holder. Compare to FIG. 8C.

FIG. 14A This is a side cross section view of the display panel in an operating position approximately perpendicular to the bag front. The sliding attachment is here attached to the bag instead of the holder. Compare to FIG. 9A.

FIG. 14B This is a magnified view of the display panel of FIG. 4A in an operating position showing how the sliding attachment holds the display panel to the bag. The sliding attachment is here attached to the bag instead of the holder. Compare to FIG. 9B.

FIG. 15A This is a side cross section view of the display panel in an operating position approximately perpendicular to the bag front. The display panel angle is held using a prop on the display panel. The sliding attachment is here attached to the bag instead of the holder. Compare to FIG. 10A.

FIG. 15B This is a magnified view of FIG. 15A showing detail of the pivoting and propping part of the display panel and sliding attachment. The sliding attachment is here attached to the bag instead of the holder. Compare to FIG. 10B.

FIG. 16A This is a side cross section view of the display panel in a storage position inside the holder. The sliding attachment is here attached to the bag instead of the holder. Compare to FIG. 11A

FIG. 16B This is a magnified view of FIG. 16A showing detail of top area of the display panel and holder. The sliding attachment is here attached to the bag instead of the holder. Compare to FIG. 11B.

FIG. 16C This is a magnified view of FIG. 16A showing detail of bottom area of the display panel and holder. The sliding attachment is here attached to the bag instead of the holder. Compare to FIG. 11C.

FIG. 17 This is a cross section side view of the display panel being installed onto a sliding attachment (flexible fabric flap).

FIG. 18 This is a cross section side view of further progress of the display panel being installed onto a sliding attachment.

FIG. 19A This is a cross section side view of the display panel already installed with the sliding attachment being attached to the holder near its bottom.

FIG. 19B This is a magnified view of the attachment of the sliding attachment near the bottom of the holder.

FIG. 20 This is a cross section side view of the display panel already installed with the sliding attachment attached to the bag wall instead of the holder.

FIG. 21 This is a plan view of a piece of material cut to produce the holder and sliding attachment assembly for attachment to a bag front.

FIG. 22 This is again the installation of the sliding attachment to the display panel. In this case the sliding attachment extends downward from the bolder instead of upward.

FIG. 23 This shows the sliding attachment installed upward through the holder and about to pass through the slot in the display panel.

FIG. 24 This is the display panel and sliding attachment already installed and about to be attached to the holder.

FIG. 25A This shows that the end of the sliding attachment may be attached to the bag front instead of to the holder.

FIG. 25B This is a magnified view of the retainer top end and display panel slide attachment area of FIG. 25A.

FIG. 26A This is an exploded view of the bag computer with the pull up holder using a one attached retainer to mount the display panel. Details of the parts are shown.

FIG. 26B This is an exploded view of an alternative holder which is a ring with no front, sides or bottom.

FIG. 27 This shows the inside of the holder shown in FIG. 26A.

FIG. 28A This is a retainer attaching the display panel to the bag. The retainer has 3 layers with an electrical connection between.

FIG. 28B This is a magnified view of the retainer distal end and display panel attachment edge clamp connection area.

FIG. 29A This shows that the two layer retainer and the holder front may be run parallel to the bag and connected together with the bag.

FIG. 29B This is a magnified view of the retainer and holder attaching to the bag.

FIG. 30A This shows the display panel and electrical connection separated from the bag and retainer.

FIG. 30B This is a magnified view of the electrical connection to the display panel.

FIG. 30C This is a magnified view of the electrical connection designed to match a computing unit inside the bag.

FIG. 31A This shows the display panel propped in an operating position.

FIG. 31B This is a magnified view of the retainer extending over the top of the holder and suspending the display panel in an operating position.

FIG. 31C This is a magnified view showing that the retainer may be attached (riveted) to the holder front wall. A rigid contact surface may also be present.

FIG. 32A This shows the display panel in a storage position inside the holder.

FIG. 32B This is a magnified view showing the two layer retainer around the display panel attachment edge and the attachment of the retainer and holder front to the bag.

FIG. 32C This is a magnified view showing that the retainer is attached to the holder front about half way into the holder. Although the retainer is continuous from the bag front, it folds over at the attachment with the holder front.

FIG. 33 This is the bag computer with a side pocket to hold an electrical device holder.

FIG. 33A This shows the telephone handset connector may alternatively include a matching wireless microphone/speaker headset.

FIG. 34 This shows the bag with the front wall removed so the outside electrical device holder and an inside speaker and/or microphone holder (attached together and to the bag through the bag wall) are both visible.

FIG. 35 This shows the side of the electrical device holder that attaches to the bag and inside speaker microphone holder.

FIG. 36 This is the same bag of FIG. 34 but turned to show the inside surface of the side wall attaching to the electrical device holder and speaker microphone holder.

FIG. 37 This shows the side of the speaker microphone holder that attaches to the bag and outside electrical device holder.

FIG. 38 This shows the electrical device holder and speaker microphone holder assembled with the bag and the speaker microphone and wire withdrawn from its holder and out of the bag's top opening.

FIG. 39 This is a front view of the bag with a profile side view of the side pockets showing how an electrical device may enter the holder in a side pocket.

FIG. 40 This is a front view of the holder that attaches to the bag wall. It shows the cross section line for other holder side view drawings.

FIG. 41A This is a cross section side view of the holder with the electrical device withdrawn.

FIG. 41B This is a cross section side view of the holder with the electrical device half way inserted.

FIG. 41C This is a cross section side view of the holder with the electrical device fully inserted.

FIG. 42A This is a cross section side view of the holder attached to the bag wall and with the electrical device half way inserted and the pocket cover open.

FIG. 42B This is a cross section side view of the holder attached to the bag wall and with the electrical device fully inserted and the cover closed.

FIG. 43A This is the holder shown in front view.

FIG. 43B This is the holder shown in side view at cross section A/B.

FIG. 43C This is the holder shown in top view.

FIG. 44 This is a bag computer with the display panel mounted to the bag front wall (outside) with a cover/intermediate panel. The speaker/microphone holder is seen attached to the bag front so the cover/intermediate panel will cover it when it's closed.

FIG. 45 This is the bag of FIG. 44 with the cover/intermediate panel, display panel and the speaker/microphone holder removed. A wireless audio headset is also shown.

FIG. 46A This shows a computing unit panel for mounting to the inside surface of the bag front wall. It is adapted to match and hold to the bag and outside speaker/microphone holder. It shows the surface facing the bag front wall.

FIG. 46B This shows a computing unit panel for mounting to the inside surface of the bag front wall. It is adapted to match and hold to the bag and outside speaker/microphone holder and related electronics. It shows the surface facing away from the bag front wall.

FIG. 47 This shows the side of the speaker/microphone holder meant to attach to the bag and computing unit.

FIG. 48 This shows the inside surface of the bag front wall with a support structure to hold the computing unit panel and the openings through the wall for attachment to the speaker/microphone holder on the outside.

FIG. 49 This shows FIG. 48 with the computing unit panel mounted to the wall.

FIG. 50 This shows that the speaker/microphone holder may be mounted to the inside of the cover/intermediate panel instead of to the bag front wall.

FIG. 51A This shows a front view of a reel and case suitable for use in storing wire in the speaker and/or microphone holder.

FIG. 51B This shows a side view of a reel and case suitable for use in storing wire in the speaker and/or microphone holder.

FIG. 52A This shows a front view of a second part of the reel case for the speaker/microphone holder. It has electrical connections including one that rotates.

FIG. 52B This shows a side view of a second part of the reel case for the speaker/microphone holder. It has electrical connections including one that rotates.

FIG. 53 This shows more detail of the reel and case for speaker/microphone wire.

FIG. 54 This shows an electrical connection male part suitable for a rotating connection in the reel and case for the speaker/microphone,

FIG. 55 This shows a front view of a pulley style wire storage device with the mechanism visible. The speaker and/or microphone wire collects and stores on two pulleys (top and bottom).

FIG. 56 This shows a side view of the pulley style wire storage device with the wire removed to better show the pulley arrangement. The pulleys are far apart for storing much wire.

FIG. 57A This is the same view as FIG. 56 but here the pulleys are close together because much wire is withdrawn from the holder. The elastic rewind band is shown with a dotted line.

FIG. 57B This is a view of the bottom pulleys of FIG. 57A. They are mounted on a carriage that slides up and down the case.

FIG. 58 This is a top view of the holder case showing the wire extraction hole which may be shaped to jam wire and stop wire rewinding.

FIG. 59 This is a diagram showing the relations of the bag, computing unit panel, audio connector, telephone handset connector and telephone handset along with their communication linkage in the arrangement of FIGS. 34 to 38.

FIG. 60 This is a diagram of the arrangement of FIG. 59 except that the audio connector is outside the bag and the telephone handset and handset connector are inside the bag.

FIG. 61 This is a diagram showing the relations of the bag, computing unit panel, audio connector, telephone handset connector and telephone handset along with their communication linkage in the arrangement of FIGS. 44 to 49.

FIG. 62 This is a diagram showing the relations of the bag, computing unit panel, audio connector, telephone handset connector and telephone handset along with their communication linkage in the arrangement of FIG. 50.

FIG. 63 This is a diagram showing the relations of the bag, computing unit panel, audio connector, telephone handset connector and telephone handset along with their communication linkage and showing multiple transceivers and communication linkages including digital linkage as well as audio.

FIG. 63A This is a telephone handset removed from and independent from the telephone handset connector of FIG. 63.

FIG. 64A This is a perspective drawing showing the physical connection of the outside telephone holder, bag and inside speaker/microphone holder

FIG. 64B This is a perspective drawing showing the physical connection of the outside telephone holder, bag and inside wireless transmitter receiver unit for a remote speaker/microphone.

FIG. 65 This is the bag computer showing that the operator may view the display from in back and over the top of the bag.

FIG. 66A This is a front view of the bag computer operator wear the bag computer in a storage position.

FIG. 66B This is a side view of the bag computer operator wear the bag computer in a storage position.

FIG. 67A This is a side view of the bag computer operator wear the bag computer in an operating position viewing the display from in back and over the top of the bag with the bag bottom resting against his belt area. His hands are operating the display controls for the computer.

FIG. 67B This is a side view of the bag computer operator wear the bag computer in an operating position viewing the display from in back and over the top of the bag with the bag bottom resting against his chest area. He is viewing the display without using his hands.

FIG. 68A This is a view of the bag computer showing its bottom including attachments to hold the bag to the operator's body.

FIG. 68B This is a view of the bag bottom of FIG. 68A with alternative types of bag bottom attachments to hold the bag to the operator's body.

FIG. 68C This is a view of the bag bottom of FIG. 68A with further alternative types of bag bottom attachments to hold the bag to the operator's body.

FIG. 69A This is a bag computer with a holder on its front designed to hold a panel pivotally attached to a display panel.

FIG. 69B This is the display panel with pivotally attached mounting panel for mounting to the bag in FIG. 69A. It can be seen the display faces upward in and operating position and away from the bag when in a storage position.

FIG. 70 This is a computer for mounting to a bag. It has two pivotally attached panels (display panel and body panel) and is here shown in a storage position with the display facing away from the body panel.

FIG. 71 This is the computer of FIG.70 opened into an operating position (about 150 degrees).

FIG. 72 This is the computer of FIG. 71 further pivoted to about 240 degrees, removed from the bag holder and positioned to be set on a table.

FIG. 73 This is the computer of FIG. 72 turned to make the keyboard and display more visible. Keyboard and display details are shown.

FIG. 74 This is the bag computer showing the line of cross section for FIGS. 75 to 78. The cover/intermediate panel (8) is shown on the bag front. This is the same style of bag computer as shown in FIG. 44.

FIG. 75A This is a side view cross section (at A/B of FIG. 74) of the cover/intermediate panel and display panel (bag missing) with the display panel in a storage position parallel to and next to the inside surface of the cover/intermediate panel.

FIG. 75B This is a magnified view of the FIG. 75A pivoting mount area showing the flexible fabric attachment flap/retainer and its attachments to the display panel and to the cover/intermediate panel.

FIG. 76A This is a side view cross section (at A/B of FIG. 74) of the cover/intermediate panel and display panel (bag missing) with the display panel in a operating position parallel to and next to the outside surface of the cover/intermediate panel. Note that the display panel has rotated 360 degrees from FIG. 75A.

FIG. 76B This is a magnified view of the FIG. 76A pivoting mount area showing the flexible fabric attachment flap/retainer and its attachments to the display panel and to the cover/intermediate panel.

FIG. 77A This is a side view cross section (at A/B of FIG. 74) of the cover/intermediate panel and display panel (bag missing) with the display panel in an operating position and propped at about perpendicular to the cover/intermediate panel.

FIG. 77B This is a magnified view of the FIG. 77A pivoting mount area showing details of the flexible fabric attachment flap/retainer, its attachments to the display panel and to the cover/intermediate panel and the display panel prop.

FIG. 78A This is a side view cross section (at A/B of FIG. 74) of the cover/intermediate panel and display panel (bag missing) with the display panel in an operating position and propped at about perpendicular to the cover/intermediate panel. In this case, the display panel is quickly and easily removable from the pivoting mount assembly.

FIG. 78B This is a magnified view of the FIG. 78A pivoting mount area showing details how the display panel may be removable from the cover/intermediate panel, attachment flap/retainer and display panel to attachment flap fitting using the matching fittings shown.

FIG. 79A This is a view of the holder for a two panel computer showing various details including the basic holder and parts.

FIG. 79B This is a view of the holder for a two panel computer showing various details including the holder with additional walls, cover flaps and attachments.

FIG. 79C This is a view of the holder for a two panel computer showing various details including the holder with strap, attachments, optional front wall and holder bottom to operator attachment.

FIG. 79D This is a view of the holder for a two panel computer showing various details including the holder with extended and padded walls, removal slot and computer mounting pocket/band with attachments.

FIG. 80A This is the two panel computer made for the holder of FIG. 79. It shows various details with the computer panels closed for storage.

FIG. 80B This is the two panel computer made for the holder of FIG. 79. It shows various details with the computer panels open for use.

FIG. 81 This is the computer and holder of FIG. 79 and FIG. 80 assembled and in an operating position.

FIG. 82A This is the computer a holder assembled in the closed position.

FIG. 82B This is the computer a holder assembled in an operating position.

FIG. 83A This is the operator of the holder and bag viewing the computer display with no hands.

FIG. 83B This is the operator of the holder and bag operating the computer with his hands.

FIG. 84A This view show more details and options for the two panel computer.

FIG. 84B This view show more details and options for the two panel computer.

FIG. 84C This shows the opposite side of FIGS. 84A and 84B. It shows more details and options for the two panel computer.

FIG. 85 This view shows the computer with the display panel on the opposite side of the display panel. Compare to FIG. 84C. This view also shows that an operator body prop with no electronics may substitute for the body panel. This figure also shows that the display panel may include wireless communications to a separate computer.

FIG. 86 This shows the display panel, alternatively, may be mounted to the body with the display panel sliding in and out of the body or operator body prop (not pivoting).

FIG. 87A This is a holder for a tablet computer to convert it into a wearable computer. It is a single piece holder with grasping part on top and prop part on the bottom.

FIG. 87B This is a holder for a tablet computer to convert it into a wearable computer. It is a two part holder made of wire with the same parts pivotally attached together.

FIG. 87C This is a magnified portion of FIG. 87A showing a molded-in hinge for display panel angle adjustment.

FIG. 88A This is a wearable computer with a view of the front side of the computer.

FIG. 88B This is a wearable computer with a view of the back side of the computer.

FIG. 88C This is a wearable computer with a magnification of the bottom edge of the computer.

FIG. 89 This is a front view of the wearable computer of FIG. 87 showing various details.

FIG. 90A This is a side view of an operator wearing the wearable computer showing the computer in an operating position.

FIG. 90B This is a side view of an operator wearing the wearable computer showing the computer temporarily in a storage position against the operator's body.

FIG. 91A This is a front view of an operator wearing the wearable computer showing the computer in an operating position and view.

FIG. 91B This is a front view of an operator wearing the wearable computer showing the operator's apron with attachments matching the computer bottom visible after the computer was removed.

FIG. 92A This is a view of the bag computer showing the top opening leading to the bag interior for accessory installation and a cover flap attached near the top of the bag back wall.

FIG. 92B This is a views of the bag computer showing a cover flap attached near the center of the bag top wall.

FIG. 93 This is an exploded view of the bag bottom showing the bag bottom removed and the shaped battery showing.

FIG. 94 This is an alternative battery canister for standard batteries and adapted to attach to the computing unit panel.

FIG. 95 This is a battery charger adapted to fit the electrical connection terminal of the shaped battery and the canister battery made for the computing unit panel.

FIG. 96 This is a rigid document holder fitting the bag computer.

FIG. 97 This is the bag computer with the top and front walls removed so the interior can be seen. The bag interior includes hold down fixtures for the battery and rigid document holder.

FIG. 98 This is the bag adapted to hold a computing unit panel in the inside and the pivoting display panel on the outside of the front wall.

FIG. 99 This is the display panel assembly dissected to show the display panel, mounting flange, axle and axle housings.

FIG. 100A This figure shows the inside of the bag front wall and the computing unit panel for mounting to it.

FIG. 100B This figure shows the opposite side of the panel (front).

FIG. 100C This figure shows how the display panel assembly and its attachment align with the front wall for mounting.

FIG. 101 This is the bag with the display panel assembly mounted to the bag front wall.

FIG. 102 This is the bag adapted to hold a computing unit panel in the inside and the pivoting display panel on the outside of the top wall.

FIG. 103A This figure shows the inside of the bag front wall and the computing unit panel for mounting to it.

FIG. 103B This figure shows how the display panel assembly and its attachment align with the top wall and computing unit panel for mounting.

FIG. 104 This is the bag with the display panel assembly mounted to the bag top wall.

FIG. 105 This is a cross section view (at a/b of FIG. 98) of the disassembled parts of the hinge part of the display panel assembly for bag mounting. It shows parts used for holding the angle of the display panel relative to the bag.

FIG. 106A This is a cross section view (at a/b of FIG. 98) of the assembled parts of the hinge part of the display panel assembly for bag mounting of FIG. 104. It shows the hinge brake engaged.

FIG. 106B This is a cross section view (at a/b of FIG. 98) of the assembled parts of the hinge part of the display panel assembly for bag mounting of FIG. 104. It shows the hinge brake disengaged.

FIG. 106C This shows a perpendicular cross sections at a first point along the hinge.

FIG. 106D This shows a perpendicular cross sections at a second point along the hinge.

FIG. 106E This shows a perpendicular cross sections at a third point along the hinge.

FIG. 107 This is the front side of a display panel including vertical operating position props for angle adjustment of the display panel's vertical operating position on the bag.

FIG. 108A This is a cross section view of the display panel of FIG. 106 at a/b. It shows the vertical operating position prop projecting from the display panel extension prop.

FIG. 108B This is a cross section view of the display panel of FIG. 106 at a/b. It shows that the vertical operating position prop and/or the extension prop may be a part of a jaw used as part of a clamp to attach the display panel retainer to the display panel.

FIG. 109A This is a cross section view of the display panel of FIG. 106 at a/b. It shows the display panel propped against the bag at an angle greater than 180 degrees.

FIG. 109B This is a cross section view of the display panel of FIG. 106 at a/b. It shows the same as FIG. 109A but the vertical operating position prop has been move to a different place on the bag front.

FIG. 110A This is the bag computer with a display panel with vertical operating position prop and in an operating position.

FIG. 110B This is a magnification of FIG. 109A to show detail including the vertical operating position prop.

FIG. 111A This is the bag computer with a display panel with vertical operating position prop and in a storage position.

FIG. 111B This is a magnification of FIG. 110A to show detail including the vertical operating position prop.

FIG. 112 This is the bag computer with a pivoting cover and a pivoting display panel attached to the distal end of the cover. A wireless audio headset is shows on the outside of the cover.

FIG. 113A This is the first of a series of 5 views showing the display panel being attached to the cover distal end and being installed and moved into operating and storage positions. This view is installing 1.

FIG. 113B This is the second of a series of 5 views showing the display panel being attached to the cover distal end and being installed and moved into operating and storage positions. This is installing 2.

FIG. 113C This is the third of a series of 5 views showing the display panel being attached to the cover distal end and being installed and moved into operating and storage positions. This is installed and out of the cover.

FIG. 113D This is the fourth of a series of 5 views showing the display panel being attached to the cover distal end and being installed and moved into operating and storage positions. This is installed and propped in an operating position.

FIG. 113E This is the fifth of a series of 5 views showing the display panel being attached to the cover distal end and being installed and moved into operating and storage positions. This is installed and in the storage position.

FIG. 114A This is a magnified view of FIG. 113A.

FIG. 114B This is a magnified view of FIG. 113B.

FIG. 114C This is a magnified view of FIG. 113C.

FIG. 114D This is a magnified view of FIG. 113D.

FIG. 114E This is a magnified view of FIG. 113E.

FIG. 115 This is the cover and display panel removed from the bag and turned so the inside surface and electrical connections are showing. A wireless audio headset is shows on the inside of the cover.

### DETAILED DESCRIPTION OF THE INVENTION

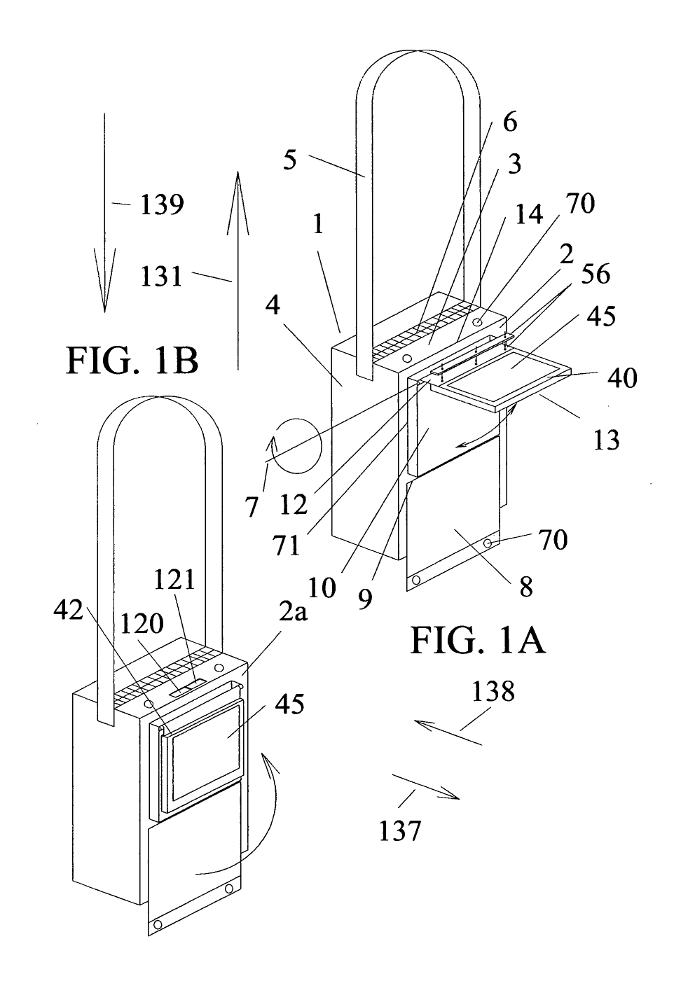

Shown in FIG. 1A and FIG. 1B, this computer includes a bag 1 which may have a front wall 2, a top wall 3, and one or more side walls 4. Each wall has an inside surface and outside surface (the outside surface of the bag front wall is shown at 2a in FIG. 1B) and the bag walls may enclose a bag interior. The top wall may have an opening 6 to access the interior of the bag and this opening may have a closure such as a zipper, hook and loop or buttons. The bag may have a carrying strap 5 for attaching the bag to the bag wearer and computer operator.

The computer uses a pivoting computer equipment mount (abbreviated PCEM) to pivotally attach the display panel 13 to the bag. The PCEM is configured to deploy the display panel by pivoting along a horizontal axis 7 parallel to the bag front wall into various angles relative to the bag front wall and suitable for viewing by the operator. The PCEM may be an axle/bearing combination, flexible fabric or other means to attach computer equipment, such as a display panel, to the bag while allowing it to pivot by its attachment edge 42. The PCEM may be a retainer 12, especially when it includes several sections or pivoting axes. The PCEM (or a retainer) may be made of flexible fabric such as a flexible fabric attachment flap or a flexible fabric attachment filament. The display panel pivoting may be located at the top of the computer equipment storage area near the junction 14 of the top and front bag walls (also called the top or top edge 14 of the bag front wall). The display panel may attach to the retainer 12 using a pair of jaws 56 or clamp matching the retainer and located on the display panel near its attachment edge 42.

The display panel has a front side 40 and the display 45 is located on the front side of the display panel. Thus, as shown in FIG. 1A, when the display panel is approximately perpendicular to the bag front, the display 45 is facing upward toward the bag wearer and computer operator. The upward direction is from the bottom end of the bag toward the top end of the bag and is illustrated by the upward arrow 131, the downward direction 139 being the opposite direction. Shown in FIG. 1B, when the display panel is hanging downward approximately parallel to the bag front 2a in a vertical down position, the display 45 is facing away 137 from the bag front wall. When thus stored, the display panel is located in the computer equipment storage area 71, a portion of the outside surface of the bag front wall, shown here with the support structures filling the majority of this area. When stored in the support structure holder, the display panel's display may face toward 138 the bag front wall. The bag may include one or more heat dissipation outlets 120, sound outlets 121 or a combination of the two and these may be located in the top wall, front wall or other bag wall. These align with a computing unit panel mounted in the bag interior and allow heat and sound from it to exit the interior of the bag.

The bag may include a support structure 10 found in the computer equipment storage area. The bag may include a pivoting cover 8, such as a flap or rigid shaped cover matching the computer equipment in the computer equipment storage area. The pivoting cover may be attached to the bag near the bottom 9 of the computer equipment storage area and can pivot from an operating position hanging down about parallel to the bag front wall to a storage position upward and covering the computer equipment storage area and any equipment in it. The pivoting cover may include matching attachments 70 to hold it in the storage position.

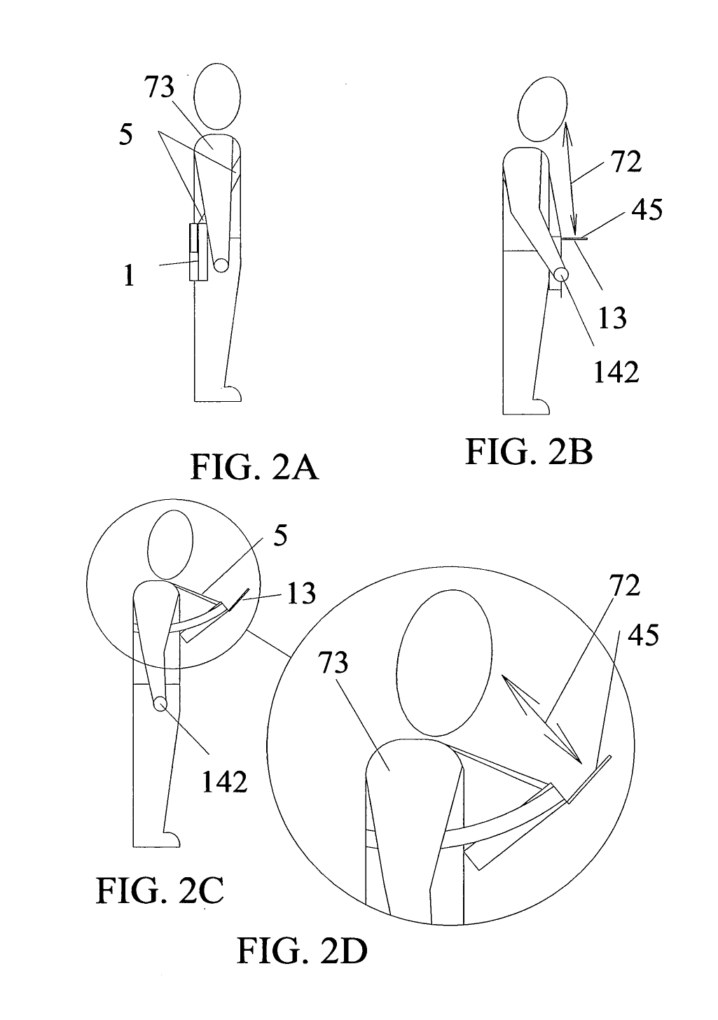

Shown in FIG. 2A, when the computer is in storage position and not in use, the bag wearer and computer operator 73 may wear the bag 1 by its carrying strap 5 like a normal shoulder bag or other personal strap carried bag. When in operating position, for example FIGS. 2B, 2C and 2D (magnified), the bag is positioned in front of the operator with the display panel 13 pivoted on the horizontal axis so that the display 45 is in the line of sight 72 of the operator. The bag computer may be operated with an operator hand 142 (FIG. 2B) or the bag and display panel may be held in place without using any hands (FIG. 2C).

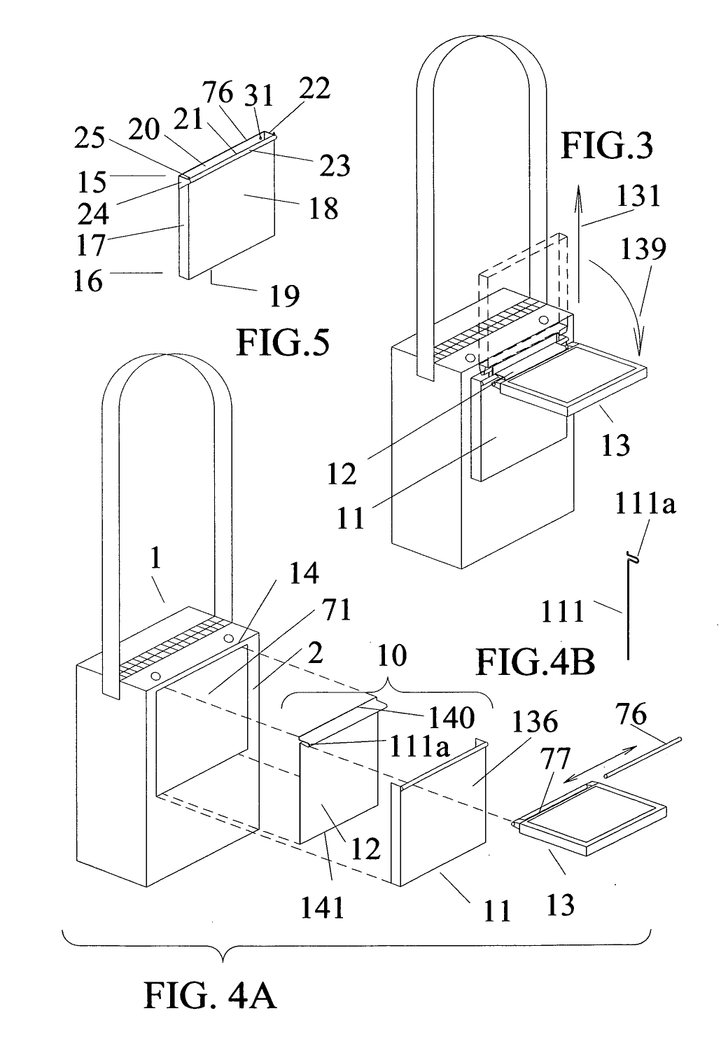

As shown in FIG. 3 is the bag computer sliding attachment and retainer type display panel mount used to deploy the display panel 13 from a storage position into an operating position. The display panel, retained to the bag and/or holder by a retainer 12 (a type of pivoting computer equipment mount and may be an attachment flap), slides upward 131 out of the storage position in the holder 11 on the bag front wall (display panel shown in dotted lines) and is then pivoted downward 139 into an operating position useful for viewing by the operator.

In the exploded view FIG. 4A, the support structure 10 is designed to attach to the outside of the bag's 1 front wall 2. Its purpose includes assisting in storing the display panel to the bag, protecting the display panel when stored, and assisting in deploying the display panel from its storage position to an operating position.

The support structure is located in the computer equipment storage area 71, a portion of the outside surface of the bag front wall, so that when the display panel is moved into operating position it is positioned near the junction 14 of the top and front walls (also known as the top end or top edge of the bag front wall) so that the display is as close as possible to the operator wearing the bag and the apparent size of the display is maximized.

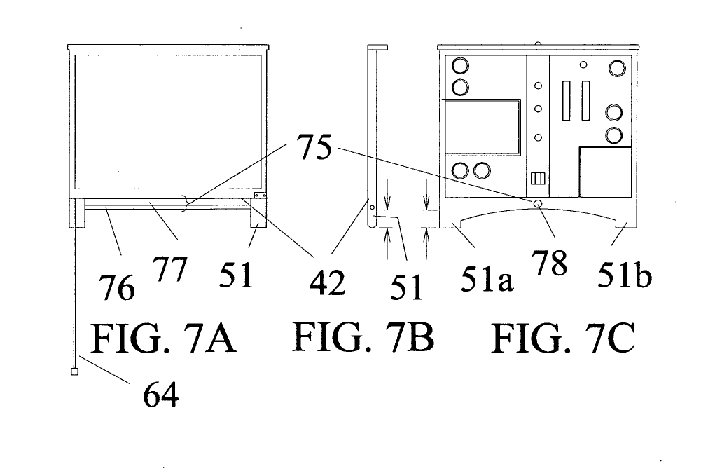

The support structure 10 may include a holder part 11 and a retainer part 12. The holder part may be any construction that allows the display panel 13 to slide into and out of the holder from the side closest to the junction of the bag top and bag front walls (holder top end). The holder front has an outside surface 136. The retainer (shown as an attachment flap in this figure) has a top end 140 and a bottom end 141 and both ends are designed to be fixed to either the bag or the holder when ready for use (shown in this figure for attachment to the bag wall). Along with attaching the display panel to the bag, the retainer also serves as a guide along which a display panel, including a slide attachment which functions as a traveler, can slide and be directed upward without pivoting and out of its storage position. The retainer also allows a pivoting motion which allows the display, once out of the holder, to be pivoted into an operating position in the view of the operator. In this figure, the area of display panel attachment to the retainer is shown as a loop or fold of retainer material 111a which passes through the display panel slide attachment slot. The display panel may be slidably attached to the retainer using a slide attachment such as a slot 77 and a bar 76 which may be removable for installation of the retainer (see FIG. 7A).

FIG. 4B shows that the retainer may be an attachment filament 111 that attaches by both ends to the bag or holder and passes (here shown as a sliding loop 111a in the retainer attachment filament) through the display panel's slide attachment (see FIG. 7C) and may be an alternative for the attachment flap retainer 12 shown in FIG. 4A.

Alternatively, two retainers (of this type) located on the two side walls of the holder may be used with two slide attachments on the right and left edges of the display panel.

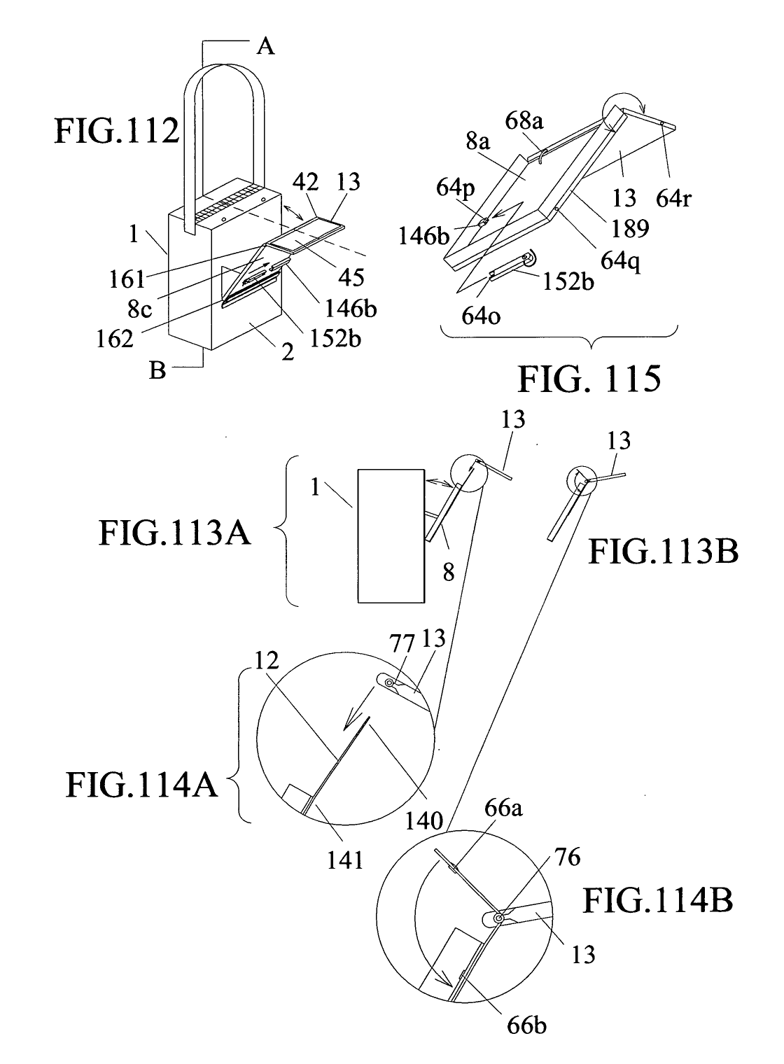

This sliding attachment and retainer type display panel mount may be used to attach and store the display panel to a pivoting cover, in which case the holder is a cover (see FIGS. 112 to 115, cover 8).

Shown in FIG. 5, is the holder top end 15. The end of the holder distal from the junction of the bag top wall and bag front wall is the holder bottom end 16. The holder may have side pieces 17 to attach the holder front 18 to the bag.

The holder may be pocket like and may be made of flexible material, such as bag cloth and may be sewn, glued or bonded to the bag. The holder may be made of a rigid material, such as plastic or metal. The holder may include a back side 76 to protect the display panel from forces from inside the bag and the holder may include attachments such as mounting holes 31 to fix the holder to the bag. The holder may be bracket-like, ring-like or rail-like so that a portion of the display is left exposed, especially at its the bottom or front.

The bottom side 19 of the holder may be extended so that the holder is longer than the display panel. This produces a volume of space at the bottom of the holder and this area may be used as the bottom end retainer storage area for excess retainer material.

The holder may have a holder top end opening 20 for the display panel to slide into and out of the holder. The top end of the holder front may have a holder top front edge 21. The top end of the holder side pieces may have holder top side edges 22.

The top front edge of the holder may include a top front edge reinforcement bar 23 to keep the top front edge straight even under a load, to provide for an axis for the display panel to pivot around and to smoothen the holder top front edge to accommodate retainer material. The top side edge may also be reinforced with top side edge reinforcements 24 in such a way to keep the reinforcement bar on the top front edge from collapsing against the front wall and closing the opening in the top end of the holder. The reinforcement bar may be smooth and rounded and may have top edge guides 25 near the top side edges to hold the retainer in a proper position, normally in the center of the top front edge.

The retainer part may be made of a flexible material such as a sheet, cloth, filament, cord, line, strand, wire, belt, electrical cable, strap, chain or other flexible fabric. The retainer material should be capable of retaining the display panel to the holder or bag front wall while still being pliable enough to not interfere with the movement of the display panel into and out of the holder. One suitable type of retainer would be a flat sheet forming an attachment flap and this type of retainer will be used as an example although another types of retainer, such as a filament, may be substituted in many cases. The retainer is a type of pivoting computer equipment mount, a means to pivotally hold computer equipment, such as a display panel, input device, keyboard, electrical write pad, camera or other equipment, to a bag. When the retainer is attached to the attachment edge of the computer equipment, both the front and back of the computer equipment is available for use.

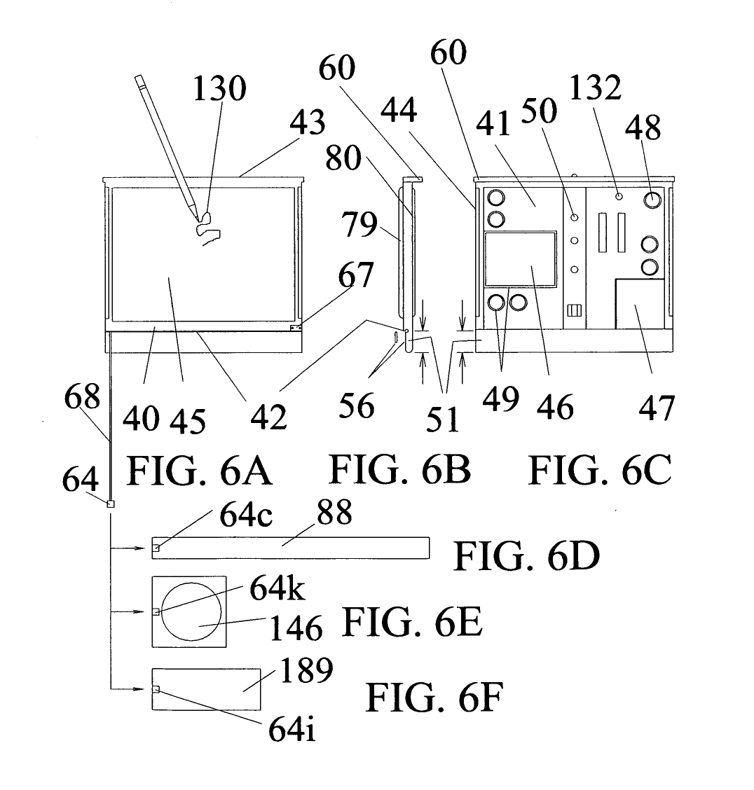

The display panel, shown in FIGS. 6A, 6B, and 6C, is panel-like and has a front side 40 (FIG. 6A), a back side 41 (FIG. 6C), an attachment edge 42, a distal edge 43, and two side edges 44. The display panel may be shaped and sized to fit the inside of a holder, rigid holder or holder receptacle for storage. A display 45 is located on the front side of the display panel. The front side of the display panel may include a touch screen control 130 (indicated by pencil drawing line). For control of the computer or display, the back side of the display panel may include manual controls such as a touch pad/pointing device 46, joystick pad 47 or buttons 48 (e.g. pointing device “clickers”). For faster and more accurate control, the controls may be located on the display panel so that the touch pad may be controlled by the fingers of one hand (e.g. right) and the clicking buttons controlled by the fingers of the other hand (e.g. left). The back side may include finger guides 49 to help the operator find controls on the back side. The finger guides may be removable. The display panel back side may also include a prop or prop fixtures 50 designed to hold an angle between the display panel and bag front by placing a prop between them. The display panel prop 51 may take the form of an extension of the display panel. This prop/extension may be fixed to the attachment edge of the display panel and may be on the same plane as the plane of the display panel or may be angled relative to the plane of the display panel.

The distal edge of the display panel may include a handle or ledge 60 which may serve to keep the display panel from entering the holder too far and assist in extracting the display panel from the holder. The display panel may also include one or more front side guard rails 79 to keep the display on the front side from rubbing against the holder or bag. The display panel may include one or more back side guard rails 80 to provide space between the holder and display panel for an electrical connection wire to fit between them and to keep controls from being actuated while in the storage position.

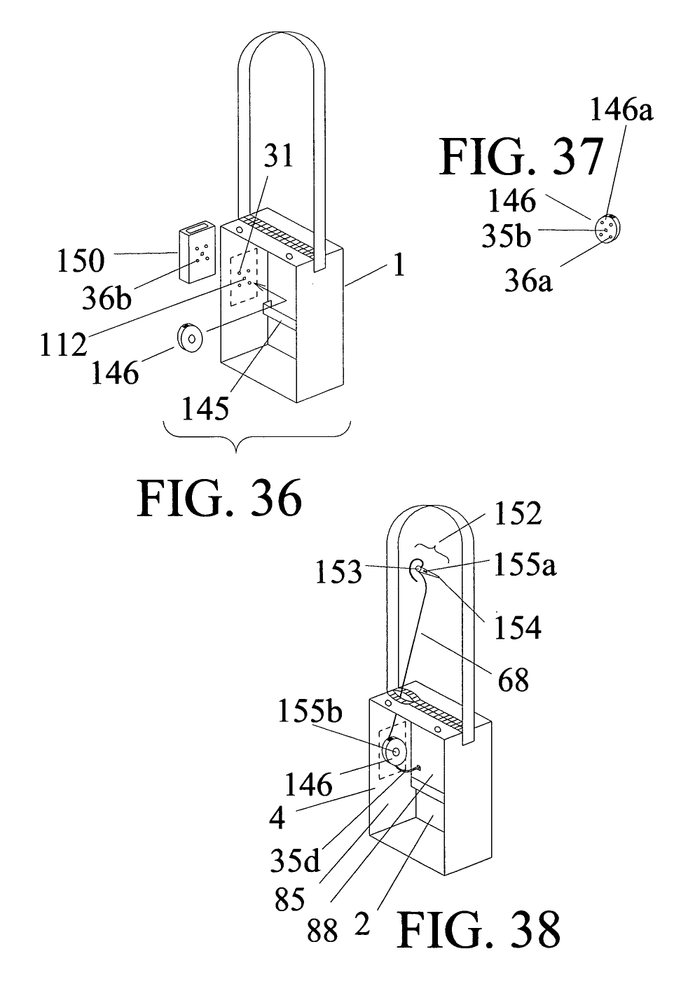

Shown in FIG. 6D, FIG. 6E and FIG. 6F, the display panel may have an electrical connection 64 to connect it with an electrical connection 64c on a computing unit panel 88 (FIG. 6D) attached to the inside front wall of the bag (see FIG. 38) or connect with an electrical connection 64k on the audio connector 146 (FIG. 6E) attached to the inside wall of the bag (see FIGS. 36 and 37) or connect with an electrical connection 64i on a battery 189 (FIG. 6F) or connect to a peripheral inside the bag or connect with a computing unit or battery that may be part of a holder or cover attached to the outside of the bag. The connection may be a wire 68 long enough to reach through an attachment flap electrical access channel and/or through the front wall to the inside of the bag. Alternatively, the display panel may include a disconnectable electrical connection 67, such as a socket or plug, designed to match and electrically connect with an electrical connection fixture on the retainer distal end.

The retainer may be attached to the display panel on or near the display panel attachment edge. If the display panel includes a prop extending from the attachment edge for holding the display panel angle, the attachment edge may not be on an edge of the display panel. In this case, the attachment edge may be a line of attachment or point of attachment of the retainer to the display panel. The display panel may be removable from the retainer. For easy removal, the display panel may have an attachment on or near its attachment edge to match and connect with the attachment on the retainer distal end. The attachment on the display panel may be a clamp or two jaws 56 adapted to hold retainer or attachment flap to the display panel.

For privacy, the operator may want to blacken the display panel when it is not in use and hanging down in front of the bag. The display panel may include an electrical down position on/off switch 132 to turn off the display when the display panel is in the vertical down position in front of the bag (see FIG. 1B). The switch may be a button or lever located on the display panel so that it is actuated by pressing against the bag or holder when the display panel is in the storage position. The switch may be a gravity switch which senses and is actuated when the display panel is in the vertical down position.

Shown in FIGS. 7A, 7B and 7C, the display panel attachment edge 42 may be adapted to slidably fit onto a retainer that forms a guide on which the display panel slides. In this case, the display panel may include a display panel slide attachment 75 (indicated by a brace) on or near the display panel attachment edge and adapted to slide along the retainer from a storage position to an operating position. This slide attachment may be comprised of a bar 76 or axle separated from the attachment edge by a slot 77 opening through which the retainer (for example, a sheet, flap or strip) can pass and slide as the display panel is moved between operating and storage positions.

Alternatively, shown in FIG. 7C, the display panel slide attachment may be comprised of one or more slide holes 78 or other openings in the display panel near the attachment edge to match one or more retainers such as a filament, band or strip.

If the display panel includes a prop 51 extending from the attachment edge for holding the display panel angle, the attachment edge may not be on an edge of the display panel. In this case, the attachment edge may be a line of attachment or point of attachment of the retainer to the display panel. A prop or props on the attachment edge may be a right prop 51a and/or a left prop 51b to the right and/or left of the display panel, slide attachment, bar, slot or hole. An electrical connection 64 may be included.

The display panel may be removable from the retainer. For removal, the bar 76 may be detachable from the display panel so the retainer can be put in place in the attachment edge slot (see FIG. 4A). Alternatively, an end of the retainer may be disconnectable from the bag or holder so it can be passed through the slot or hole in the slide attachment in a display panel including, for example, a molded in or fixed slot or hole.

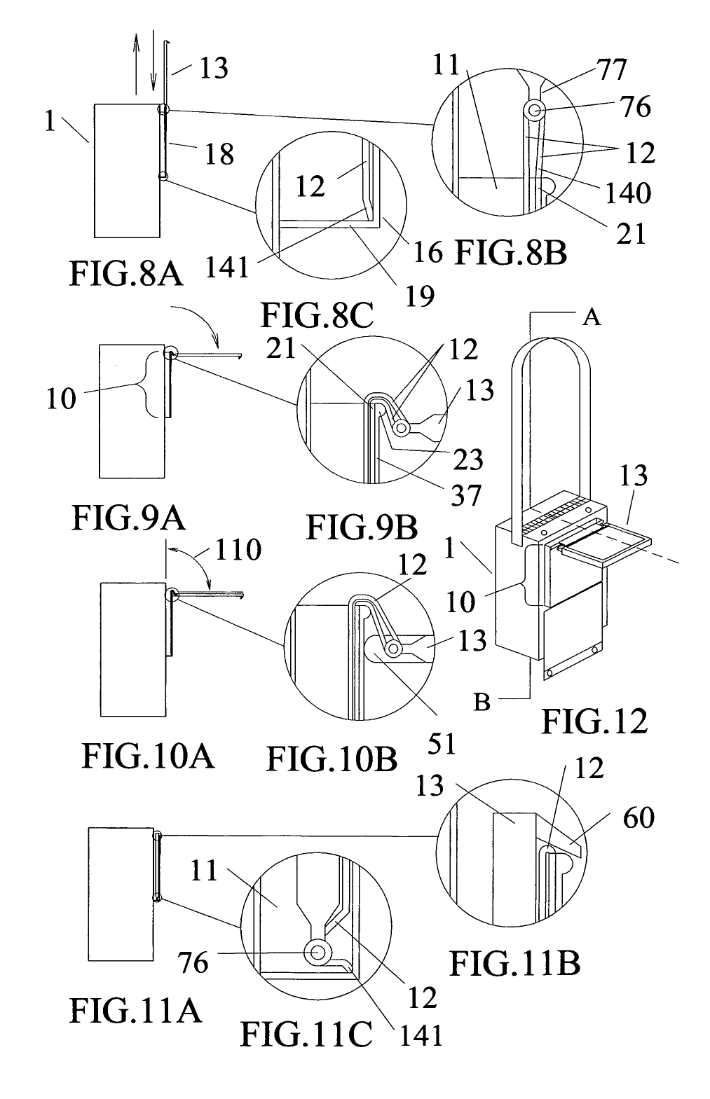

FIGS. 8A to 11C show cross section views of the bag 1, display panel 13 and support structure 10 (holder 11 and retainer 12) cut through at A/B in FIG. 12 and aligned along a plane shown with the dotted line. In this figure the retainer is a guide along which the display panel with a slide attachment may slide.

In FIG. 8A with parts magnified in FIGS. 8B and 8C, the display panel 13 is installed to the bag 1 but removed from the holder 11 with an upward movement. The retainer 12 top end 140 is attached near the top front edge 21 of the holder front side 18 and, in this case, may be an extension of the holder front extending upward from the top front edge of the holder. The retainer then goes around the bar 76 and through the slot 77 of the display panel slide attachment and then extends downward where the retainer bottom end 141 attaches to the holder bottom side 19 or to the holder front side near the holder bottom end 16. The display panel is free to pivot where the retainer rounds the display panel bar or hole.

In FIG. 9A with parts magnified in FIG. 9B, the display panel 13 has been pivoted into an operating position with the retainer 12 hanging slightly over the holder top front edge 21. The display panel is free to pivot where the retainer rounds the display panel bar or hole and may be moved into a useful operating position. In these drawings, a contact surface 37 and a top front edge reinforcement bar 23 are included.

In FIG. 10A with parts magnified in FIG. 10B, the arrangement of FIG. 9A is shown again but in this case a prop 51 is included so that the display panel 13 is suspended by the retainer 12 and the prop pushes against the bag and holder to hold the display panel at one or more angles 110 relative to the bag front wall.

In FIG. 11A with parts magnified in FIGS. 11B and 11C, the display panel 13 is in a storage position in the holder 11. FIG. 11B shows that the handle/ledge 60 at the distal end of the display panel may serve to maintain the position of the display panel in the holder and holder top end opening, to extract the display panel from the holder and to cover the holder top front edge and exposed retainer 12. FIG. 11C shows the display panel attachment edge area including the slide attachment and bar 76 with the retainer 12 bottom end 141 attached to the holder with the retainer still holding the display panel to the bag.

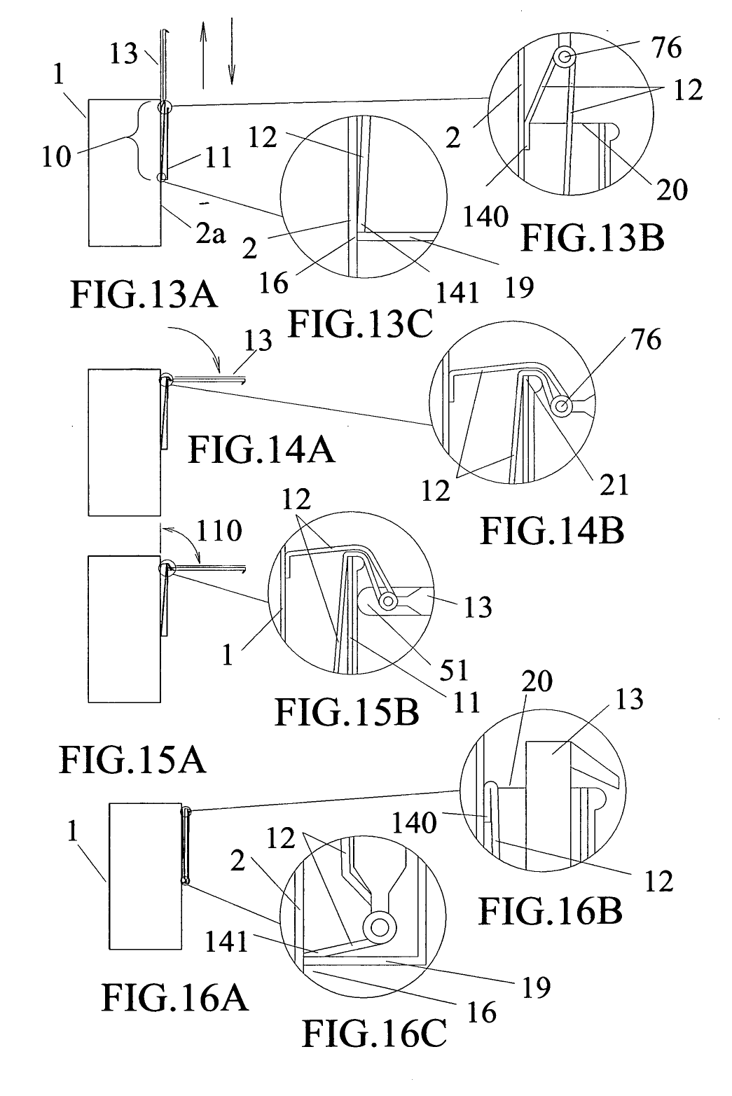

The series of drawings, FIG. 13A to FIG. 16C, show cross section views of the bag 1, display panel 13 and support structure 10 cut through at A/B in FIG. 12 and aligned along a plane shown with the dotted line. They show that the retainer top end and bottom end may be alternatively attached, fixed, or fastened to the outside surface of the bag front wall instead of to the holder.

In FIG. 13A with parts magnified in FIGS. 13B and 13C, shows the display panel 13 withdrawn from the holder 11 through the top end opening 20 but is still attached to the bag with the retainer. It shows the retainer 12 top end 140 attached to the bag 1 front wall 2 outside surface 2a near the holder top end opening and the retainer bottom end 141 attached to the bag front wall outside or holder bottom 19 near the holder bottom end 16. The retainer leads around the slide attachment (bar 76) thus slidably holding the display panel to the bag. Thus the attachment from the bag to the display panel is a loop in the retainer (in this case an attachment flap but may alternatively be an attachment filament).

In FIG. 14A with parts magnified in FIG. 14B, the display panel 13 is in an operating position with the retainer 12 leading over the holder top front edge 21 and the display panel is pivotable by the slide attachment (bar 76) to any operating position.

In FIG. 15A with parts magnified in FIG. 15B, the same arrangement as FIG. 14A is shown but here a prop 51 is used along with the retainer 12 suspending the display panel 13. With the prop pushing against the holder 11 and bag 1, the display panel may hold and be operated at one or more angular positions 110 relative to the bag front wall.

In FIG. 16A with parts magnified in FIGS. 16B and 16C, the display panel 13 is now in storage position in the holder and the retainer 12 top end 140 is attached to the bag 1 near the holder top end opening 20. The bottom end 141 of the retainer is attached to the bag front wall 2 or holder bottom side 19 near the holder bottom end 16.

In various alternatives: The retainer top end may be attached to the holder near the holder top end and the retainer bottom end may be attached to the bag near the holder bottom end: The retainer top end may be attached to the bag near the holder top end and the retainer bottom end may be attached to the holder near the holder bottom end. The result is a stationary guide (the retainer) along which the display panel slide attachment may slide.

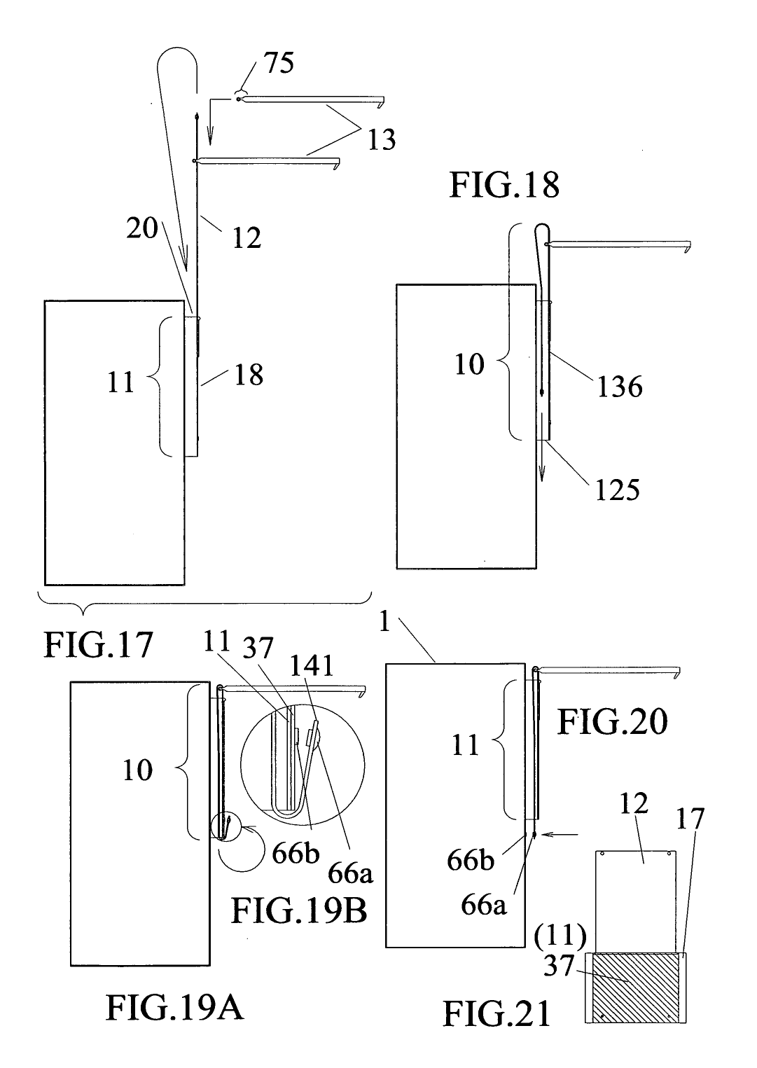

FIGS. 17 to 25B show a simplified version of the sliding attachment and retainer type display panel mount that easily mounts and dismounts the display panel to the retainer, holder and bag. FIGS. 17 to 20 show a cross section side view of the bag, support structure and display panel at A/B in FIG. 12. Since the majority of the retainer is hidden inside the holder, inserting and removing the retainer from the slide attachment on the display panel can be difficult. The following embodiment uses a band-like holder with open top and bottom along with a retainer with one end detachable and re-attachable to an attachment in an accessible place on the holder or bag.

Shown in FIG. 17, the retainer 12 is a long upward extension of or addition to the front 18 of the holder 11. The retainer may be passed through a slot or hole in the slide attachment 75 on the display panel 13. The retainer can then be turned and passed downward through the holder top end opening 20 as shown in FIG. 18. In FIGS. 19A and 20, the retainer is at the bottom of the support structure 10 and may be passed through the holder bottom end opening 125. One or more attachments near the bottom end 141 of the retainer can be attached to one or more matching attachments on the holder 11 (FIG. 19B, 66b) or, alternatively, on the bag 1 front (FIG. 20, 66b). FIG. 19A, a magnified view FIG. 19B, shows that the holder front may include a contact surface 37 which may cover most or all of the outside surface of the holder front 136 and may include the attachment 66b matching the retainer bottom end attachment 66a. The contact surface may be rigid and may be panel that is all of, part of or attaches to the holder front and forms a compression column against which the retainer may pull without collapsing the holder front.

FIG. 21, in the bottom right corner, shows a flat plan for a possible pattern (in one half scale) for the support structure material before it is affixed to the bag. The holder front (11) may be covered with a contact surface 37 which may be a part of or attached to the pattern material and is shown with cross hatching. The plan also shows the retainer 12 and holder side pieces 17. The support structure (holder sides) may be sewn, riveted, glued, bonded or otherwise attached to the bag.

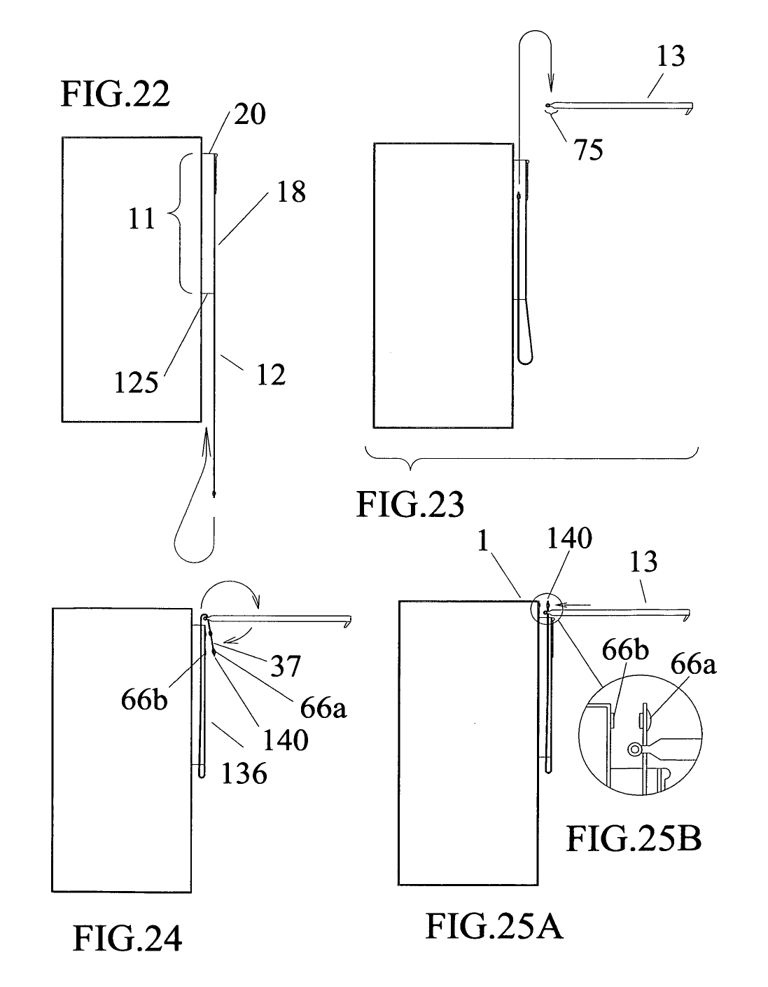

FIGS. 22 to 25 shows the same way of attaching the display panel 13 to the retainer 12 as in FIGS. 17 to 20 but in this case the retainer is a long downward extension of or addition to the front 18 of the holder 11.

The figures show the retainer 12 extending downward from the holder front 18 with its top end 140 passing upward through the bottom end opening 125 of the holder band 11, through the holder top end opening 20, through the slide attachment 75 on the display panel 13 and being attached to the outside surface of the holder front 136 (FIG. 24) using matching attachments 66a and 66b. The attachment near the retainer top end 140 may be or include a contact surface 37. FIG. 25A and FIG. 25B show that the attachment of the retainer top end 140 may be to the bag 1 instead of to the holder and may use attachments 66a and 66b.

It is easy to imagine, instead, that either the top end or the bottom end of the retainer, whether extending upward or downward, may removably attach to the bag or holder with the opposite end permanently fixed to the bag or holder for the same purpose of installing or removing the display panel to the retainer, support structure and bag.

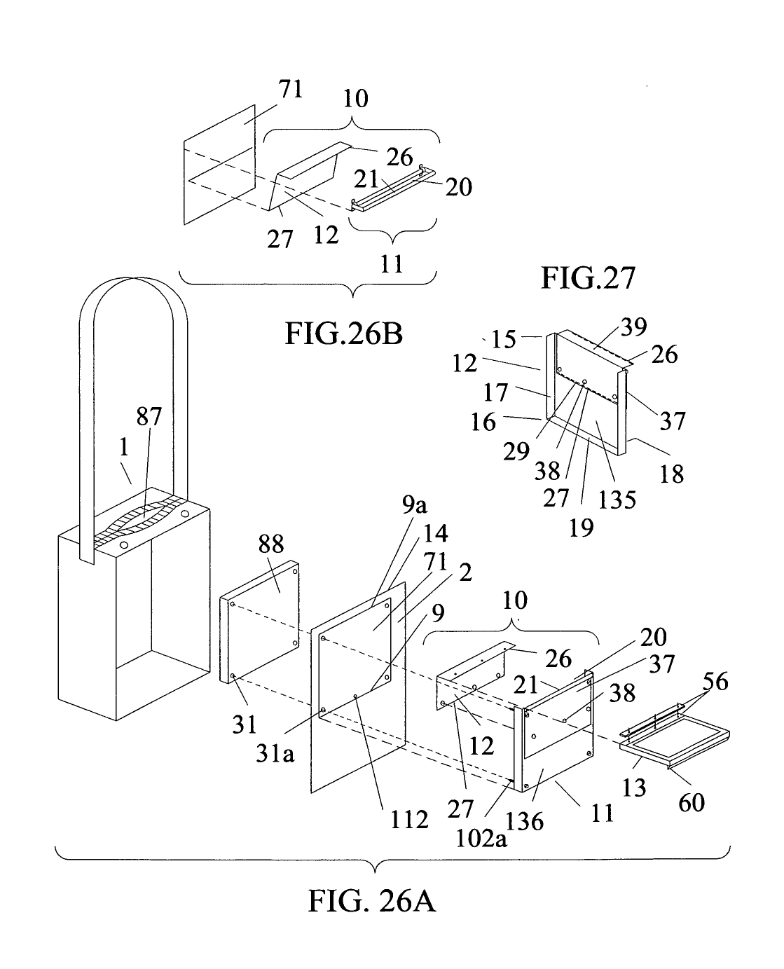

FIGS. 26A to 32C show the bag computer simplified holder and retainer end to display panel mount. In this arrangement the display panel deploys upward out of the holder and pivots into an operating position. In contrast to the previously described embodiment, these figures show the retainer having two ends with one attached to the bag or holder and the other attached to the display panel.

In the exploded view of the bag and support structure, FIG. 26A, and in the inside view of the holder, FIG. 27, the support structure 10 is attached to the outside of the bag's 1 front wall 2 in the computer equipment storage area 71 which may include a top 9a and a bottom 9. The bag front wall may have a top end 14.

The support structure may have a holder 11 part and a retainer part 12. The holder part may be any construction that allows the display panel 13 to slide into and out of the holder from the side closest to the front wall top end (e.g. holder top end opening 20). The holder may have a front 18, a top end 15, a bottom end 16, a top end opening 20, a top front edge 21, bottom side 19 and one or more side pieces 17. The holder front may have an inside surface 135 and outside surface 136. The holder may be fitted with a contact surface 37 to assist in temporarily holding a display panel prop to the holder. The contact surface, holder and/or retainer may be attached together by, for example, riveting 38 or sewing through the holder front.

The display panel may be adapted to fasten to the retainer or retainer distal end, for example, by using a clamp, two jaws 56 or other means.

The bag may include an electrical access opening 112 to allow an electrical connection from the display panel to pass the bag front wall 2 to the interior 87 of the bag 1.

FIG. 26A also shows that one or more fasteners 102a, such as screws, may be used to fasten the holder through openings in the front wall 31a to matching fastening fixtures 31, such as screw holes, in a computing unit panel 88 meant to be attached to the inside of the bag front wall. Any sort of holder may be used in this fashion to hold both the holder and the computing unit panel to the bag and its walls.

FIG. 26B shows that the holder may be a ring holder 11 without front, sides or bottom. With its proximal end 27 attached to the bag's computer equipment storage area 71, the retainer 12 distal end 26 passes upward through the ring holder top end opening 20 and over its top front edge 21 to hold the display panel to the bag. The ring holder top end opening is large enough for the display panel to pass through and the display panel may be held in place by its handle/ledge 60.

FIG. 27 shows the retainer and holder with its inside surface showing. The retainer may be an attachment flap 39, attachment filament, flexible fabric or other means to attach the display panel to the bag and/or holder. The retainer may have two ends, a proximal end 27 attached to the bag and a distal end 26 for attaching to the display panel. The proximal end may be adapted to fasten the retainer to the bag or the holder. The retainer 12 proximal end may attach to the inside surface 135 of the holder with, for example, sewing 29 or riveting 38.

This holder and retainer end to display panel type display panel mount may be used to attach and store the display panel to a pivoting cover, in which case the holder is a cover (see FIGS. 112 to 115, cover 8).

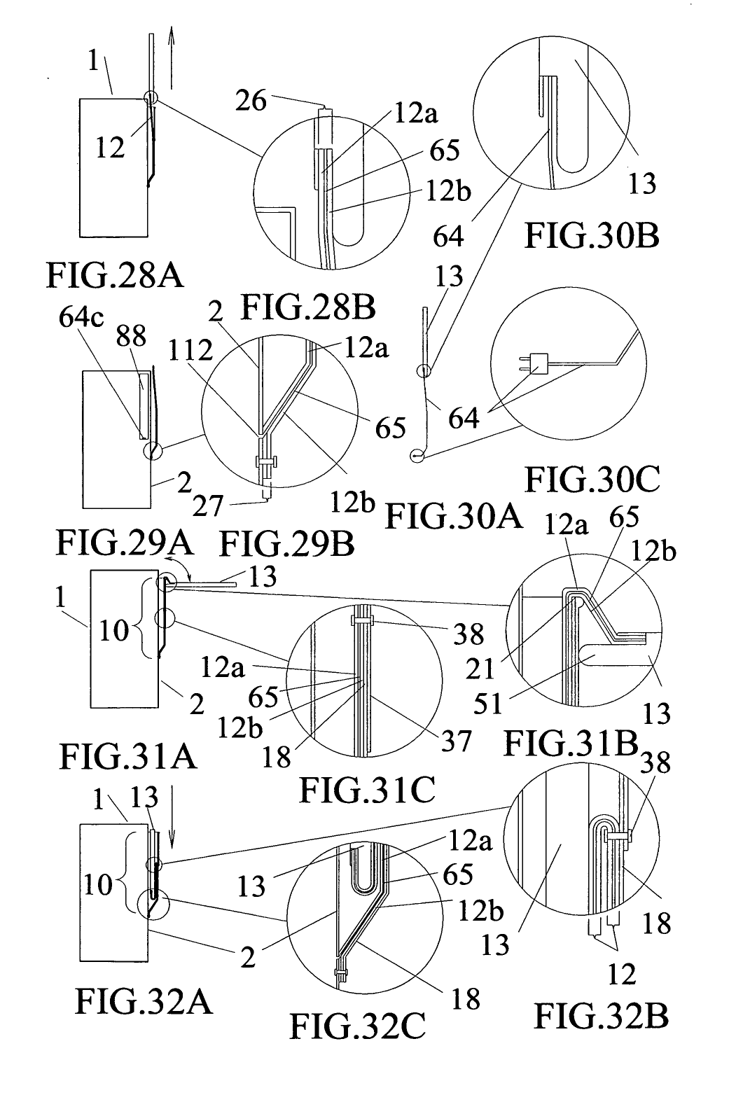

FIGS. 28A to 32C show an improvement to the support structure of FIGS. 26A, 26B and 27 where the retainer 12 includes a proximal end 27 and a distal end 26 with the distal end attached to the display panel and the proximal end attached to the bag 1 or holder. The retainer is double layered and parallels the holder front. The purpose of this arrangement is to make series of parallel layers of material that may be easily manufactured by attaching them together with, for example, sewing, gluing, bonding and/or riveting. The layers provide a continuous and protected electrical access channel to the bag interior that is easily manufactured. All the figures show cross section views of the bag 1, display panel 13 and support structure 10 cut through at A/B in FIG. 12 and aligned along a plane shown with the dotted line.

Shown in FIG. 28A and magnified in FIG. 28B, the retainer distal end 26 is attached to the display panel. The retainer 12, which may be an attachment flap, has two layers, 12a and 12b, with an electrical access channel 65 between them. The two layers may be of the same flexible fabric material or they may have different characteristics such as the material weight, thickness or elasticity. These two layers may be of different characteristic from the holder with, for example, the 12a and 12b layers being made of a lighter more flexible material and the holder made of a thicker less flexible material while all layers may be sewable.

FIG. 29A and magnification FIG. 29B show the bag and retainer with the holder, display panel and electrical connection removed. The retainer proximal end 27 may be comprised of two layers, 12a and 12b, fixed (with, for example, sewing or riveting) to the bag front wall 2. The electrical access channel 65 between the two layers aligns with an electrical access opening 112 in the bag front wall.

FIG. 30A shows that the display panel 13 may have an electrical connection 64, such as a wire, adapted to match the electrical access channel in the retainer and the electrical access opening in the bag.

FIG. 30B, a magnification of FIG. 30A, shows the electrical connection 64 to the display panel 13 and FIG. 30C, a magnification of FIG. 30A, shows the electrical connection 64 adapted to fit the retainer electrical access channel, the electrical access opening in the bag and to match electrical equipment inside the bag such as the electrical connection 64c on a computing unit 88 (FIG. 29a), peripherals or batteries.

FIG. 31A and magnification FIG. 31B show the display panel 13 in an operating position with the retainer two layers, 12a and 12b, and electrical access channel 65 extending over the holder top front edge 21 and suspending the display panel while a prop 51 on the display panel pushes against the holder part of the support structure 10 and bag 1 to hold the display panel at one or more angles relative to the bag front wall 2. Magnification FIG. 31C shows that the retainer may be fixed to the inside of the holder front wall (for example, with riveting 38, sewing or clamping) and/or to the contact surface 37 for the purpose of allowing the retainer to fold in half to remove any slack in the retainer when the display panel is put in storage position (shown in. FIGS. 32A to 32C). The layers shown are the holder 18 and the two retainer layers 12a and 12b with the electrical access channel 65 between these two retainer layers. (For drawing clarity, FIGS. 31A to 31C and 32A to 32C exclude the electrical wire in the electrical access channel.)

FIG. 32A and magnification FIG. 32B show the display panel 13 in the storage position in the holder part of the support structure 10. The retainer 12 has doubled over and turned downward as the riveting 38 holds the retainer to the holder front 18. The holder may be made of material that is normal bag material, extra heavy or stiff bag material, rigid or semi-rigid material or may include parts that are rigid or semi-rigid. The contact surface may be part of the holder. The holder sides may be rigid to hold the holder front away from the bag or may be flexible or elastic to allow or assist the holder front to collapse against the bag front when the display panel is moved into an operating position.

FIG. 32C, a magnification of FIG. 32A, shows the bottom end of the support structure, holder and retainer. The retainer curves around the display panel 13 attachment edge (and prop if present), extends upward to the riveting and returns downward along the holder front 18. The retainer layers 12a and 12b along with the electrical access channel 65 and the holder front are attached together with the bag front wall 2 (for example, by sewing, riveting or other means).

The purpose of this arrangement is to simplify and combine the construction of the holder and retainer and to build in an electrical access channel that is entirely enclosed and protected when not in the interior of the bag.

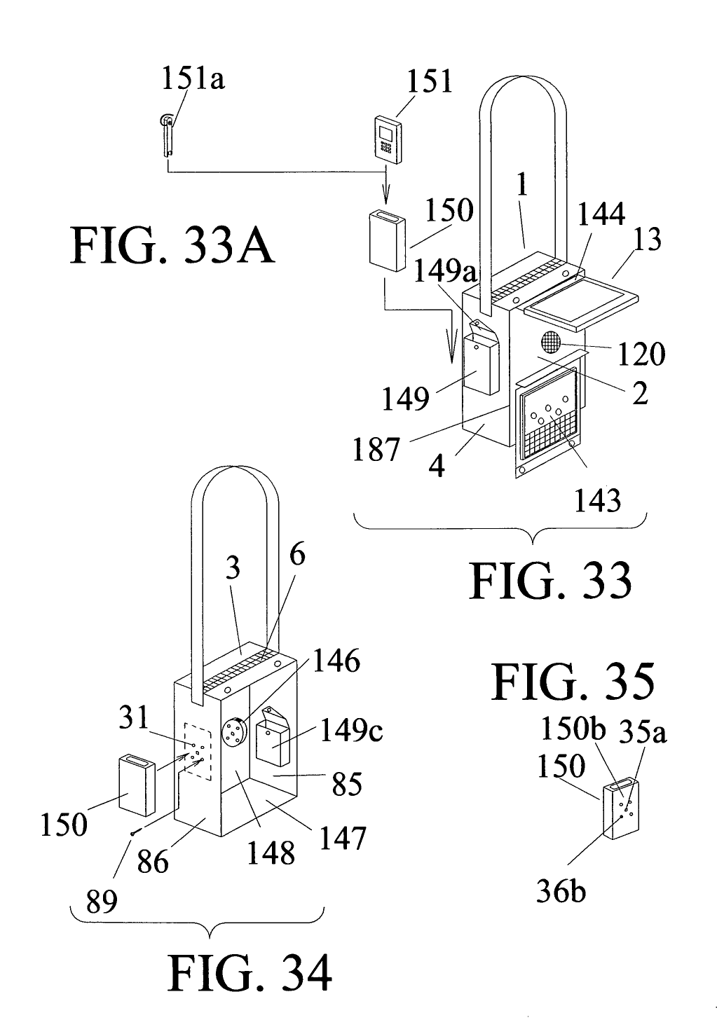

FIGS. 33 to 38 show a bag 1 for holding electrical equipment with FIG. 34 showing the bag with the front wall removed and FIGS. 36 and 38 with the back wall removed so that inside surfaces of the walls are visible.

FIG. 33 (front view with bag intact) and FIG. 34 (front view with the front wall removed) show the bag computer designed to hold and electrically connect computing equipment such as an electronic display panel 13, computing unit panel 88 (FIG. 38) or keyboard 143. The bag may have specific attachments or supports to hold this equipment such as one or more pivoting computer equipment mounts 144, computing unit panel inside support structure 145 (FIG. 36), outside surface support structure and/or openings 31 adapted to hold the equipment to the bag for use. The bag front may include one or more bag heat dissipation outlets 120 matching one or more computing unit panel heat dissipation outlets 120a (FIG. 46a) on the computing unit panel. The heat dissipation outlet may be an opening in the bag wall, air permeable material, exposed heat sink material or other means to allow heat to exit the bag interior.

The bag may have soft or rigid walls and may also be called a case. The bag may have a front wall 2, one or more side walls 4, a top wall 3, a bottom wall 147 and a back wall 148. There may be a junction 187 between the front wall and a side wall. The bag may have a cargo opening 6 to access the bag interior and the opening may be in the top wall and include a closure such as a zipper. Any of the walls may have an inside surface 85 and an outside surface 86. A bag wall outside surface may include a holder such as a pocket 149 to hold and protect the computer equipment or electrical device attached to the bag. The pocket may include a cover such as a flap 149a to hold the electrical device in the pocket. The pocket may include protection for the electrical device such as padding, foam or rigid or semi-rigid wall.

To improve communications while using the bag computer, a bag mounted communication assembly may be included as part of the bag. The bag mounted communication assembly may be seen as a system comprised of an interacting group of components performing a unified communication function. It functions electrically and may supply electrical power to any component. This assembly may include an audio connector 146 (FIG. 34) and a telephone handset connector 150. These two connectors physically and electrically attach to each other and physically attach to the bag by attaching the connectors together with the bag wall between. Although either may be on the outside of the bag wall, normally the telephone handset connector is on the outside. Either connector may be used with a pocket attached to a bag wall outside surface or a pocket 149c attached to a bag wall inside surface to assist in mounting and protection. The telephone handset connector 150 may include a matching telephone handset 151 such as a cell phone, 2-way radio or wireless microphone/speaker headset 151a (shown in FIG. 33A). The telephone handset connector may be designed to physically hold and electrically connect with the telephone handset and to electrically connect the telephone handset to the other assembly components for communication and battery recharging.

FIG. 34 further shows that the telephone handset connector may be semi-permanently attached to the bag using an attachment means 89 through matching hole or pattern of holes 31 in a bag wall. The telephone handset connector may attach to the outside surface 86 of the bag wall by attaching through the bag wall to the audio connector 146 in the inside of the bag thus clamping the bag wall between and holding the two parts and bag together.

FIG. 35 shows the telephone handset connector 150 back side 150b (side facing the bag wall). It shows a telephone handset connector to audio connector electrical connection 35a and one or more telephone handset connector bag attachment parts 36b.

FIGS. 36 to 38 show the bag from the back with the bag back side removed so the interior is visible. Included in the figures is the audio connector 146. The audio connector may be or include a reeling, spooling, coiling, folding, weaving or other type mechanism that systematically and mechanically takes in, stores and dispenses an electrical wire without tangling. This electrical wire is capable of electrically connecting the audio connector to an audio device such as a speaker and/or microphone and, if present, their controls. Alternatively, the audio connector may be or include a radio (wireless) transmitter and/or receiver adapted to communicate electrically with a speaker and/or microphone radio transmitter and/or receiver in a remote unit.

The audio connector may be semi-permanently attached to a bag wall using an attachment means 89 (FIG. 34) through a matching hole or pattern of holes 31 in a bag wall. The telephone handset connector 150 and telephone handset connector bag attachment part 36b may attach directly to the audio connector bag attachment part 36a (FIG. 37) through one or more matching holes 31 in the bag wall. The bag may also include one or more electrical access openings 112 to allow the electrical connection of the telephone handset connector to audio connector electrical connection 35a (FIG. 35) to the audio connector to telephone handset connector electrical connection 35b (FIG. 37) through a bag wall. FIG. 37 shows the audio connector 146 back side 146a (the side facing the bag wall) and shows the audio connector to telephone handset connector electrical connection 35b and audio connector bag attachment parts 36a.

FIG. 38 shows the bag with the bag mounted communication assembly installed to the bag. The inside surface 85 the bag side wall 4 has the audio connector 146 attached. The audio connector may have an audio connector to computing unit panel electrical connection 35d extending to a computing unit panel 88 which may be attached to the inside surface of the bag front wall 2 using, for example, a support structure 145 (FIG. 36). Via the computing unit panel, the computing unit panel electrical connection may further indirectly or directly lead to an exterior mounted pivoting display panel storable in the bag's computer equipment storage area. The audio connector may store and dispense an electrical wire 68 making an electrical connection to an electrical device such as a headset 152, possibly including a speaker/earphone 153, microphone 154, headset/phone/computer control 155a, display unit or other input/output device. One or more controls 155b may be included on the audio connector to connect with and control telephone functions (such as answer and hang up), computer functions, speaker functions and/or microphone functions. Further electrical connections may extend from the audio connector to connect with the computing unit panel and/or the telephone handset connector using the electrical connection described above.

Shown in FIG. 39 is the bag 1 with its front wall 2 showing and its right and left sides wall 4 showing their edges. In this case, the bag has pockets 149 on the side walls. The telephone handset 151 is shown from the side as it enters the bag side pocket at and angle 157.

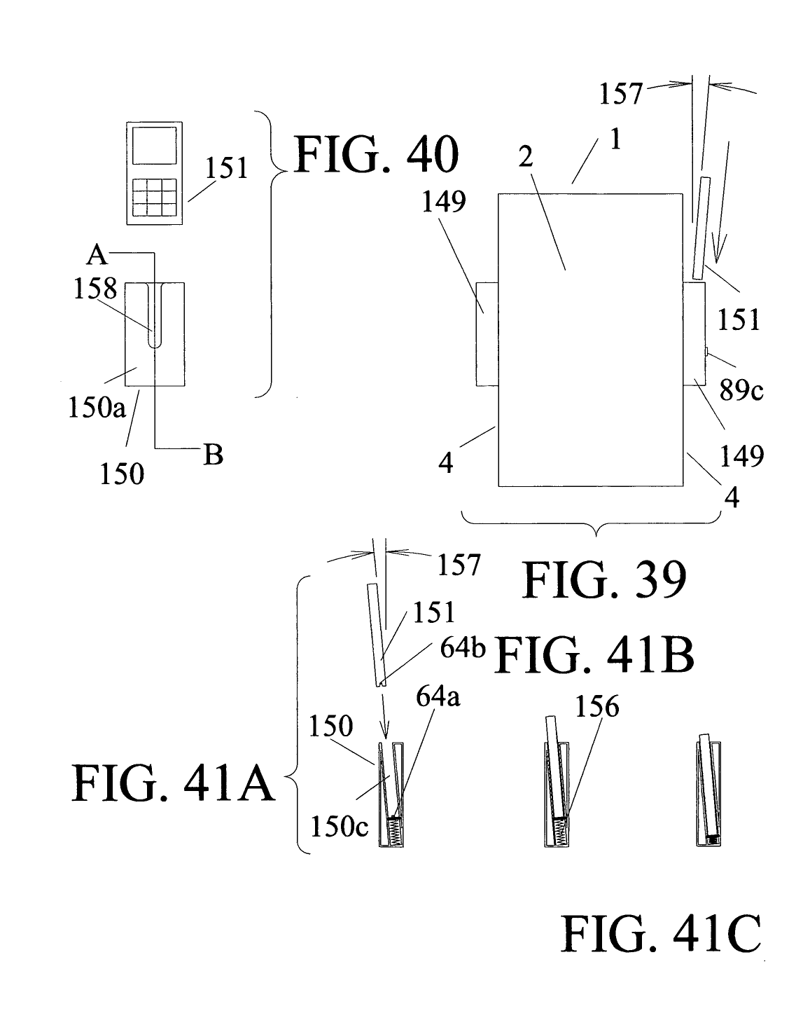

In FIG. 40, the telephone handset 151 (now turned 90 degrees to a front view), such as a mobile phone, computer input/output device, computer equipped “smart” phone or other such device for mobile telecommunications, may be held to the bag with one or more telephone handset connectors 150 adapted to fit a bag electrical access opening, bag attachment openings and/or pockets. FIG. 40 shows the telephone handset connectors front side 150a (side facing away from the bag) and also shows the positioning of a cross section A/B used in the side view cross section views which show three views of the telephone handset connectors with; FIG. 41A, the telephone handset removed from the telephone handset connector for hand use; FIG. 41B, the telephone handset partially withdrawn from the telephone handset connector; and FIG. 41C, the telephone handset in the telephone handset connector in storage position. The telephone handset connector may include a cavity 150c to fit and hold a telephone handset 151. The telephone handset connector may include one or more telephone handset connector to telephone handset electrical connections 64a to removably connect to a matching telephone handset electrical connection 64b so the handset may be alternatively used alone or with the rest of the assembly through the electrical connections provided by the telephone handset connector. The cavity may include an ejection mechanism 156, such as a spring, to eject and partially remove the telephone handset for easy removal. The cavity may be angled 157 to make removal easier. The telephone handset connector may include a removal slot 158 for removing the telephone handset.

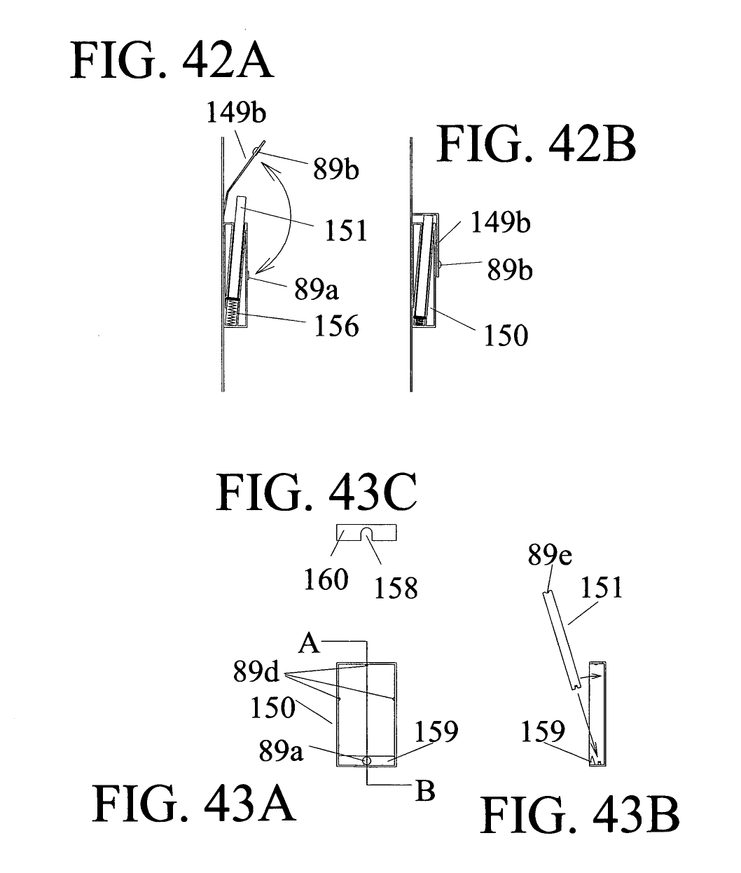

Shown in side view cross sections (at FIG. 40A/B) FIG. 42A (open) and FIG. 42B (closed), a telephone handset connector cover 149b may be arranged to hold the telephone handset 151 in the telephone handset connector 150 against the pressure of the ejection mechanism 156. The telephone handset connector cover may include an attachment 89b which may match the bag attachment 89c (FIG. 39) or telephone handset connector attachment 89a to hold the cover in place.

Shown in FIG. 43A front view on the left, FIG. 43B side cross section view at A/B on the right and FIG. 43C top view above, the telephone handset connector 150 may be partially or completely open on its front side 150a (FIG. 40) and including a telephone handset connector footing 159 and one or more attachments 89d, such as snap knobs, adapted to fit the telephone handset or matching attachment 89e on the telephone handset 151 and hold it to the telephone handset connector. The removal slot 158 may be in the telephone handset connector top wall 160 and may be used to pivot the telephone handset away from the telephone handset connector where it can be withdrawn. The telephone handset connector may include a cover attachment 89a to match the telephone handset connector cover attachment 89b (FIG. 42A). The bag may include a pocket or partial pocket fitting the telephone handset connector to protect and hold the telephone handset connector to the bag.

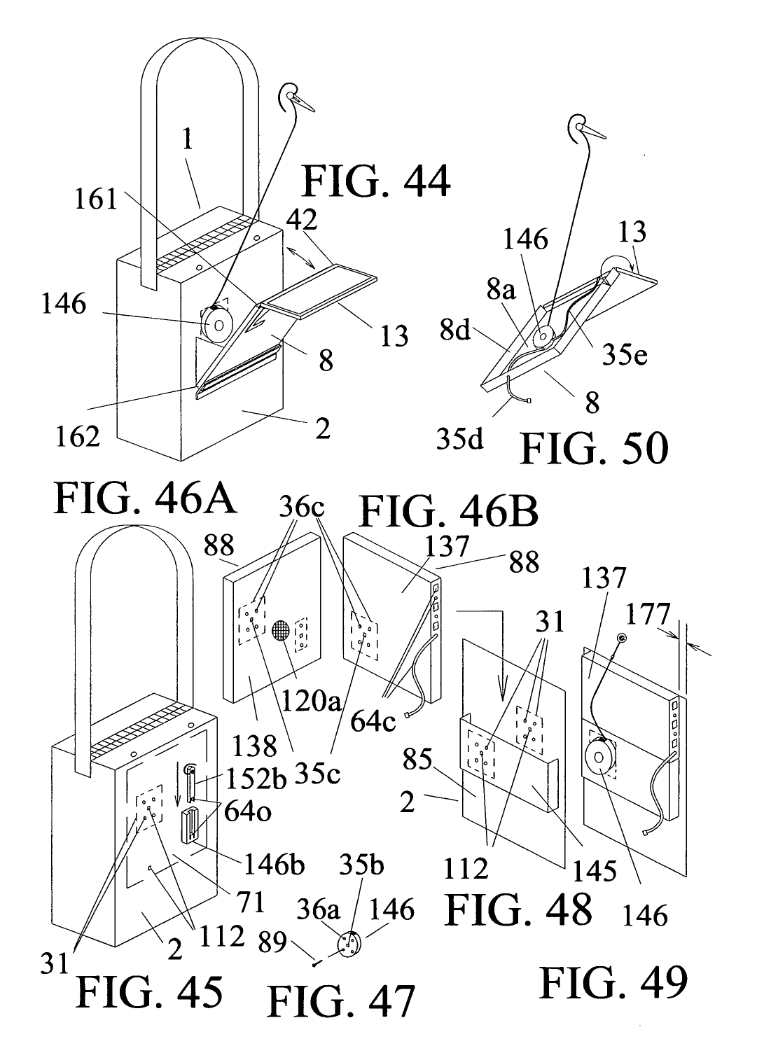

The audio connector may be used on a bag 1 with a computing unit panel. In a first case, shown in FIG. 44, the bag may have a cover 8 (also called an intermediate panel between the bag and the display panel) pivotally attached to the outside surface of the bag front wall 2 by the cover proximal attachment edge 162. The cover may be rigid and adapted to pivotally hold an electronic display panel 13 by the display panel attachment edge 42 to the cover distal edge 161. FIG. 44 shows the cover and display panel in an operating position (see FIG. 73 for a view of the cover and display panel in closed storage position). It can be seen that the audio connector 146 is attached to the bag front wall where it may be covered by the cover 8 when the cover is closed.

In FIG. 45 the bag is shown with the cover/intermediate panel, audio connector and display panel removed. It shows a pattern of attachment holes comprising a bag attachment structure 31 positioned on the bag front wall 2 in the computer equipment storage area 71 coverable by the cover and designed to mount the audio connector to the bag by attaching through the bag wall to a computing unit panel mounted on the inside of the bag front wall. Using attachments 89 (FIG. 47) between the inside mounted computing unit panel and the outside mounted audio connector, the bag wall is clamped between the panel and the connector. There is also an electrical access opening 112 through the bag wall to allow electrical connection between the computing unit panel and the audio connector.

FIG. 45 also shows that the audio connector may be arranged to be comprised of a wireless (radio) microphone and/or speaker headset 152b and a headset holder 146b instead of or in addition to a wire connection arrangement. The headset holder has the same electrical and physical connections to the bag and communications assembly as the audio connector already described. The headset holder serves as a storage place for the headset and an electrical connection 64o to connect the headset to the other assembly components to, for example, recharge the headset batteries or control a transceiver (answer the telephone). The headset holder may include a transmitter and/or receiver unit to communicate with the headset. The wireless headset with headset holder arrangement of the audio connector may be used on the inside of a bag wall (FIG. 38), on the outside of a bag wall (FIG. 64A), directly on the computing unit panel (FIGS. 45 to 49), on the inside of a cover (FIG. 50) or elsewhere that an audio connector may be used.

A computing unit panel 88 for mounting to the inside of the bag wall is shown in FIG. 46A (showing the side facing toward 138 the bag wall) and FIG. 46B (showing the side facing away 137 from bag wall). The computing unit panel may include one or more electrical connections 64c on any side or edge to connect with batteries, telecommunication equipment, wireless radio communication equipment, audio connector, display panel (see FIG. 6A), keyboard, memory, sound and/or microphone facilities as well as any other equipment for computer use. Either side of the computing unit panel may include electrical connections 35c and/or attachment parts 36c adapted to connect the audio connector to either side of the computing unit panel and, via the computing unit panel, to other components of the communication assembly. These types of connections connecting the computing unit panel to the audio connector may be used with bag computers of any style. An additional audio connector may be attached to the communications assembly via the computing unit panel in this way to use, for example, a different style of microphone and/or earphone adapted to use with, for example, stereo music.

It is easy to imagine that the telephone handset connector, its attachments and electrical connection of FIGS. 34 and 35 may be adapted to attach directly to the attachments and electrical connection of the computing unit panel (FIGS. 46A and 46B) so that the telephone handset may be removably stored and connected directly to the computing unit panel on the inside or outside of the bag.

These drawings also show the computing unit panel side facing toward 138 the bag front wall may include one or more computing unit panel heat dissipation outlets 120a matching one or more bag heat dissipation outlets 120 (FIG. 33) on the bag front wall.

FIG. 47 (supplementing FIGS. 46A and 46B) further shows the audio connector 146 side facing the bag front wall and/or computing unit panel. For electrical connection to the audio connector, the computing unit panel electrical connection 35c (FIGS. 46A and B) may be adapted to connect with an audio connector to telephone handset connector electrical connection 35b on the audio connector 146 when mounted to the computing unit panel. The audio connector may be used in this arrangement to electrically connect directly with a telephone unit inside the computing unit panel without the use of a separate telephone handset or telephone handset connector. The computing unit panel attachment parts 36c (FIGS. 46A and B) may be adapted to physically connect with the audio connector attachment part 36a on the audio connector.

FIG. 48 shows the inside surface 85 of the bag front wall 2 which may include a pattern of attachment holes through the wall and/or a bag attachment structure 31 and bag electrical access opening 112 to match the computing unit panel and the audio connector. A computing unit panel support structure 145 may be included to hold the computing unit in place on the wall. The attachment structure and/or electrical access opening may be located on and/or through the support structure for the computing unit panel so that the audio connector may be attached to the computing unit panel side facing away from bag wall while it is mounted in its support structure. Alternatively, the audio connector may attach directly to this side of the computing unit panel without any bag wall or support structure between the panel and the connector.

In FIG. 49 the computing unit panel is attached to the inside surface of the bag front wall by its support structure and the audio connector 146 is attached to the computing unit panel ready for use. Also shown is that the bag front wall may have an extension 177 between the computing unit panel and the front wall to side wall junction 187 (FIG. 33). This extension may act as a bumper protecting the computing unit panel and side mounted electrical connections from blows from the side. To supplement this extension, the bag front wall may be reinforced with thicker or stiffer material, rigid or semi-rigid plastic or foam, layered or padded material, rubber, leather or other material to cushion the bag but still suitable for bag construction.

FIG. 50 shows that the audio connector 146 may alternatively be mounted to the inside surface 8a of the bag cover/intermediate panel 8 which may be rigid. In this case, there may be an audio connector to computing unit panel electrical connection 35d leading from the audio connector to a computing unit in the cover/intermediate panel or through an electrical access opening 112 (FIG. 45) in the bag front wall to a computing unit panel mounted inside the bag. There may also be an audio connector to display panel electrical connection 35e leading from the audio connector to a telecommunications, audio and/or computing unit located in the display panel 13 pivotally attached to the cover/intermediate panel 8. The audio connector to display panel electrical connection may lead to the display panel via a removable electrical connection on a clasp mounted on the cover/intermediate panel and meant to removably hold the display panel to the cover/intermediate panel. The display panel, thus, may be an independent telephone handset removable from a handset holder (the cover/intermediate panel). Thus, in this example, the telephone handset connector is attached to the bag and the telephone handset is attached to the telephone handset connector but the audio connector is attached to the telephone handset directly and without any bag between them. The drawing shows that, in any case, the cover/intermediate panel 8 may include sides 8d which may shape the cover to include a hollow area facing the bag and suitable to completely cover the audio connector and display panel.

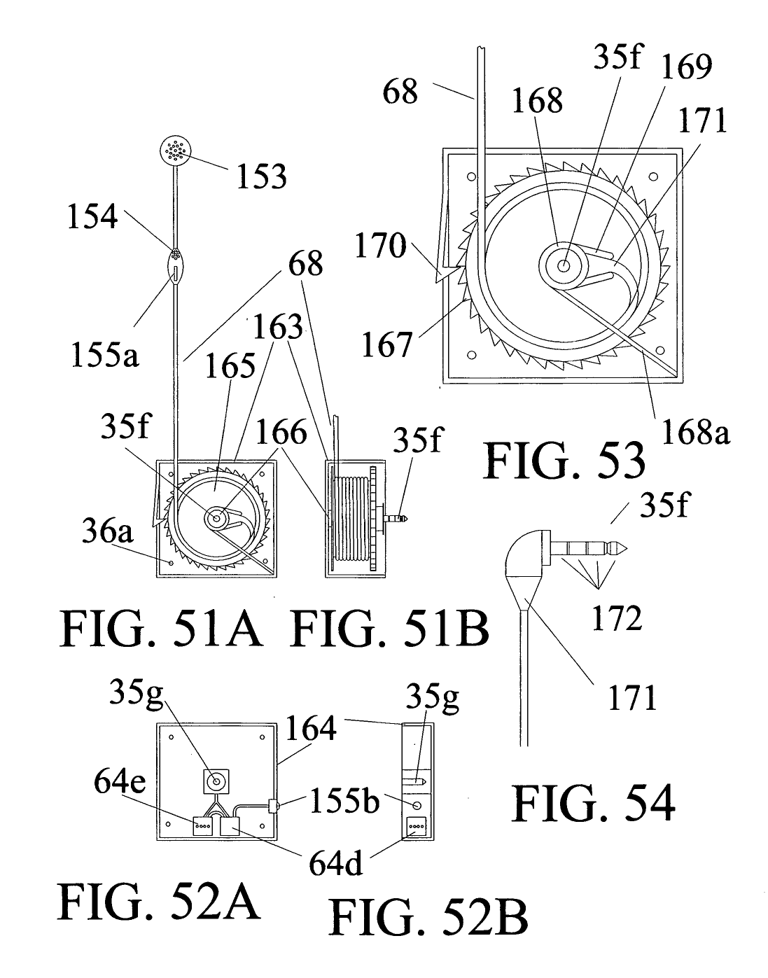

FIGS. 51 to 54 show one alternative type of audio connector including a reel type wire storage device. FIG. 51A and FIG. 51B show a body part of this audio connector with a front view (FIG. 51A—left) and a side view (FIG. 51B—right) of a spool type audio connector designed to connect a speaker and/or microphone assembly (for example, speaker/earphone 153, microphone 154 and/or headset/phone/computer control 155a) with the remainder of the bag mounted communication assembly. It includes a body part 163 including attachments 36a to join the body to a bag and telephone handset connector, a spool 165 to wind an electrical wire 68 on, an axle/bearing pivoting holder 166 for the spool, and a male rotating electrical connection 35f from the turning spool to a stationary part.

FIG. 52A and FIG. 52B show the audio connector cover part of the audio connector (above) with a front view (FIG. 52A—left) and a side view (FIG. 52B—right). The cover part fits the body part and completes the enclosure of the audio connector. It includes a cover part 164 and a female rotating electrical connection 35g complimentary to the male rotating electrical connection on the spool and is the stationary part of the electrical connection that connects the wire on the spool to the remainder of the audio connector. Also included may be an audio connector to telephone handset connector electrical connection 64d connecting the female rotating electrical connection to the telephone handset connector; and an audio connector to computing unit panel electrical connection 64e connecting the female rotating electrical connection to a computing unit in a computing unit panel or in a display panel. There may also be one or more controls 155b (eg button) adapted to connect with and control telephone functions (such as answer and hang up), computer functions, speaker functions and/or microphone functions.

FIG. 53 shows an enlarged image of the body part front view in FIG. 51A. Other features may include a ratchet 167 for holding the wire extended, a rewinder 168a such as a spring, elastic or rubber band, rewinder spool 168, a wire end electrical fixture holder 169 adapted to hold a standard earphone/microphone plug fitting 171 and a pawl 170 to start and stop rewinding,

FIG. 54 is a commonly used male electrical plug 35f for earphone and earphone/microphone combinations and suitable for use in this type of audio connector. It may have a plug body 171 to match the wire end electrical fixture holder 169 (FIG. 54), a male connection to fit the female rotating electrical connection 35g (FIG. 52) and may be fitted with multiple connection sites 172 to accommodate, for example, stereo sound, speaker, microphone and/or telephone.

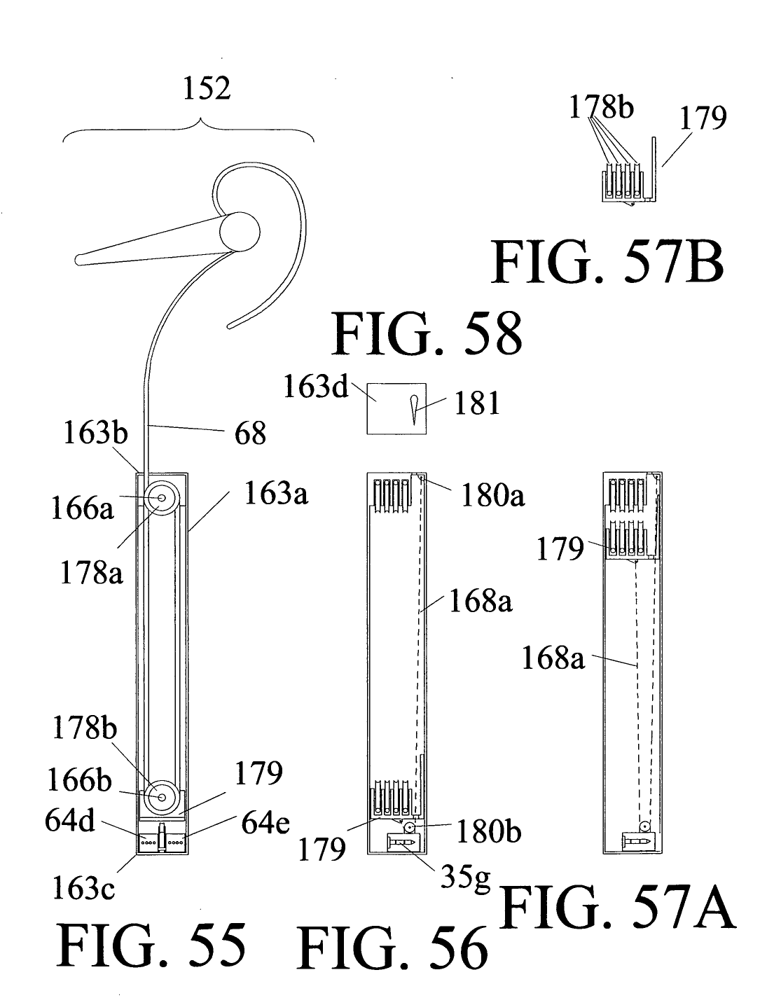

Shown in FIGS. 55 to 58, the audio connector may, alternatively, include a pulley type wire storage device. Shown in a side view FIG. 55, it is comprised of a body 163a which holds pulleys with an electrical wire 68 which leads to a speaker and/or microphone assembly 152. The electrical wire 68, may lead around one or more pairs of pulley wheels with the first pulley 178a of the pair near one (top) end 163b of the body and the second pulley 178b of the pair near the opposite (bottom) end 163c of the body. One or more (in this drawing 4) second pulleys are mounted to a second axle 166b in a carriage 179 which can slide end to end in the body. The first pulleys are mounted near a body end (top end in this case) to a first axle 166a fixed to the body 163a.

Also shown in this figure; an audio connector to telephone handset connector electrical connection 64d; an audio connector to computing unit panel electrical connection 64e; a speaker/microphone wire electrical connection 35g (FIG. 56).

FIG. 56 shows the same arrangement but from a front view and with the wire removed. As wire is extracted from the body, the carriage 179 moves toward the top of the body as wire is taken from storage around the pulleys. Also shown in this drawing are a rewinder 168a (shown as a dashed line), such as a spring, elastic or rubber band, the anchor 180a to hold the rewind mechanism and a pulley 180b to reverse rewind mechanism direction of force; an electrical connection 35g (socket) to match the male connection on the wire leading to the speaker and/or microphone. FIG. 57A is the same view as FIG. 56 but with the carriage 179 moved toward the top of the body. FIG. 57B shows the carriage 179 separated from the body and holding four second pulleys 178b. A top view FIG. 58 shows a body top wall 163d and that it may include a rewind lock 181 such as a shaped exit hole configured to pinch, jam and selectively hold the wire outside of the body against the force of the rewind mechanism.

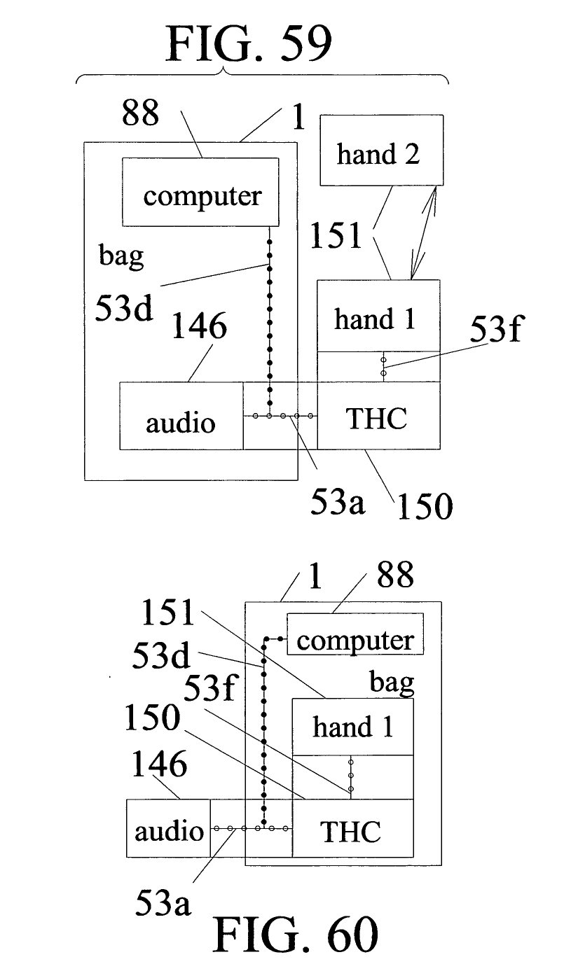

In the diagrams of FIG. 59 to FIG. 62, lines with white circles represent the usual audio electrical connection while the lines with black circles represent the additional or optional audio electrical connection. “THC” represents the telephone handset 150: “audio” represents the audio connector 146: “computer” represents the computing unit panel 88: “hand 1” represents the telephone handset 151.

FIG. 59 is a schematic diagram approximating the bag mounted communication assembly arrangement of FIGS. 33 to 28 showing the electrical connections between the components of the bag mounted communication assembly.

The audio connector 146 (here shown inside the bag) may have an audio connector to the telephone handset connector electrical connection 53a (see also 35a and 35b, FIG. 35) leading from the audio connector to the telephone handset connector 150 (here shown outside the bag). A telephone handset 151 may be electrically connected to the telephone handset connector with a telephone handset to telephone handset connector electrical connection 53f (see also 64a and 64b in FIG. 41A). “hand 2” shows the same telephone handset removed from the telephone handset connector and its electrical connection. If there is a separate computing unit panel 88 (here labeled “computer”) used with the assembly, an audio connector to computing unit panel electrical connection 53d may be included (see also 35d, FIG. 38). Electrical connections 53a and 53d may commonly connect the computing unit panel, audio connector and telephone handset connector. Electrical power to drive the assembly may be supplied by either the computing unit panel or the telephone handset.

FIG. 60 is a schematic diagram showing a variation of FIGS. 33 to 38 and shown in FIG. 64A where the telephone handset connector includes a telephone handset to computing unit panel electrical connection. The diagram shows that the telephone handset connector 150 and audio connector 146 may be reversed with regard to their positions inside and outside the bag wall. The audio connector 146 is now shown on the outside of the bag wall and the telephone handset connector 150 is shown on the inside of the bag wall. The audio connector to the telephone handset connector electrical connection 53a, telephone handset to telephone handset connector electrical connection 53f and audio connector to computing unit panel electrical connection 53d are analogous to FIG. 59 and remain inside the bag. This arrangement allows the user quick access to the equipment most frequently used.

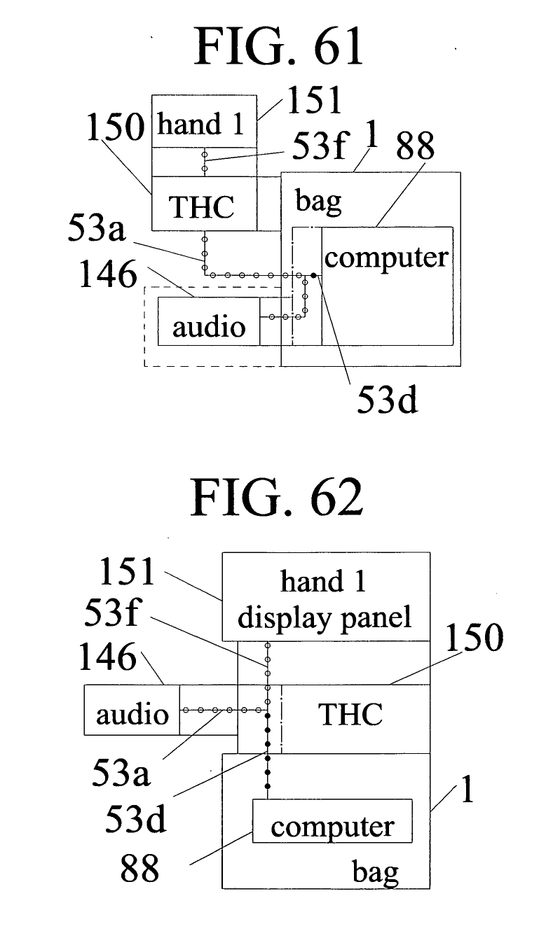

FIG. 61 is a schematic diagram approximating the bag mounted communication assembly arrangement of FIGS. 44 to 49. Here the audio connector 146 is attached directly to the computing unit panel 88. The audio connector 146 may be on the outside of the “bag” 1 or inside the bag (as indicated by the dashed line). The cover/intermediate panel (here analogous to the telephone handset connector and labeled as “THC” 150) is attached to the outside of the bag and holds the telephone handset 151. The audio connector to the telephone handset connector electrical connection 53a may lead from the audio connector to the telephone handset connector 150 and may pass through the computing unit panel 88 (including the area enclosed by the dot-dash line). An audio connector to computing unit panel electrical connection 53d may be included to electrically connect the computing unit panel with the telephone handset connector and the audio connector; this may be a common electrical path. The telephone handset and telephone handset connector may be electrically connected with the telephone handset to telephone handset connector electrical connection 53f.

FIG. 62 is a schematic diagram approximating the bag mounted communication assembly arrangement of FIG. 50. In this case the audio connector 146 is attached to the telephone handset connector 150 (cover/intermediate panel 8 in FIG. 50) which is itself attached to the bag. The audio connector to the telephone handset connector electrical connection 53a establishes communication between these two. The telephone handset connector may only physically hold the connection 53a with electrical connections running parallel to its surface (indicated by the dot/dash line). Instead, the telephone handset connector may include the connections for telephone handset 151 and/or computing unit panel. The removable telephone handset 151 (display panel 13 in FIG. 50) and handset connector may be electrically connected with the handset to handset connector electrical connection 53f (see also 35e, FIG. 50). The telephone handset (labeled “hand 1 display panel”) may include the primary display panel and may also include a computing and telecommunications units.

An audio connector to computing unit panel electrical connection 53d may be included to electrically connect a computing unit panel 88, if present, inside the bag 1, with the telephone handset connector and the audio connector. The audio connector, telephone handset connector and computing unit panel 88, if present, may be on a common electrical path.

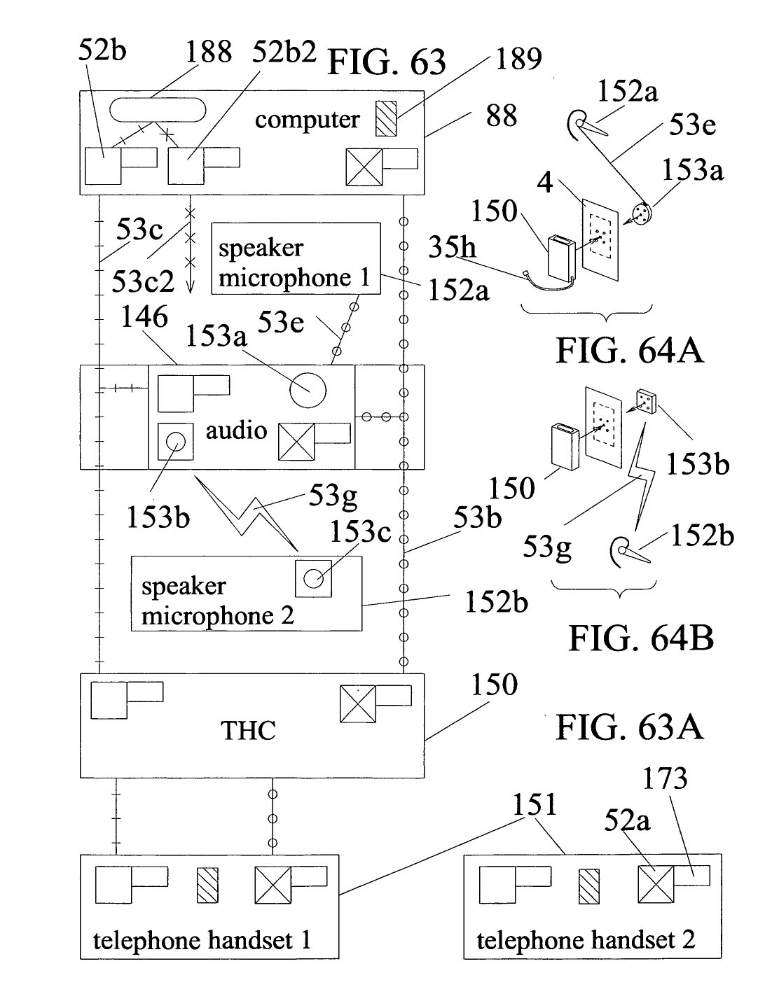

Further details for the bag mounted communication assembly are shown in FIG. 63. It shows the electrical communication connections between the audio connector (“audio” 146), telephone handset connector (“THC” 150), telephone handset (“hand 1” 151) and computing unit panel 88 (“computer”), if present. “hand 2” represents the telephone handset removed from and independent from the telephone handset connector (see also FIG. 63A). Digital radio transmitters and/or receivers 52b (also called “digital radio telecommunication units”) are white squares; audio radio transmitter and/or receiver 52a (also called “audio radio telecommunication units)) are squares around an “X”; local wireless radio transmitter and/or receiver 153b and 153c (also called “local wireless radio telecommunication units”)are squares around a circle; SIM modules 173 are small rectangles attached to the squares; power sources 189 are small rectangles with diagonal hatching.

This diagram shows that, in addition to the audio electrical connection path 53b (shown as the line with white circles) linking electric audio input and output, there may be one or more separate electrical connection paths for digital information 53c (shown as the line with right angle cross lines) linking electric digital input and output. For example, a transmitter and/or receiver located in one component (e.g. telephone handset connector 150) may have a separate digital electrical communication path 53c to another component (e.g. computing unit panel 88) to send digital information independent of the audio information.

There may be multiple audio and/or digital information electrical communication paths. Digital information, for example, may enter the computing unit panel via an additional and separate transmitter and/or receiver 52b2 and be distributed to components using a separate communication path 53c2 (line with “x”s) which follows the same path route as 53c. The computing unit may include a communication integrator 188 to request and receive portions of information from one transmitter and/or receiver to be integrated with information from another transmitter and/or receiver. The communication integrator may be programming, a sub-processor or a separate computing unit. The computing unit panel may include a power source 189 (e.g. battery—shown as a rectangle with diagonal hatching) which may be used to power the entire assembly and to recharge the batteries of components such as the telephone handset, cell phone, 2-way radio or wireless microphone/speaker headset. The power source electrical connection to other components may be included in or parallel to any one or all of the separate electrical communication paths shown.

The purpose of multiple transmitters and/or receivers and paths may include 1) the ability to transmit and receive both telephone and internet information at the same time and 2) the ability to receive digital internet information from more than one radio source at the same time thus speeding the receipt of large amounts of internet telecommunication information in a mobile environment. This may be integrated with portable computer multiprocessor capability.

Any one or more of the audio connector, telephone handset connector, telephone handset and computing unit panel may be chosen as an alternative place for locating an audio transmitter and/or receiver 52a (shown as a white square around an X) and/or digital transmitter and/or receiver 52b (shown as a white square). SIM units are shown as rectangles 173 attached to their transmitters and/or receivers.

The purpose of multiple possible transceiver/SIM locations may be 1) to provide more or less handy access to SIM cards so they can be changed with, for example, foreign travel requirements, 2) to locate the transmitters and/or receivers and SIMs in more or less replaceable components for renewal, upgrading or adding units, 3) to allow continued use of a component when another component (for example, the telephone handset or the computing unit panel) is missing, disconnected or turned off.

This diagram also shows that the audio connector may include or be a wireless radio transmitter and/or receiver 153b (shown as a white square around a circle and also called a “radio telecommunication unit”). A speaker and/or microphone (“speaker microphone 1” 152a) may be electrically connected to the audio connector by an electrical wire 53e, for example, stored on a wire storage device 153a. Alternatively or additionally, a speaker and/or microphone (“speaker microphone 2” 152b) may be electrically connected to the audio connector wirelessly 53g using a transmitter and/or receiver 153b in the audio connector and a matching transmitter and/or receiver 153c in the speaker and/or microphone.

FIG. 64A and FIG. 64B are perspective drawing of the telephone handset connector 150 and audio connector connected through a bag wall 4 and shown in two configurations. In the configuration at the top (FIG. 64A), the audio connector's wire storage device 153a communicates with the speaker and/or microphone 152a using an electrical wire 53e. In this view the telephone handset connector includes a telephone handset connector to computing unit panel electrical connection 35h as in the case where the telephone handset connector is attached to the inside of the bag wall. In the configuration at the bottom (FIG. 64B), the audio connector's radio transmitter and/or receiver 153b communicates wirelessly 53g with the speaker and/or microphone 152b instead.

To improve the viewing and positioning of the display panel while using the bag computer, a bag computer bag bottom operator body interface may be included as part of the bag and/or operator apparel.

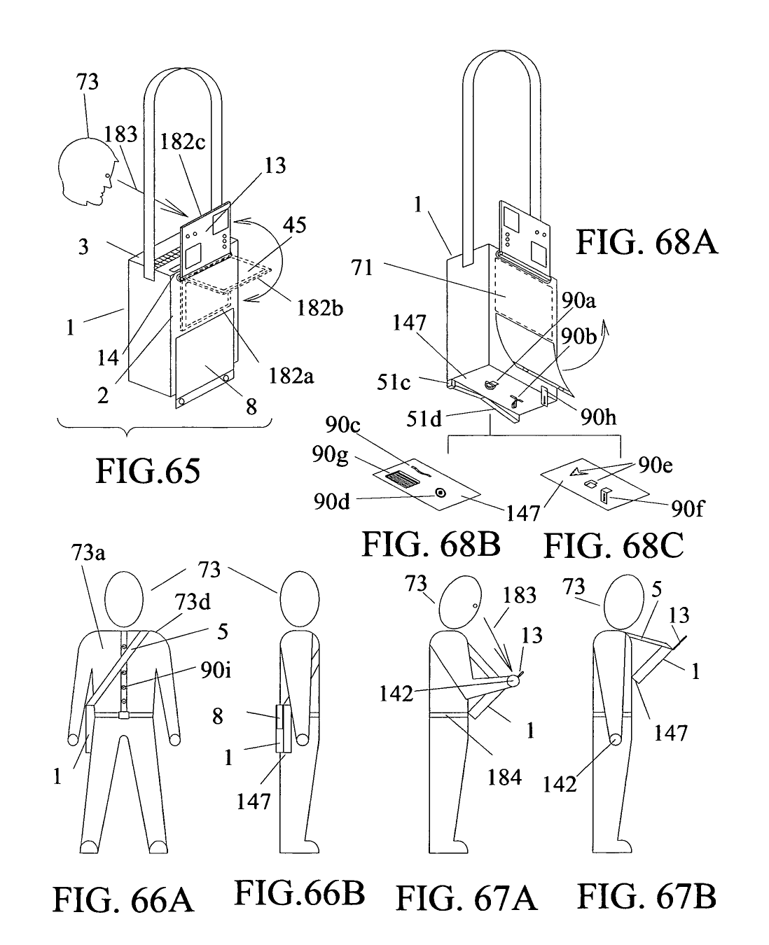

As shown in FIG. 65 an electronic display panel 13, including a display 45, may be mounted near the top edge 14 of the front wall 2 of a bag 1. The bag may include a pivoting cover 8 to cover the display panel when it is in a storage position 182a (dashed lines) in a computer equipment storage area 71 on the outside surface of the bag's front wall.

The display panel may be pivotally mounted on the bag so it may be moved from a storage position to one or more operating positions 182b (dashed lines) including a vertical operating position 182c which allows an operator 73 to view 183 the display panel's display from in back of the bag and over the top of the bag's top wall 3.

FIG. 66A (front view) and FIG. 66B (side view), show an operator 73 wearing the bag 1 by its strap over his shoulder 73d area while the display panel is stored and covered by the cover 8. The operator is wearing normal clothing 73a including one or more attachable objects 90i that may be attached to the bag such as, in this case, buttons. Other types of clothing which may unintentionally or intentionally have an object or shape that may be joined with a bag bottom operator body interface may include a shirt, smock, coat, tunic, overalls, apron, necklace or vest. The object 90d worn by the operator may be specifically designed to match and join to an interface near the bag bottom. Other examples of joinable objects that may be found on an operator's clothing may include “D” ring, loop, strap, button, hook, tab and button hole, friction or gripping surface, snap, clip, tie, hook and loop, magnet or other interface means. FIG. 67A shows the operator using and manipulating the computer and display with the display panel 13 in vertical operating position and the bottom wall 147 of the bag supported by an attachable object on the operator's body, in this case near his belt 184, to position the display panel further from the operator's body and the display more easily viewed 183. FIG. 67B is the same view as FIG. 67A but showing that the display panel and bag can be supported by the operator's body (front torso area) and strap 5 without the operator using his hands 142. The purpose of the bag bottom operator body interface is to support and position the bag to improve the operator viewing of the bag computer's display panel while in a vertical operating position.

In FIGS. 68A, 68B and 68C, the outside surface of the bottom wall 147 of the bag 1 is shown three times. Shown are various different types of bag bottom operator body interfaces (90a to 90g, 51c and 51d) configured to temporarily join with and hold the bottom of the bag to the operator so that the bag will not slipping up or down and the bag's display may be viewed in a vertical operating position over the top of the bag's top wall. The bag bottom operator body interface may include “D” ring 90a, loop 90b, strap 90c, button 90d, hook 90e or pocket (of metal, plastic or cloth), tab and button hole 90f, friction or gripping surface 90g, snap, clip, tie, hook and loop, magnet, legs 51c, shaping 51d, or other attachments or means to aid in temporarily holding the bag bottom to the operator or his clothing. The interface 90h may be located on a nearby adjacent side wall of the bag, the bag bottom or anywhere on the bag so that the bottom of the bag may be held to the operator, the bag is prevented from slipping, and the display may be viewed in the vertical operating position.

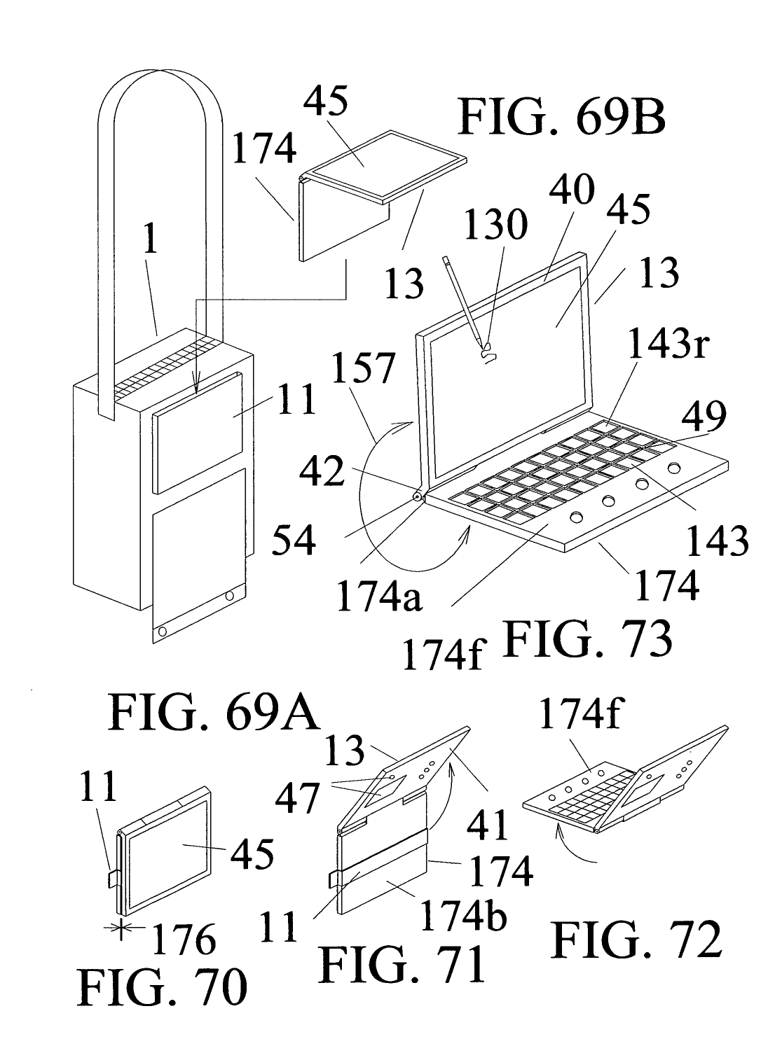

FIG. 69A and FIG. 69B show a bag computer two panel computer with keyboard for holder mounting. It is shown with a bag 1 and holder 11 adapted to fit the computer body 174 of the two panel computer and hold the display panel 13 and the display 45 to the bag 1 in an operating position in the view of an operator. In this case, the holder is a pocket. The holder may alternatively be a strap (FIGS. 71, 11), set of matching attachments on the computer body and holder, bracket or other means to hold the computer body to a bag or to some other object.

Shown in FIG. 70 the display panel and computer body are in a closed storage position with the back side of the display panel and the back side computer body facing each other and the front sides of the display panel and computer body facing outward away from each other. The display 45 is shown. The hinge may be arranged to allow a gap 176 between the display panel and computer body to allow the material of a holder 11 to fit between them. In the storage position there is a 0 degree angle between the display panel and computer body. In FIG. 71, the display panel 13 and computer body 174 are in an operating position when mounted in a holder 11, for example, on a bag. One or more manual controls 47 may be located on the display panel back side 41 for controlling the computer or display. The computer body back side 174b is visible. In this operating position there is about a 150 degree angle between the display panel and computer body. In FIG. 72 the computer has been dismounted from the holder for use, for example, on a table. The computer body has been further pivoted so its front side 174f is facing up and visible and has a keyboard ready for use. In this operating position there is about a 240 degree angle between the display panel and computer body. This figure is the same panel positioning as FIG. 73 but here the computer is turned with the display panel back side visible.

Shown in FIG. 73, the computer body includes a keyboard 143 for the bag computer two panel computer with keyboard for holder mounting. The computer is comprised of a display panel 13 and a computer body 174. The display panel has a front side 40, including an electronic display 45, an attachment edge 42 and a back side. The display may have touch screen controls 130 (indicated by stylus and screen marking). The computer body is comprised of a front side 174f, a back side, and an attachment edge 174a. The computer body may have a keyboard 143 on its front side. Keyboard may include recessed keys 143r depressed below the general level of the panel surface and/or may have raised spacers or finger guides 49 to keep the keys from being depressed while in a holder or while the computer body is set on a surface (e.g. table) with its front side facing down. The display and computer body are pivotally attached to each other by their attachment edges. Attachment may be with a hinge 54 such as an axle/bearing hinge, flexible fabric attached to the attachment edges of the two panels or other means to pivotally attach the two panels. A prop may be included between the display panel and the computer body to hold the two panels in an operating angle. The hinge may be able to pivot about 225 degrees and would preferably pivot to 270 degrees. This pivoting arc 157 allows the display panel to be usable while either the front side or the back side of the computer body is against an object such as a table or a bag front. The pivoting arc allows the keyboard to be used when the computer body is set with its back side on a table.

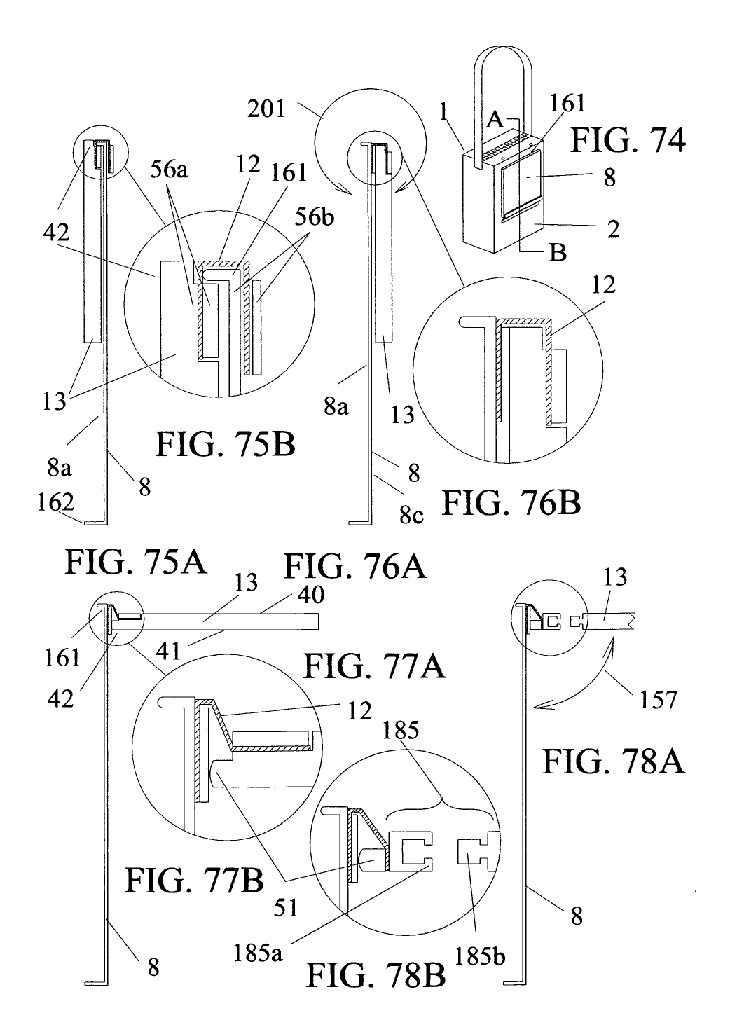

When the display panel of a bag computer is mounted to the distal edge of a cover/intermediate panel (see FIG. 44) the hinge attaching the display panel to the cover may be improved for durability, ease of construction and pivoting characteristics. In FIG. 74, the bag 1 is shown with a cover 8 in a closed position on the bag front wall 2 with the display panel hidden between the cover and bag front wall. The cover (intermediate panel) distal edge 161 is toward the top of the bag front wall. (Pease refer to FIG. 44 to see the cover and display panel in an operating position). FIG. 75 to FIG. 78 show in cross section at A/B in FIG. 74 the improved bag computer intermediate panel to display panel pivoting computer equipment mount.

FIG. 75A is the cross section side view of the cover 8 (also called an intermediate panel) and display panel 13 assembly (for drawing clarity, the bag and front wall are not shown—the cover proximal edge 162 would normally be pivotally attached to the bag front wall) with the display panel in a closed storage position next to the inside surface 8a of the cover. In FIG. 75B, a magnification of the PCEM area on FIG. 75A, a pivoting computer equipment mount or retainer 12, here shown as a flexible fabric attachment flap but may alternately be an attachment filament, attaches the display panel to the bag and is shown with diagonal hatching. It extends from the display panel attachment means 56a, such as a socket/plug, clamp or two jaws, on the attachment edge 42 of the display panel 13 to a cover attachment means 56b, such as a bonding means (e.g. glue, sewing, rivet), a clamp, socket/plug, or two jaws, on the cover. The flexible fabric for a PCEM may be clamped, screwed, riveted or otherwise attached near the distal edge 161 of the cover or may be a part of the cover or its surface, such as a bonded or glued covering, layer or overlay.

Shown in FIG. 76A and in magnified PCEM area of FIG. 76B, the display panel 13 has been pivoted out of the storage position from beside the inside surface 8a of the cover 8 to an operating position next to the outside surface 8c of the cover. The flexible fabric retainer 12 now leads out of the cover. The display panel has rotated 360 degrees 201. This large amount of rotation is due to the use of the flexible fabric retainer as a PCEM.

Shown in FIG. 77A and in magnified PCEM area of FIG. 77B, the display panel 13 is now propped in an operating position outside of the cover 8 and about perpendicular to the cover surface plane. An extension of the display panel is used as a display panel prop 51, contacts the cover and, along with the retainer, holds the display panel in an operating position angle 157 relative to the cover. The flexible fabric retainer 12 suspends the display panel.

One advantage and purpose of attaching the display panel 13 by its attachment edge 42 to the display panel cover 8 (also called an intermediate panel) distal edge 161 is that both the front side 40 and back side 41 of the display panel are exposed for using a computer related tool such as a display, manual controls, camera, heat sink/dissipater. With the back side of the display panel exposed, the operator can use his fingers to manipulate the computer and display panel controls found there (including graphic user interface) while holding the display panel with his hands in a most natural way and with great accuracy.

Shown in FIG. 78A and in magnified PCEM area of FIG. 78B, the PCEM (retainer) may be connected to a display panel clasp 185 designed to removably hold a display panel 13 to the cover 8. The clasp may have a clasp attachment 185a to match a display panel attachment 185b on an edge of the display panel.

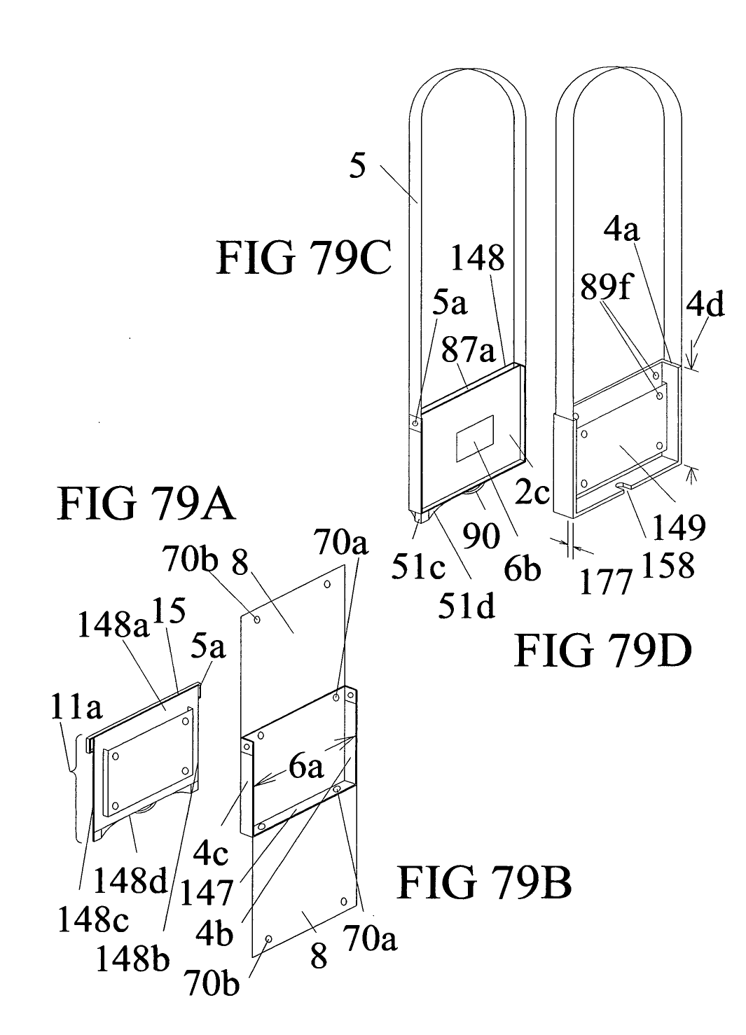

FIG. 79A, FIG. 79B, FIG. 79C and FIG. 79D show views of a holder 11a for a folding wearable computer or remote control viewer. As subsequently described, this holder may also be suitable to hold a “notebook” computer, a “lap top” computer or other commonly used computers with two pivotally attached panels with the first panel equivalent to the “body panel” and the second panel equivalent to the “display panel”.

In FIG. 79A, the holder is comprised of a right edge 148b, a left edge 148c and a bottom edge 148d, a top end 15, a back wall (148 in FIG. 79C) with an inside surface 148a. The back wall may include openings to, for example, allow ventilation, lighten the holder, or allow access to controls or maintenance features on the computer first panel (body panel). The walls may be rigid. The holder includes body panel holding part to hold the first panel of the computer with two pivotally attached panels to the holder. For example, the body panel holding part may be one or more computer body panel attachments (89f in FIG. 79D), pocket or band (149 in FIG. 79D), a socket (87a FIG. 79C), matching shaping, or other attachment on the holder to hold the computer first panel (body panel) to the holder. The holder includes a holder bottom operator body interface (51c, 51d and 90 in FIG. 79C) to temporarily hold the holder bottom edge to the an operator's body. Shown in this view as a tube-like structure on the holder back wall and with openings near the right and left edges of the holder, the holder includes one or more strap attachments 5a to hold a strap to the right and left edge of the holder. The one or more strap attachments may alternatively be side loops of flexible or rigid material, posts, screw holes or other fixtures to attach a strap.

FIG. 79B shows that the holder may include a bottom wall 147 and one or more side walls (in this drawing, a right side wall 4b and a left side wall 4c) and take the form of a box-like structure with the front and top sides missing and creating and open portion 6a in the holder so that the display panel of the computer held in the holder may be easily accessed by pivoting it about 180 degrees without interference from the holder. The back, side and bottom walls may be rigid to protect the computer. The holder may include a pivoting cover 8 attached to the bottom wall or, alternatively, to the back wall so that it may pivot to cover the top and front open areas of the holder and a computer held in the holder. The cover may be a flap of flexible fabric and/or may include rigid components. Matching holder attachment 70a and cover attachment 70b may be included.

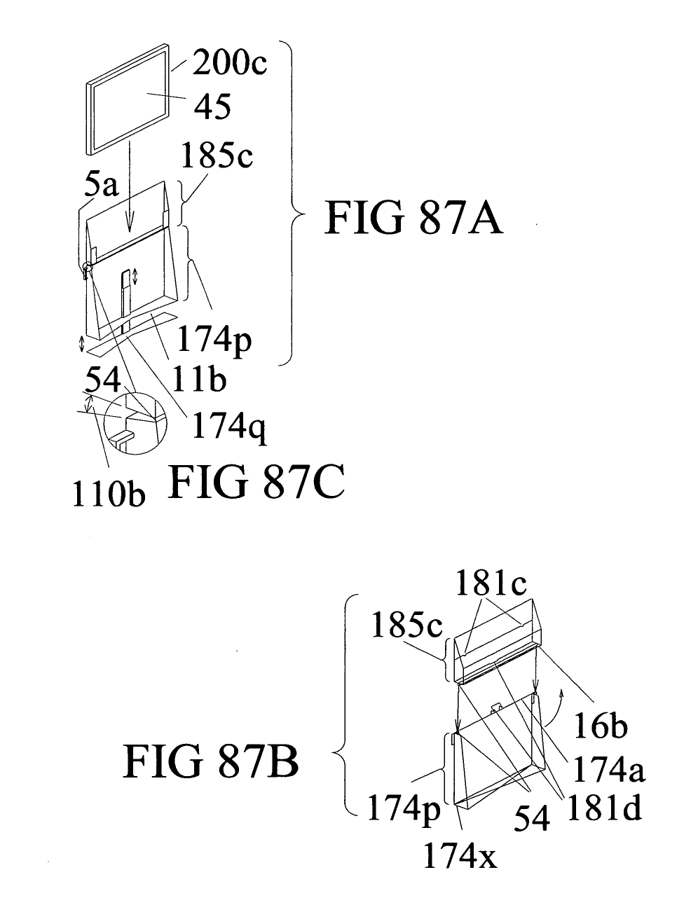

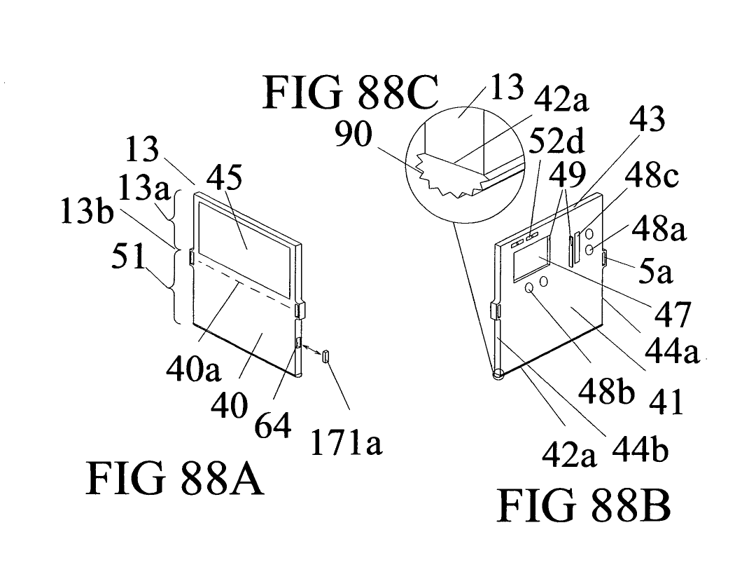

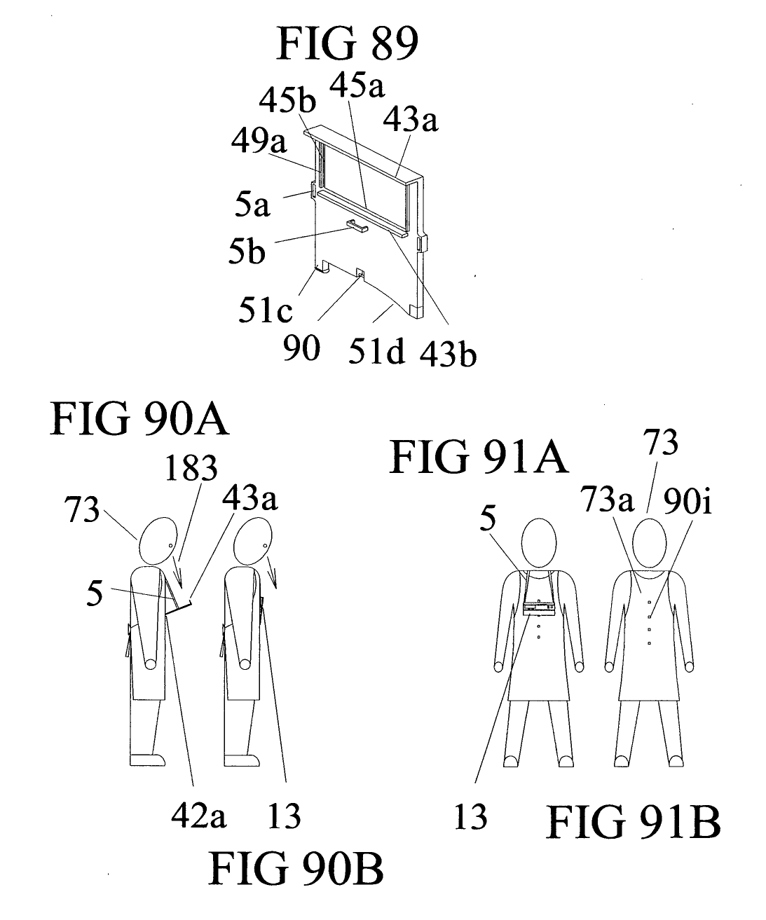

FIG. 79C shows that the holder may further include a carrying strap 5 and/or strap attachments 5a intended to hold the holder with wearable computer to the body of the operator in both a storage position and an operating position. The strap attachment to the holder may be located near the top end of the side or back walls so that the strap supports both sides of the body when operated. The holder may also have one or more computer body panel attachments 89f matching a computer and intended to hold the computer body panel to the holder back wall inside surface. The holder bottom wall or holder bottom edge may include a holder bottom operator body interface 90 meant to temporarily hold the bottom of the holder to an operator's body, lap, waist or front torso area and facilitate viewing by the operator. The holder bottom operator body interface may be or include an interface to match an attachment on or shape of the operator, an interface to attach to a normal object on the operator (e.g. a button), a friction surface (e.g. knurled rubber), a shaping 51d of the holder bottom, legs 51c near the holder bottom, an extension of the holder bottom edge or other attachment or means to assist in temporarily holding the holder to the front torso area (73c, FIG. 83) of the operator's body and position the display for optimal viewing (see also FIGS. 88 and 89). The length of the holder (4d, FIG. 79D) between the top end and the bottom edge may be adapted for optimal positioning of the display panel and may include a bottom end adjustment mechanism for increasing this length (see 174q, FIG. 87A). The holder may include a front wall 2a and form a socket 87a with an open at the top to install the computer body. The socket may be rigid. The socket acts as the body panel holding part to hold a computer first panel to the holder. In such an arrangement the display panel (second panel) may not be able to pivot into the storage position and the computer may be held in the holder only when the display panel is in the open operating position. The socket may include one or more openings 6b to access manual controls on the body panel and may include additional attachments to hold the body in the socket.

FIG. 79D shows that the holder may further include an extension 177 on the side and/or bottom walls for protection of the computer from blows from the front, may have thickened or padded protective bottom, back or side walls 4a, and may have a removal slot 158 in the a wall (bottom) to use a finger to open the computer display panel. The computer body panel attachment may be a pocket or band 149 (which may include attachment 89f matching the computer) to hold a panel of the computer to the holder back wall inside surface. The holder length 4d is shown.

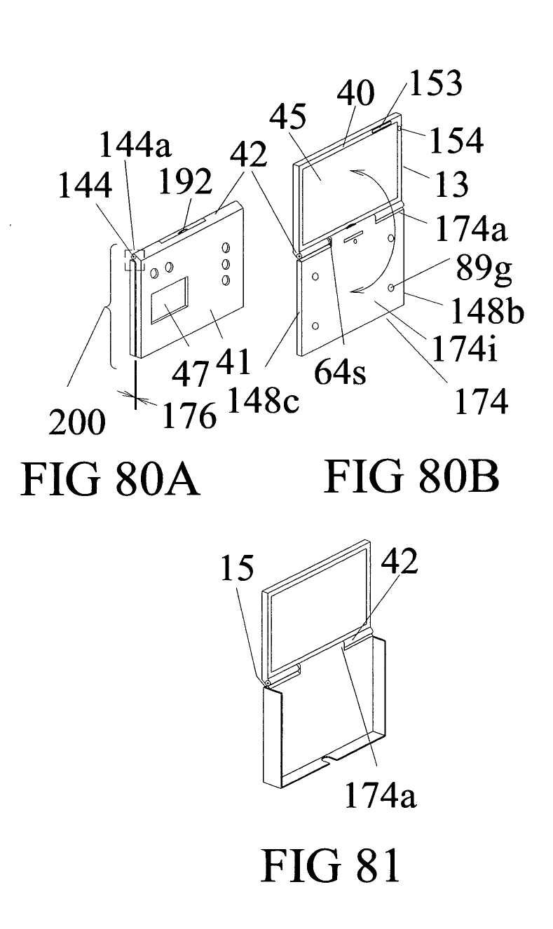

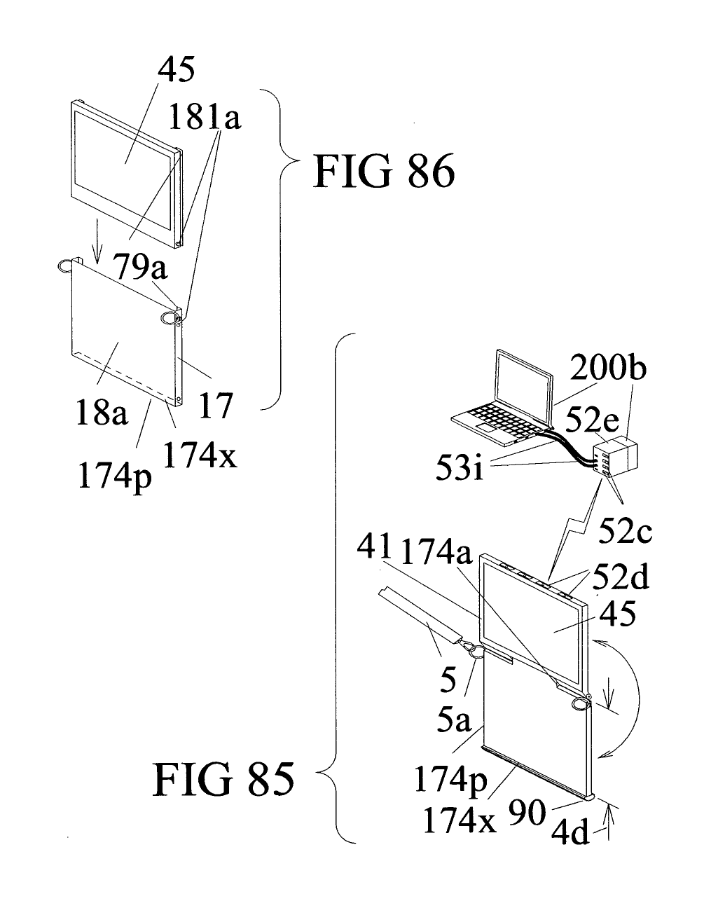

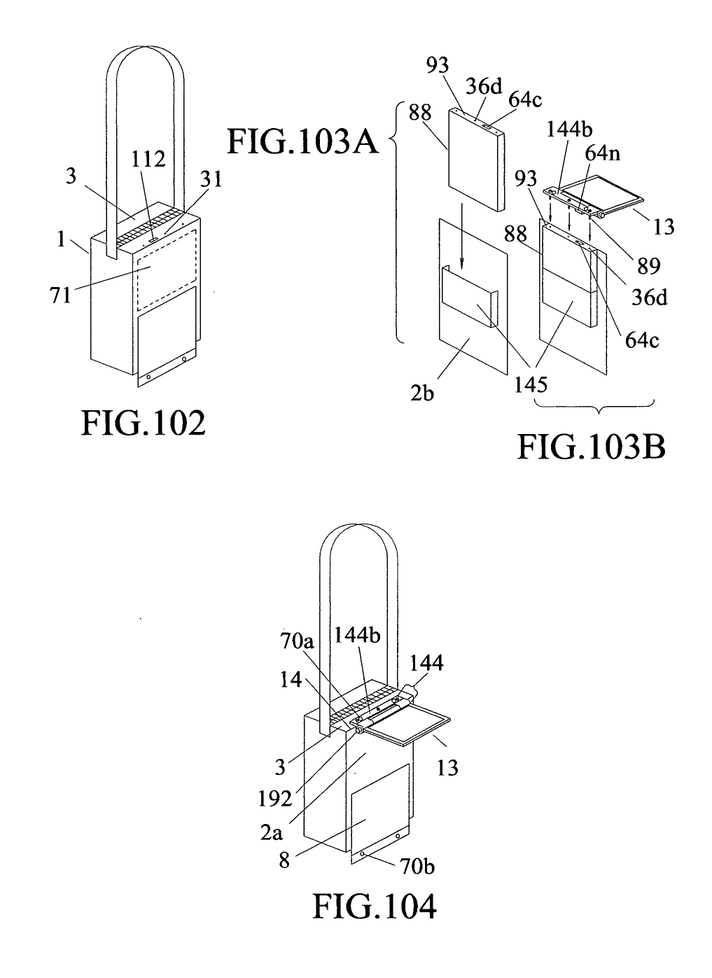

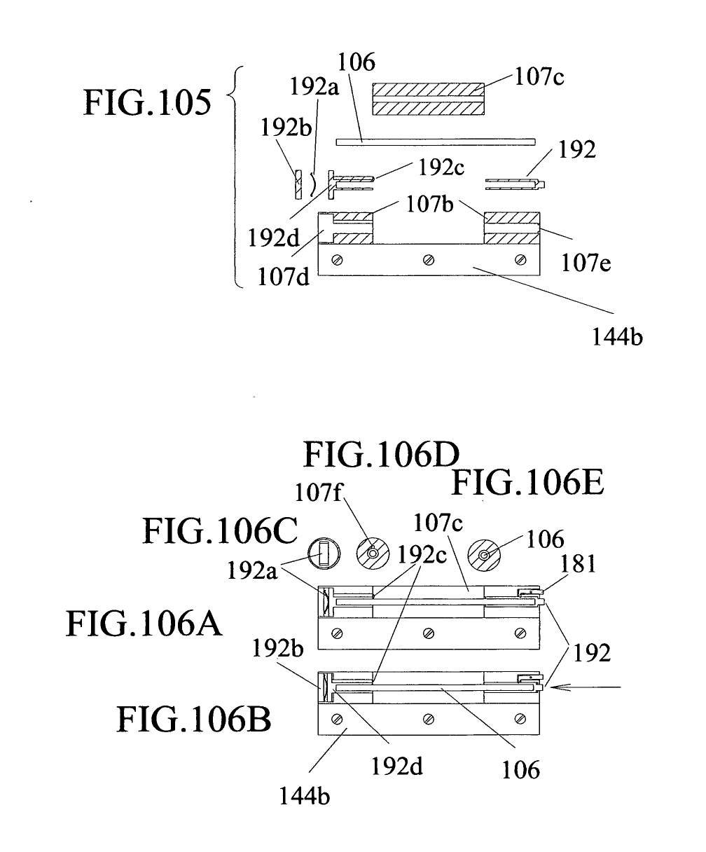

FIG. 80A and FIG. 80B show the computer 200 for mounting in the holder of the folding wearable computer or remote control viewer. It is shown in a closed storage position (FIG. 80A) and an open operating position (FIG. 80B). The computer has two panels: the display panel 13 and the body panel 174 pivotally joined together by a hinge 144 in the hinge area 144a (indicated by dashed square). The hinge may be of a type including an electrical connection 64s between the display panel and the body panel. Parts of the display panel are shown and include a display panel attachment edge 42 which pivotally attaches to the body panel attachment edge 174a, a front side 40 including a display 45 arranged to face toward the body panel when in the closed storage position and a back side 41, possibly including one or more manual controls 47 for the computer or display, arranged to face away from the body panel when in the closed storage position. The display may include a touch screen (see FIG. 6A). The two panels may include a gap 176 between them when in the closed storage position to accommodate holder pocket material when attached to the holder using a pocket or band. In addition to the display, the display panel may include a computing unit, battery, telecommunications, radio transceiver, or other computer related equipment. The body panel may have a right edge 148b, a left edge 148c and one or more holder attachments 89g, such as snaps, hooks or holes, on the inside surface 174i of the body panel which match attachments on the holder. It can be seen that the inside surface of the body panel is adjacent to the display panel front side when in a closed storage position and not in the holder. The display panel or body panel may include a speaker 153 and/or microphone 154 for telecommunications or communicating with the computing unit. The body panel may include a computing unit, batteries, telecommunications, radio transceiver, or other computer related equipment. Alternatively, the body panel may be a panel with no electronics and used only for supporting the display panel and/or attaching it to the holder. In this case, the body panel may be called an operator body prop (see FIGS. 85, 86 and 87). The computer may include an angle holding mechanism 192, such as a spring actuated knob or braking mechanism (see FIGS. 105 and 106) for holding the two panels in the open operating position approximately 180 degrees from the closed storage position.

FIG. 81 shows the holder and computer joined together in an open operating position. The display is located above the holder and the display panel attachment edge 42 and the body panel attachment edge 174a are located near the top end 15 of the holder and near the strap attachments.

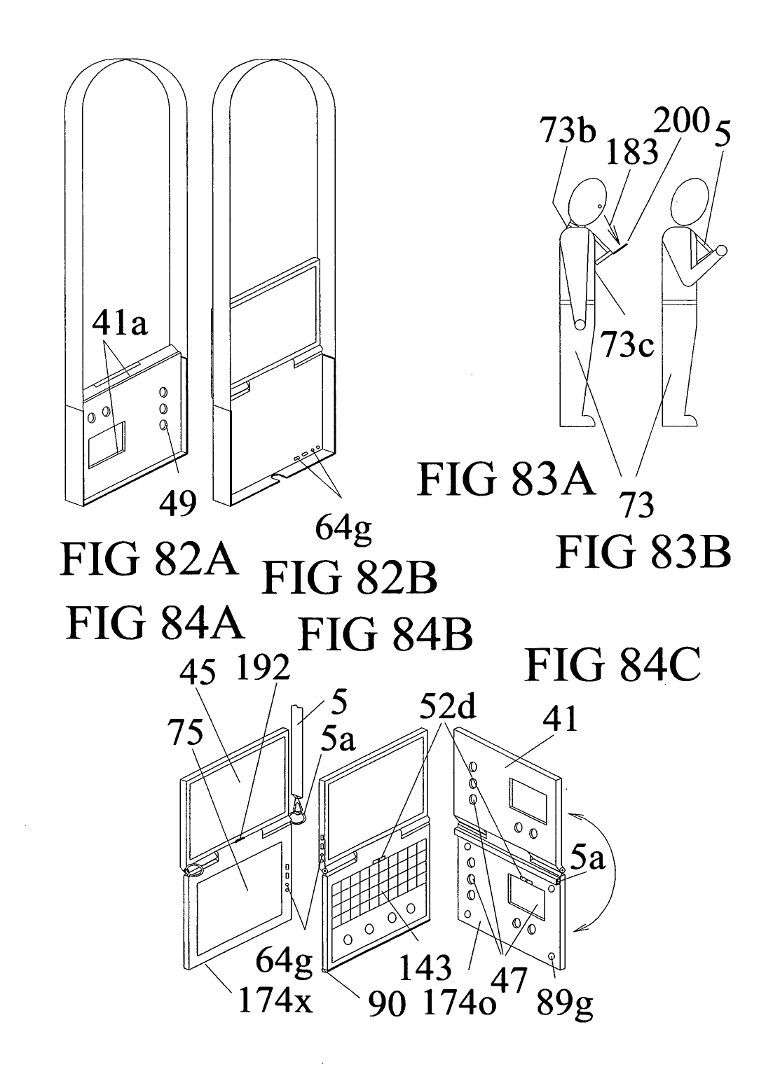

FIG. 82A and FIG. 82B show the holder and computer assembled with the strap included. FIG. 82A is the closed storage position and FIG. 82B is the open operating position. The back side of the display panel may have finger guides 49 for directing operator fingers to control. The back side of the display panel may also have protective layer or cushioning 41a, such as rubber, foam or impact absorbing material or plastic, to protect the computer against blows on its open side. The protective layer and finger guides may be combined using openings in the thickened protective layer to guide fingers to the controls. Electrical connection sockets/plugs 64g may be included to connect with, for example, power supply, external telecommunications (e.g. internet), battery recharge, audio microphone and/or speaker (e.g. earphone) and/or input/output computer peripherals.

FIG. 83A and FIG. 83B show an operator 73 using the folding wearable computer 200 in an operating position while not using his hands (FIG. 83A) and while using his hands (FIG. 83B) for computer control operation. The display panel and computer body are pivoted by the hinge from a closed storage position into in an open operating position with the bottom end of the computer body panel against the operator's body (front torso area 73c) and the body panel extending to the display panel while the strap 5 suspends or stays the computer from the operator's body (head/neck/shoulder area 73b) in a position where the operator can view 183 the display. This way of positioning and using a computer may be seen as a method of operating the computer. The wearable computer's various arrangements of size and attributes noted above may be configured specifically to enhance this method of operation. The goal of this wearable computer's method may be further defined as remotely and wirelessly communicating with a remote separate computer.

FIG. 84A, FIG. 84B and FIG. 84C show three views of the computer in an operating position FIG. 84A, FIG. 84B, and FIG. 84C with a variety of features including: a heat sink/dissipater 75; strap attachments 5a fixed to the computer in the hinge area, on the hinge, near the computer body attachment edge or near the display panel attachment edge for attaching the strap 5 to the computer instead of to the holder; electrical socket/plugs 64g for communication, audio and/or battery recharging; a keyboard 143; attachments 89g on the outside surface 174o of the body panel for attaching the computer to the holder. If located on an operator body prop, a keyboard may include its own transmitter or receiver 52d and power supply for communicating wirelessly with a remote radio telecommunication unit. Alternatively, a keyboard mounted on aa operator body prop may include a (hinge) electrical connection (64s, FIG. 80B) between the display panel and the body panel to connect to a transmitter and/or receiver in the display panel.

FIG. 84A shows that the folding wearable computer may be used and positioned by the operator without any holder with the straps attaching directly to the computer by the strap attachments 5a, the computer body panel and display panel opened and held to about 180 degrees with the angle holding mechanism 192 (see also FIGS. 99, 105 and 106) and the strap 5 suspending the computer from the operator while the computer body panel bottom end 174x contacts the operator to hold the computer in an operating position in the view of the operator (see FIGS. 83A and 83B). The computer body panel bottom end may include a computer body panel bottom operator body interface 90 (FIG. 84B, FIG. 85 and FIG. 88C), such as a friction or gripping surface, attachment or shaping, adapted to temporarily hold the computer to the operator or to an attachment, object or shape on his apparel (see FIGS. 66, 67, 68, 90 and 91). The computer body panel bottom operator body interface may be or include legs or be shaped (see FIG. 89 and FIG. 79C) to assist in holding the computer body bottom end to the front area (73c, FIG. 83) of operator's body. The length of the body panel (see 4d, FIG. 85) between the attachment edge and the bottom end 174x may be adapted for optimal positioning of the display panel and may include a bottom end adjustment mechanism (see 174q, FIG. 87A) for increasing this length.

FIG. 84C shows the computer turned so that the display panel back side 41 and the body panel outside surface 174o are visible. Manual controls 47 for a computer or the display, as previously described, may be located on the display panel back side or, alternatively, located on the computer body outside surface. A strap attachment 5a may be located on this side. If located on an operator body prop, a manual control may include its own transmitter or receiver 52d and power supply for communicating wirelessly with a remote radio telecommunication unit. Alternatively, a manual control mounted on a operator body prop may include a electrical connection (64s, FIG. 80B) between the display panel and the body panel to connect to a transmitter and/or receiver in the display panel.

Shown in FIG. 85, the display 45 now on the back side 41 of the display panel and facing away from the body panel when in the closed storage position (compare FIG. 10 view C).

Also shown in FIG. 85, whatever the arrangement of the display on the display panel, computer body and holder may be, this wearable computer may be a wireless wearable displayer and controller for a remote separate computer (remote control viewer). For example, a desk top or notebook computer may be running and connected by wire to the internet. The wearable displayer and controller may be used to communicate with this computer wirelessly so the operator is more free to move and lounge in a variety of positions. To this end, the wearable displayer and controller may be a system including one or more remote radio transmitters and/or radio receivers 52c (also called “remote radio telecommunication units”) and radio to computer electrical connections 53i, for example by wires and/or plugs, to a remote separate computer 200b and/or internet telecommunications. Computer software programming may be included with the system to interface the remote transmitters and/or receivers 52c to the remote separate computer. In one or more variations of this arrangement, the transmitters and/or receivers and separate computer may be combined (52c and 200b) into one physical unit (e.g. housing 52e) which may lack one or more normal computer input/output devices (e.g. display) to facilitate direct connection to the internet. The wearable remote control viewer (or computer) may include one or more display/control radio transmitters and/or radio receivers 52d (also called “display/control radio telecommunication units”) to remotely communicate functions such as the display information, manual control information, pointing device information, audio information, keyboard information and/or other input/output information with the matching remote transmitters and/or receivers connected to the remote separate computer. Each matching pair of transmitter and/or receiver units (i.e. each pair of display/control radio telecommunication unit and matching remote radio telecommunication unit) may transmit information specifically and exclusively so that they will not interfere with other telecommunication unit pairs or with other nearby electronic equipment. To simplify this remote control arrangement, the computer body panel may, alternatively, be an operator body prop 174p designed to pivotally or slidably attach to the display panel and extend between the display panel and operator body to help the operator to wear the display panel, prop it against his body and view the display. In FIG. 85 the operator body prop attachment edge 174a is shown pivotally attached to the attachment edge of the display panel. The operator body prop may be made of, for example, metal wire, metal or plastic sheet or molded plastic. The operator body prop may include equipment attachments (see 89g, FIG. 80B) to removably attach other radio equipment such as a keyboard or other equipment. The operator body prop may include an operator body prop bottom operator body interface 90 (shown here as a friction device but may alternatively be legs, attachment, shaping or other means to temporary join the prop bottom end to the operator body), strap attachments 5a in the hinge area and/or a strap 5. The operator body prop may contain no electronic equipment thus eliminating the need for electrical passage through the hinge or hinge area. In this case, the display panel may contain all the electronics such as the battery, transmitters and/or receivers, signal interpretation equipment, operator manual controls and computing unit, if present. The length 4d of the operator body prop between the attachment edge and the bottom end 174x may be adapted for optimal positioning of the display panel and may include a bottom end adjustment mechanism (see 174q, FIG. 87A) for increasing this length.

The operator body prop 174p may have parts equivalent to the body panel 174 with regard subsidiary parts and accessories such as (at least) the attachment edge 174a (FIG. 80B), bottom end 174x (FIG. 84A), hinge area 144a (FIG. 80A), keyboard 143 (FIG. 84B), electrical connections 64g (FIG. 84A and FIG. 84B), (hinge) electrical connection 64s (FIG. 80B), controls 47 (FIG. 84C), body panel length 4d (FIG. 85), attachments 89g (FIG. 80B), transmitter or receiver 52d (FIG. 84B and FIG. 84C), operator body interface 90 (FIG. 84B, FIG. 85 and FIG. 88C), right and left edges 148b, 148c (FIG. 80B).

FIG. 86 shows that the display panel may, alternatively, be slidably attached to the operator body prop (or body panel if electronics included) with the display panel sliding down into or along side the prop for a storage position or up out of the prop for prop use in an operating position. In this case, the operator body prop 174p (or, alternately, a body panel with electronics) may be a box-like structure that may cover the display 45 for protection. It may have a front display protector 18a for protecting the display, a bottom end 174x wall (hidden but shown with a dotted line) and one or more sides 17. The bottom end may include a bottom operator body interface 90 (previously described). The assembly may include match guides 79a on the operator body prop and display panel to direct the sliding of the two panels together. The assembly may include match stops 181a on the operator body prop and display panel to hold the display panel and prop (body panel) together in an operating or storage position. The stops may allow pivoting of the display panel when in an operating position. Arrangements including a body panel may include the same attributes of the pivoting body/display panel arrangement, including a computing unit, battery or other electronics in the body panel.

FIG. 87A, FIG. 87B and FIG. 87C show two support frames that may hold and convert a standard tablet computer or display panel into a wearable computer or image viewer similar to that described in FIGS. 83 to 85 and FIGS. 88 to 91. In FIG. 87A, a tablet computer 200c (which may, alternatively, be a two panel folding notebook computer folded open flat) is shown positioned to be held in the support frame 11b using the grasping part 185c of the support frame. This part is designed to temporarily grasp or hold a display panel or tablet computer in the grasping part of the support frame and may include a display panel fastener, such as a latch or a friction fitting (such as friction knobs 181c (FIG. 87B)) for this purpose. There is an operator body prop 179p part of the support frame extending away from the grasping part and between the computer or display panel held in the grasping part and the body (front torso area) of the operator. The grasping part bottom end 16b (FIG. 87B) is attached or joined to the operator body prop attachment edge 174a (FIG. 87B). The grasping part and the operator body prop may be fused together as one part (FIG. 87A). The support frame includes a strap or a means to attach a strap, such as a strap attachment 5a, attached near the junction of the grasping part and the operator body prop. A strap attached to the support frame suspends or stays the support frame by the operator's head/neck/shoulder area while the bottom end of the operator body prop contacts the operators front torso area. The operator body prop extends to the display panel and holds the display 45 in the view of the operator without using hands (see FIGS. 83, 90 and 91). The location of the connection of the strap or the strap holder may be near the connection of the grasping part and the operator body prop, for example, near the operator body prop attachment edge or near the grasping part bottom end. This allows good support of the assembled display panel/support frame while allowing full access to the display panel held in the grasping part. The bottom end of the operator body prop may be supplemented by a bottom end adjustment mechanism 174q which may increase the length (see 4d, FIG. 85) of the operator body prop between its attachment edge and its bottom end in order to better position the display in the view of the operator. The bottom end adjustment mechanism may be attached to the holder (e.g. holder bottom, back, sides or front) and may include a sliding or pivoting bar or panel to supply extra length. The bottom end adjustment mechanism may include a body panel, operator body prop, holder or display panel bottom operator body interface. FIG. 87B (here shown as a support frame made of strong (metal) wire but may alternatively be made of made of, for example, plastic or metal panels, molded metal, polypropylene, other plastic or plastic foam (e.g. styrene)) shows that the grasping part of the support frame and the operator body prop may be two separate parts designed to be pivotally joined at hinge parts 54 so that the support frame, with or without the display panel, may be folded to reduce size or protect the display. A hinge latch 181d or friction hinge may be included to hold the two parts in a relative angular position. The operator body prop bottom end 174x may include an operator body interface (see FIGS. 85 and 89). FIG. 87C is a magnified portion of FIG. 87A showing that the one piece molded support frame may be made of a semi-rigid material (e.g. plastic such as polypropylene) and, as an alternative to one monolithic piece, may include a flexible section to act as a hinge 54 and allow adjustment of the grasping part to operator body prop part relative angle 110b and improve display viewing characteristics. This may be used in combination with the hinge lock 181d of FIG. 87B.

FIG. 88 to FIG. 91 shows a one panel wearable computer or computer remote control viewer adapted to be worn by an operator with the display 45 readily visible in an operating position without using hands and also easily manipulated even when the operator has dirty hand, as in the case of cooking. The computer or computer remote control viewer may be washable and may include a computing unit, batteries, radio communication and/or display/control transmitter and/or receiver 52d (see FIG. 85) for separate computer remote control. The computer or computer remote control viewer may be a system by including one or more remote transmitters and/or receivers, separate computer and electrical connections.

The wearable computer is shown in FIG. 88A front view, FIG. 88B back view and FIG. 88C a magnified view of the bottom edge area of the computer. The wearable computer or remote control viewer is comprised of a display panel 13 having a front side 40 which may be divided into a display portion 13a, including the display 45, and an extension portion 51, the two portions meeting at a junction 13b. The display panel length is the sum of the lengths of the display portion and extension portion (13a+51) as shown with the braces. The display may extend further onto the extension portion. The side opposite the front side is the back side 41 which may include one or more manual computer controls. This control may be or include a pointing device 47 and point clicker button 48a, a scrolling slide 48c, magnification and/or demagnification button 48b. The controls may be recessed or have raised finger guides 49 for finding controls with the operator's fingers on the back of the display panel. The display panel, display and controls may be waterproof.

The computer display panel may have side edges, for example a right side edge 44a and a left side edge 44b, and may include one or more strap attachments 5a on the display panel side edges or back side. The strap attachment may be located on the panel about mid-way 40a between the top edge 43 and the bottom edge 42a of the panel or near the junction 13b of the display portion 13a the extension portion 51 of the display panel.

The computer may include an electrical connection 64, shown here as a socket, for recharging and programming from a source external from the computer. This electrical connection may be configured to be waterproof using, for example, a waterproof seal 171a such as a waterproof plug or cap.

The bottom edge 42a of the computer display panel 13 may include a display panel bottom operator body interface 90 adapted to temporarily hold the panel bottom edge to the operator. Examples of this interface may include a friction or gripping surface, one or more legs, shaping, attachments such as a bar or hole, hook, clip, “D” ring, strap, snap, magnet or other means to temporarily join the bottom edge to the operators body (see FIG. 68). The display panel may include a bottom end adjustment mechanism (see 174q, FIG. 87A) to increase display panel length and better position the display in the operator's view

Shown in FIG. 89, the front side of the panel may include structures to protect the display such as one or more thumb guards 49a to the sides 45b of the display to keep dirty thumbs or fingers from smearing the display. The display panel may include a display top edge spacer 43a (near the top edge of the display panel) and/or a display bottom edge spacer 43b (near a bottom edge 45a of the display) to hold the display away from the operator's body when the panel front side is pressed against the operator's body when the display is not in use and computer is in a temporary storage position (see FIG. 90B) because the operator wants maximum view of the work area (e.g. a counter) in front of him. The various guards and spacers around the display may join to form a continuous border protecting the display.

The bottom edge of the panel may be shaped 51d to better contact an operator's body, may include one or more legs 51c, and/or may include other types of display panel bottom operator body interfaces 90.

One or more strap attachments 5a may be located on the display panel right edge, left edge, on the back side or front side so as to position the strap near the right and left side edges of the display panel or maybe located half way between the right edge and left edge for a single point strap attachment 5b.

An operator 73 is shown using the one panel wearable computer display panel 13 in side views FIG. 90A and FIG. 90B and front views FIG. 91A and FIG. 91B. For operation, the computer display panel may be worn using a strap 5 holding the display panel to the operator's head/neck/shoulder area. The strap suspends the display panel while the bottom edge 42a of the display panel contacts the operator's body front torso area. The extension portion extends to the display portion and holds the display panel in an operating position with the display in the view of the operator.

FIG. 90A shows the computer display panel 13 in operating position in the view 183 of the operator and the bottom edge of the display panel against his torso area. In FIG. 90B the operator has moved the computer to a temporary storage position against his body to increase his vision in his work space. A guard or spacer (for example, top edge spacer 43a) keeps the display from touching the operator's apparel and being smudged.

In front view FIG. 91A the operator 73 is using the computer display panel 13 in operating position. In FIG. 91B the computer is removed showing that the operator may wear apparel 73a specifically to match the computer, in this case an apron with one or more attachable objects 90i to match the display panel bottom operator body interface of the computer.

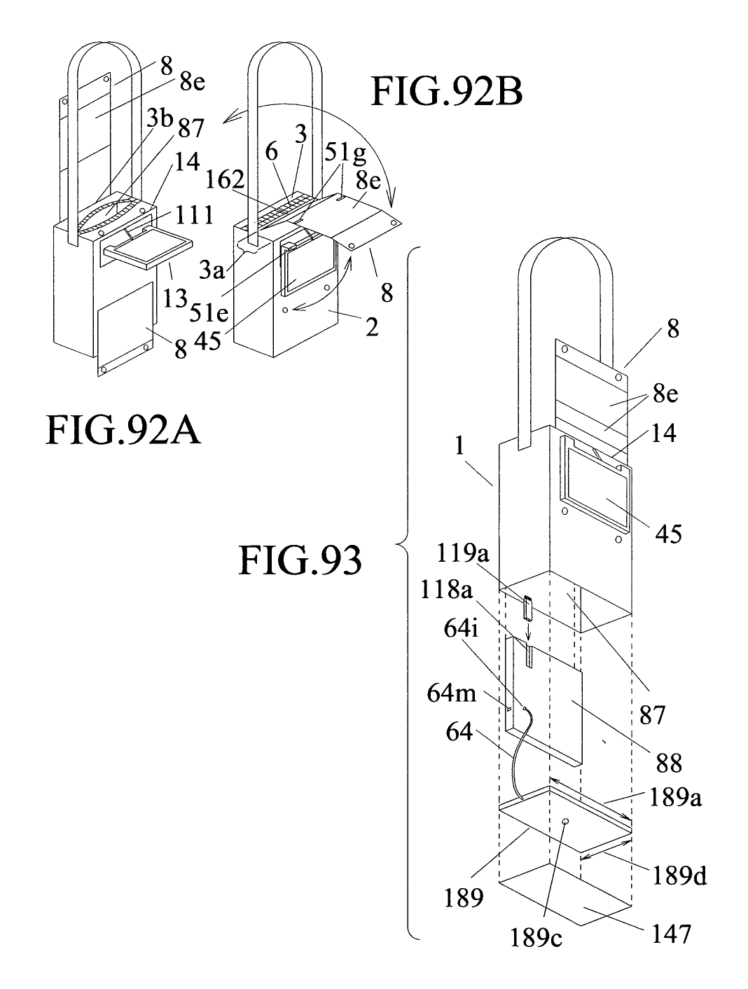

FIG. 92 to FIG. 97 show that there may be various bag computer accessories installable to the bag computer. FIG. 92 shows that these installations may be done through the top opening 6 of the bag to the interior 87 of the bag 1. In this figure the display panel 13 is attached to the bag using an attachment filament 111 PCEM.

FIGS. 92A and 92B are 2 views of the bag computer. FIG. 92A shows the bag with a display panel 13 pivotally attached to the bag near the top front edge 14 (also called junction of the top and front walls) using a filament retainer 111 which may double as an electrical connection. The top wall's top opening is open allowing access to the bag interior 87. A cover 8 is shown attached to the bag near the bottom of the computer equipment storage area. Alternatively, the cover may be attached to the bag to the back wall 148 (FIG. 97) or at the junction 3b of the top wall and the back wall. The cover may have one or more sections 8e which may be rigid or reinforced to protect the display when in storage position on the front wall. FIG. 92B shows the bag with the display panel in a storage position with the display 45 facing away from the bag front wall 2. The cover proximal edge 162 is attached to the top wall 3 about half way 3a between it's junctions with the back wall and the front wall thus leaving the top opening 6 available for use while the cover is covering the display panel. The cover 8 may have rigid or reinforced sections 8e and may include openings 51g to allow vertical operating position props 51e to pass through and allow the cover to lay flat next to the display panel.

Shown in FIG. 93, one accessory may be a bag bottom shaped battery 189 which may be constructed to fit the bottom wall 147 of the bag so it does not shift and is at a low center of gravity. In this exploded view the bag bottom wall and computing unit panel 88 are removed downward so the bag interior 87 and the shape of this bag bottom shaped battery can be seen. The battery is removable from the bag and has an electrical connection 64 (for example an appropriate length of wire and terminal connector matching the computing unit panel) adapted to lead to and connect with the computing unit panel and its electrical power connection 64m. The battery's shape along the plane of the bag bottom wall and its dimensions along the inside of the bottom and side wall junction 189a and along the inside of the bottom and front wall junction 189d match the bag bottom wall. The top to bottom dimension may vary according to the battery size. The battery may include one or more attachment fixtures 189c to match attachment fixtures 190a (FIG. 97) on the bag bottom wall and hold the battery and bag bottom wall together.

FIG. 93 also shows that the computing unit panel may include a electrical module receptacle 118a which is designed to hold a removable telecommunications related module 119a such as a local or remote network linked radio transmitter and/or receiver or SIM module and electrically connect this module to a computing unit or other telecommunications equipment in the computing unit panel and/or bag computer.

Also shown in FIG. 93, the pivoting cover 8 may be attached to the bag near the top of the bag, for example, near the junction 14 of the bag's top wall and front wall and arranged to pivot and cover the computer equipment storage area. The cover may have one or more rigid panel segments 8e extending horizontally right to left so as to protect the display 45 while it is in the storage area and may be arranged to articulate the cover in locations allowing the cover to fit both the bag while the cover is open and computer equipment in the storage area while the cover is closed.

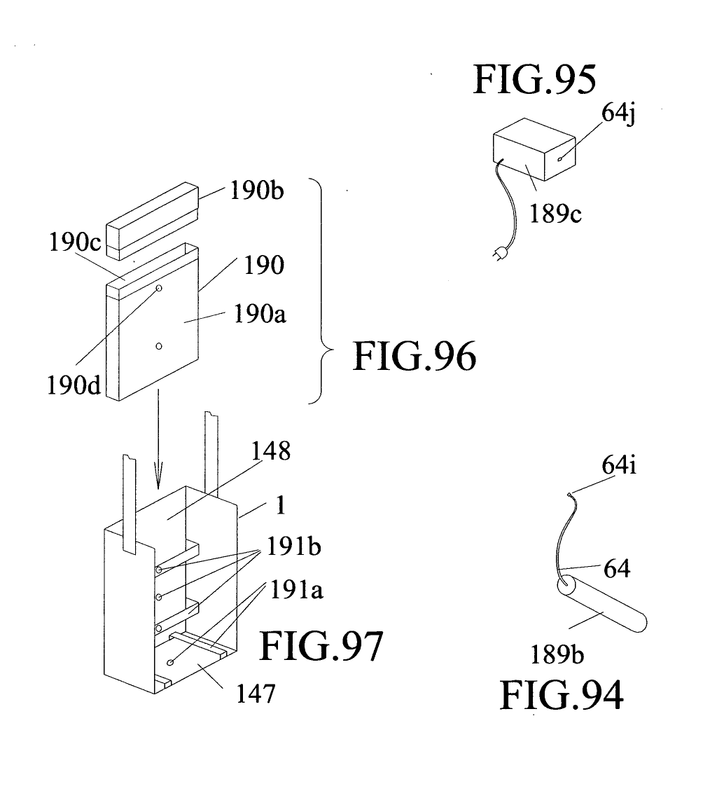

Alternatively, shown in FIG. 94, the battery may be of comprised of one or more standard size and shape batteries with matching battery canister 189b including an electrical connection 64 adapted to lead to the computing unit panel from the bottom of the bag where the canister will rest. FIG. 95 shows that these batteries may be configured to match a battery charger 189c including an electrical connection 64j to match the electrical connection terminal 64i of the bag bottom shaped battery and/or battery canister.

FIG. 96 shows another accessory, a fitted rigid document container 190 adapted to fit the bag. The document container may have several rigid or semi-rigid walls 190a defining an interior space 190c and may include a cap 190b to fully enclose the interior. The container's shape and attachment fixtures 190d may be adapted to match the shape and attachment fixtures 191b of the bag.

In FIG. 97 the front wall and top wall of the bag 1 have been removed to show the interior of the bag and show that the bag may include one or more hold down fixtures, such as straps, elastic, pocket, accessory to bag matching attachments, or other attachment means adapted to hold the accessory in place. These fixtures may include one or more battery hold down fixtures 191a to hold the bag bottom shaped battery or battery canister to the inside surface of a bag wall, such as the inside surface of the bottom wall 147, or one or more rigid document container hold down fixture 191b to hold the container to the inside surface of the back wall 148 of the bag.

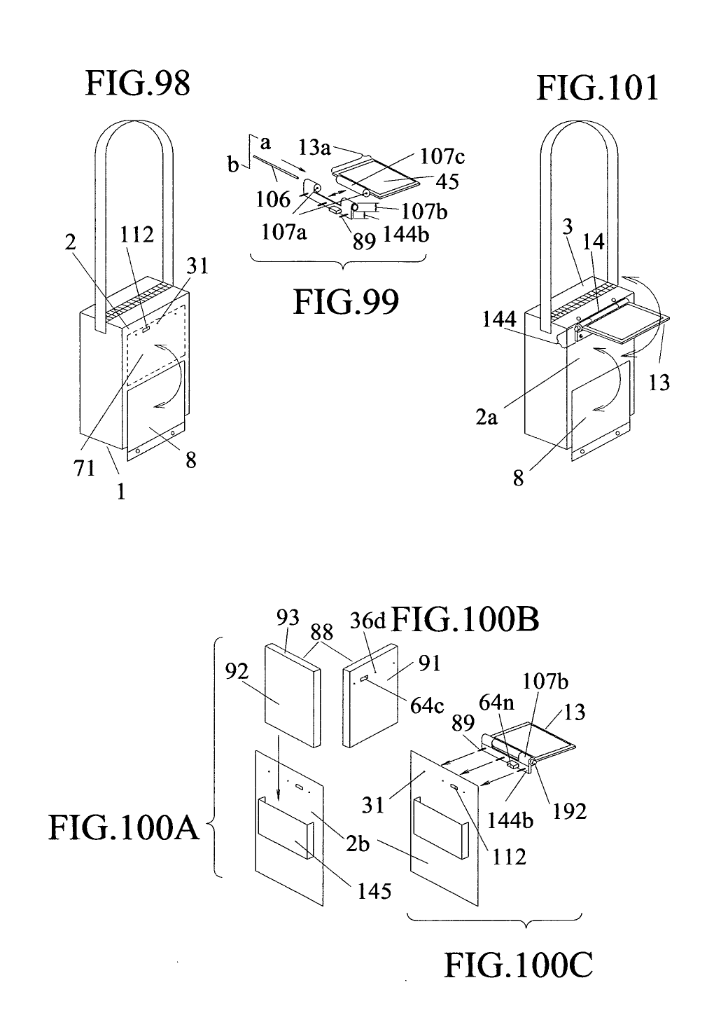

FIG. 98 to FIG. 106 show a bag computer apparatus with an axle/bearing hinge to computing unit panel display panel mount where a display panel/hinge assembly mounts solidly through the bag wall to a computing unit panel inside the bag.

FIG. 98 shows the bag 1 used to mount a computing unit panel and display panel for the bag computer. It includes a computing equipment storage area 71 on the outside of the front wall 2 for storing the display panel when in a storage position and a pivoting cover 8 to cover the computer equipment storage area and any equipment in it. Also shown are the electrical access opening 112 and one or more attachment holes 31 through the front bag wall 2 to electrically and physically attach the display panel and computing unit panel together with the bag wall between.

FIG. 99 shows the display panel assembly for mounting to the bag. It includes a display panel portion 13a and a pivoting computer equipment mount (PCEM) (see 144, FIGS. 101 and 104) comprised of a PCEM to computing unit panel coupling such as one or more projections, sockets or flanges 144b, a coupling axle housing 107b, a display panel axle housing 107c and an axle 106. The display panel portion includes a display 45 facing upward into the view of an operator wearing the bag. The display may include a touch screen and the display panel side opposite the display (the back side) may include manual computer controls such as a pointing device, touchpad, buttons, slides, etc. (see FIGS. 6A and 6C). The flange and display panel axle housings include a hole 107a which serves as a bearing for the axle and/or axle sleeve. The PCEM to computing unit panel coupling may include fasteners 89 (e.g. screws) to attach the display panel assembly to the bag and computing unit.

FIG. 100A shows the inside surface 2b of the bag front wall removed from the rest of the bag. It includes a support structure 145 suitable to hold the computing unit panel 88 to the inside surface of the bag front wall. The computing unit panel may have a top edge 93 and a back side 92 which faces away from the bag wall when attached to it. FIG. 100B shows the same computing unit panel but now it is turned so the front side 91 (side facing the bag wall when installed) is visible. This side of the panel may include an electrical connection 64c adapted to match the electrical connection on the PCEM flange of the display panel assembly. This side of the panel may include one or more computing unit panel attachment parts 36d to match attachment parts on the PCEM flange of the display panel assembly and connect the flange to the computing unit panel. FIG. 100C shows the inside surface of the bag front wall 2a with the display panel assembly 13 aligned to pass its display panel assemble attachments 89 through the bag's display panel assemble attachment holes 31 and on into the computing unit panel thus connecting the display panel assembly, bag and computing unit together. It can be seen that the display panel assemble attachments are attached to (or through) the display panel assembly flange 144b which also includes a display panel assembly to computing unit panel electrical connection 64n aligned to pass through the electrical access opening 112 in the bag front wall for connection to the computing unit panel's electrical connection. Thus the display and the computing unit are electrically connected. Also shown is the coupling axle housing 107b which includes a brake control button 192.

FIG. 101 shows the bag, display panel assembly 13, including the PCEM 144, and computing unit panel (not visible) assembled. The display panel assembly is attached to the bag front wall near the top end 14 of the outside of the bag front wall 2a. The display panel may pivot from a storage position in the computer equipment storage area to one or more operating positions which may include a vertical operating position (see FIG. 65). Also shown are the bag top wall 3 and the pivoting cover 8 for the computer equipment storage area.

FIG. 102 shows a bag 1 very similar to the bag of FIG. 98 and including a computer equipment storage area 71. In this case, though, the electrical access opening 112 and one or more attachment holes 31 pass through the top bag wall 3 to electrically and physically attach the display panel assembly and computing unit panel together with the bag wall between.

FIG. 103A shows the inside surface 2b of the bag front wall removed from the rest of the bag. It includes a support structure 145 suitable to hold the computing unit panel 88 to the inside surface of the bag front wall. The computing unit panel may have a top edge 93. In this case, the top edge of the computing unit panel may include an electrical connection 64c adapted to match the electrical connection on the PCEM flange of the display panel assembly. This edge of the panel may include one or more computing unit panel attachment parts 36d to match attachment parts on the PCEM flange of the display panel assembly and connect the flange to the computing unit panel. FIG. 103B shows the inside surface of the bag front wall with the display panel assembly 13 aligned to pass its display panel assemble attachments 89 through the bag's top wall attachment holes and on into the computing unit panel attachment parts 36d thus connecting the display panel assembly, bag and computing unit together. It can be seen that the display panel assemble attachments are attached to (or through) the display panel assembly flange 144b which also includes an display panel assembly to computing unit panel electrical connection 64n aligned to pass through the electrical access opening 112 in the bag top wall for connection to the computing unit panel's electrical connection 64c. The computing unit panel fixtures for these connections are located on the top edge 93 of the computing unit panel. Thus the display and the computing unit are electrically connected. The bag top wall (not shown) is located between the display panel assembly (flange) and the computing unit panel and fixed between them.

FIG. 104 shows the bag, display panel assembly 13, including the PCEM 144, and computing unit panel (not visible) assembled. The display panel assembly is attached to the outside of the bag top wall 3 near the top end 14 of the bag front wall 2a. The display panel may pivot from a storage position in the computer equipment storage area into one or more operating positions which may include a vertical operating position (see FIG. 65). Also shown is that the pivoting cover 8 for the computer equipment storage area may include one or more attachments 70b on the cover matching attachments 70a on the flange 144b of the PCEM to keep the cover in place over the equipment in the storage area. Also show is the brake control button 192 on the PCEM flange axle housing of the display panel assembly.

FIG. 105 shows the axle/bearing hinge to computing unit panel display panel mount with the pivoting computer equipment mount parts separated and in cross section at a/b in FIG. 99 with its plane running alone the axis of the axle. The flange 144b and coupling axle housing 107b remain connected as one piece but the display panel axle housing 107c has been remove upward. The axle 106 has also been removed upward and it can be seen that it fits both the display panel axle housing and the two sleeves (both removed upward also) which slide onto the ends of the axle. The brake control button end axle sleeve 192 slides onto one end (right) of the axle and the spring end axle sleeve 192d slides onto the opposite end (left) of the axle, the end nearest the brake spring. The brake spring 192a and brake spring retainer 192b have been removed to the left. The brake spring is located in the coupling axle housing brake spring holder area 107d and provides pressure to engage the brake contact 192c (a part of the spring end axle sleeve) to the display panel axle housing. The area of the display panel axle housing that contacts the brake contact may include a friction surface such as rubber, teeth or other means to regulate the braking of the brake contact. The coupling axle housing brake control button opening 107e provides an opening to access the brake control button and move the axle and sleeve assemble.

FIG. 106A, FIG. 106B, FIG. 106C, FIG. 106D and FIG. 106E show the parts of the pivoting computer equipment mount parts assembled. In FIG. 106A, the spring holds the axle and spring end axle sleeve to the right and the brake contact 192c engages the display panel axle housing to stop rotation of the display panel so it can hold an angular position relative to the bag and its front wall when mounted to the bag. A brake lock 181 may be included to hold the brake disengaged so the display panel may pivot freely. FIG. 106C, FIG. 106D and FIG. 106E are cross section views on a plane perpendicular to the axle axis with each view above the specific area in FIG. 106A to be depicted. FIG. 106C shows the brake spring holder area of the coupling axle housing as a cylinder containing the brake spring 192a. FIG. 106D shows the area near the brake contact 192c where it passes through a coupling axle housing brake contact keyway 107f, the keyway keeping the brake contact from rotating when engaged to the display panel axle housing. FIG. 106E shows how the axle 106 is the inner concentric circle within the brake control button end axle sleeve which fits in the coupling axle housing. In FIG. 106B the brake control button 192 has been pressed and the sleeves and axle 106 move to the left compressing the brake spring 192a between the spring end axle sleeve 192d and the brake spring retainer 192b. The brake contact 192c disengages from the display panel axle housing and the display panel is free to turn to any angle relative the bag and its front wall.

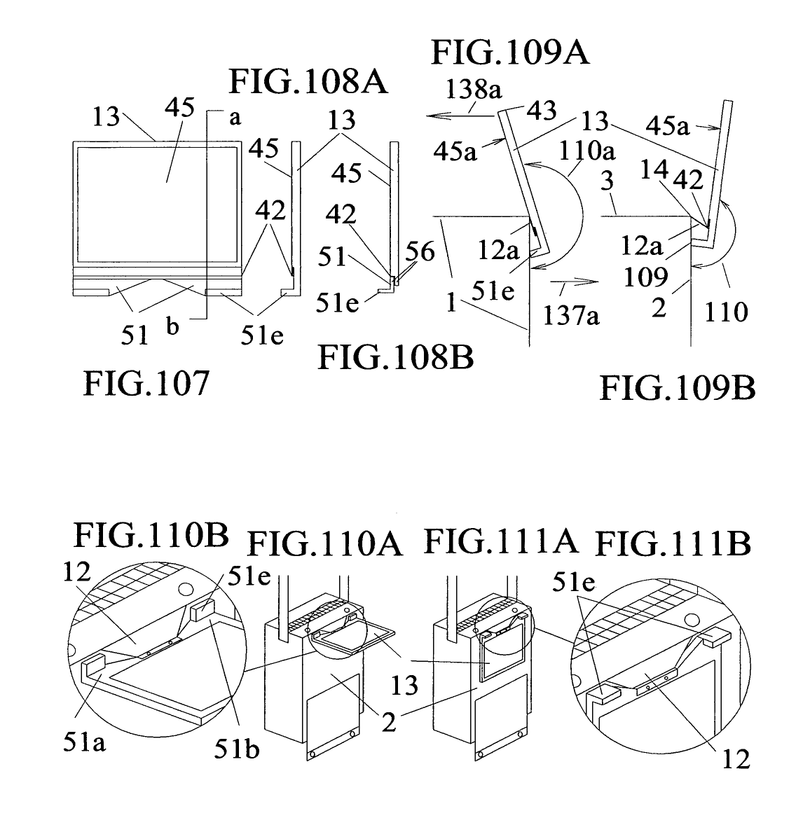

When propping a display panel on a bag using a flexible fabric pivoting computer equipment mount, the use of the display panel in a vertical operating position may be improved using a bag computer vertical operating position prop. FIG. 107 shows a front view of the display panel 13 including a display 45 where the display panel extension prop 51 is adapted to also act as a vertical operating position prop. One or more vertical operating position props 51e, here shown attached at right angles to the display panel extension prop 51, serve to improve and increase the viewing angles available in the display panel's vertical operating position.

FIG. 108A shows a cross section (a/b on FIG. 107) side view of the display panel 13 with one or more vertical operating position props 51e fixed to the display panel extension prop and projecting away from the display panel front side and the display 45 (and toward the bag when in a vertical operating position). In this case, the display panel extension props and the vertical operating position props 51e are the same structures. The attachment axis 42 (also called attachment edge) of the display panel is the place of attachment of the retainer.

FIG. 108B is the same as FIG. 108A except that one of the two jaws 56 used to clamp the retainer to the display panel attachment axis includes all or part of the display panel extension prop 51 and/or the vertical operating position props 51e. In this way, the props may be a removable (but necessary) component of the display panel.

FIG. 109A and FIG. 109B show a cross section (a/b on FIG. 107) side view of the display panel 13 now mounted to a bag 1 (top front part only is shown) near the junction 14 of the top 3 and front 2 bag walls and with the vertical operating position prop 51e in contact with the bag wall. In this vertical operating position (FIG. 109A), the vertical operating position props project away from the display panel front side toward the bag and moves the extension prop and attachment edge area of the display panel in a frontward direction 137a away from the outside of the bag front wall. With the display panel pivoting against the top edge 14 of the front wall or by the attachment axis 42, the distal edge 43 of the display panel moves in a backward direction 138a over the top wall of the bag and toward the back of the bag. Thus the vertical operating position of the display panel may be adjusted in a direction backward of vertical and greater than 180 degrees 110a from its storage position against the outside of the bag front wall.

FIG. 109B shows that the angle 110 between the display panel and the outside of the front wall can be adjusted by shifting the contact position of the vertical operating position prop end 109 on the bag front and adjusting the view of the display 45a to an operator viewing from in back of the bag and over the top of the bag's top wall 3. One or more extension props and/or vertical operating position props may be shaped or curved to assist in this function. These drawings show the display panel suspended by the free section 12a of the pivoting computer equipment mount's retainer (here shown as an attachment flap but may alternatively be a filament).

FIG. 110A shows the bag computer with the display panel 13 in an operating position. The magnification FIG. 110B shows the display panel suspended by the retainer 12 and the right extension prop 51a and the left extension prop 51b contacting the bag front wall 2. The vertical operating position props 51e are located on each of the right and left extension props and are projecting away from the display panel front side and not in use in this figure.

FIG. 111A shows the bag computer with the display panel 13 in a storage position against the bag front wall 2. The magnification FIG. 111B shows the display panel suspended by the retainer and the vertical operating position props 51e are projecting away from the bag and display panel front side. They are not in use in this figure. As shown, vertical operating position props may be located to the right and to the left of the retainer 12 (located between the two props) thus allowing the vertical operating position props to extend away from the bag and display panel front side while in the storage position without interfering with the retainer and display panel movement into the storage position.

FIG. 112 shows a bag computer with a pivoting cover 8c (outside surface) which may be rigid and includes a proximal edge 162 pivotally attached to the bag 1 front wall 2 near the bottom of the computer equipment storage area and a distal edge 161. The cover distal edge is pivotally attached to the display panel 13 attachment edge 42 with the display 45 facing up into the line of sight of a bag wearer/operator. The line A/B is the position of the cross sections for FIGS. 113 and 114. The drawing plane is aligned with the dotted line.

FIG. 113A, FIG. 113B, FIG. 113C, FIG. 113D and FIG. 113E are a series of 5 views showing a pivoting computer equipment mount arrangement including a bag computer display panel to cover 360 degree attachment loop mount. This way of mounting the display panel to the cover is simple and the display panel is easy to remove. The 5 views are: FIG. 113A, the display panel being installed to the retainer, cover and bag; FIG. 113B, the display panel partially installed to the retainer, cover and bag; FIG. 113C, the display panel installed to the retainer, cover and bag and held approximately vertical; FIG. 113D, the display panel propped in an operating position on the outside of the cover at an angle 110 relative to the cover and viewable by the operator; FIG. 113E, the display panel pivoted to beside the inside surface 8a of the cover in the storage position.

FIG. 114A, FIG. 114B, FIG. 114C, FIG. 114D and FIG. 114E are a series of 5 magnified views of FIG. 113A, FIG. 113B, FIG. 113C, FIG. 113D and FIG. 113E, respectively. In FIG. 114A, the display panel 13 is separate from the bag and about to be mounted to it with the retainer 12 bottom end 141 attached to the cover and the retainer top end 140 to be slid through the display panel sliding attachment slot 77. In FIG. 114B, the retainer is through the display panel slot and being turned around the bar 76 of the sliding attachment so it can be attached back to the inside of the cover using matching attachments 66a and 66b. In FIG. 114C, both the retainer top end 140 and bottom end are attached to the cover and they form a loop 111a of retainer material that pivotally holds the display panel sliding attachment and display panel to the cover distal end and allows it to pivot about 360 degrees. This loop of retainer material may be large enough to allow the display panel to be moved into a storage position inside the bag or to be moved into an operating position outside the bag and may include enough size to allow propping the display panel on the outside of the bag. In FIG. 114D, the display panel has been moved to the outside of the cover and is suspended by the retainer 12 loop of material while the display panel 13 prop 51 contacts the cover outside surface 8c and holds the display panel in an operating position angle relative to the cover and in the view of an operator. In FIG. 114E the display panel 13 has been pivoted counterclockwise about 225 degrees to a storage position along side the inside surface of the cover 8. It should be noted that this arrangement allows 360 degrees of pivoting for the display panel (compare with sliding mount to FIGS. 3, 4A and 26A). This arrangement may be used with the vertical operating position prop described previously (see FIGS. 107 to 111) and this sort of prop may form a handle and/or a cover for the area between the top of the cover and the bag when in storage.

In an alternative arrangement, the retainer loop (111a, FIG. 114C) may be permanent and the display panel bar (76 in FIG. 114b and FIG. 7A) may be removable from the display panel for the purpose of installing the display panel to the retainer, cover and bag (see FIG. 4A).

In an alternative arrangement, the retainer end 140 may extend to near the cover proximal attachment edge 162 and attach there (see FIGS. 8 to 16 and description). In this case, the display panel deployment includes an up/down sliding motion instead of only a pivoting motion.

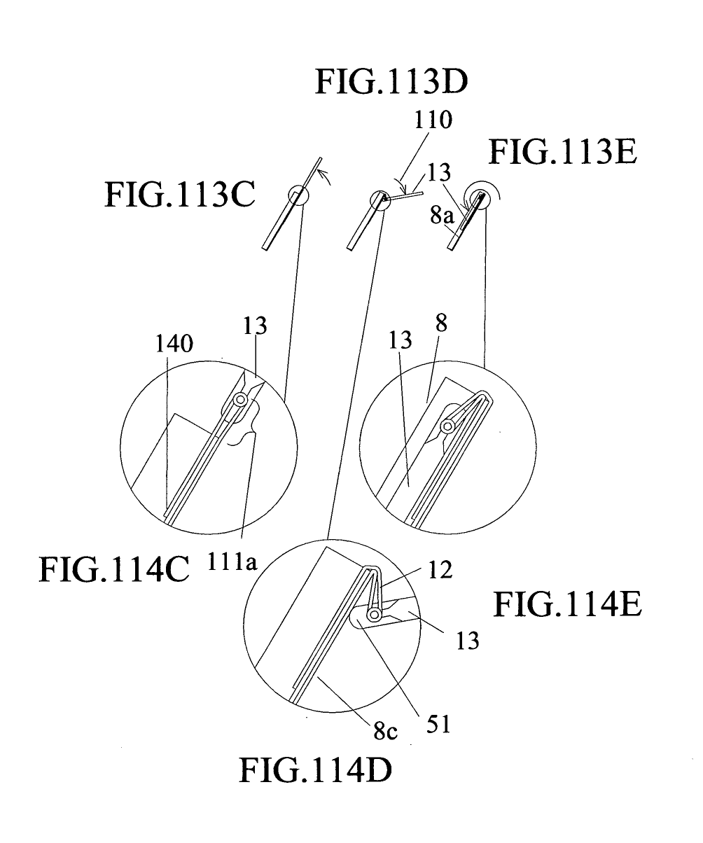

FIG. 115 shows the cover and display panel removed from the bag and showing the cover inside surface 8a. The cover may include an electrical connection 64p and mounting station 146b for a wireless (e.g. radio) microphone and/or speaker 152b (here shown as a headset) including electrical connection 64o matching the mounting station. The mounting station electrical connection may include a battery recharge connection and/or a control such as telephone answer and hang up. The mounting station for a wireless microphone and/or speaker may, alternatively, be attached to the outside surface of the cover 8c (see FIG. 112). The cover may include a battery 189 for recharging the microphone and/or speaker and electrical connection 64q for recharging the battery from an external power source. The display panel 13 may include telecommunications and local area wireless to match the wireless microphone and/or speaker. The display panel may have its own electrical connection 64r for recharging its own battery. There may be an electrical connection 68a, such as a wire, connecting the electrical equipment in the cover to electrical equipment in the display panel. In this way the cover and display panel assembly may be a simple, durable and autonomous unit for bag mounting.

1. A wearable electronic display device comprised of:
a) a display panel comprised of a front side including an electronic display, a back side and a display panel attachment edge;
b) an operator body prop comprised of an operator body prop attachment edge and an operator body prop bottom end, wherein the operator body prop attachment edge is pivotally attached to the display panel attachment edge; and
c) one or more strap attachments attached to the display device at a hinge area near the attachment of the display panel attachment edge to the operator body prop attachment edge, wherein the strap attachment is configured to attach a strap to the display device and suspend the wearable electronic display device by the strap from a head/neck/shoulder area of an operator while the operator body prop extends between the display panel and the front torso area of the operator and the electronic display in an operating position is in the view of the operator.

2. The display device of claim 1 further comprised of an operator body interface on or near the operator body prop bottom end, the operator body interface configured to temporarily hold the operator body prop bottom end to the front torso area of the operator.

3. The display device of claim 1 further comprised of a manual display control on one of the display panel back side and the display panel electronic display.

4. The display device of claim 1 further comprised of one of a radio transmitter and a radio receiver located in the display panel.

5. The display device of claim 1 further comprised of a bottom end adjustment mechanism configured to increase a length of the operator body prop to better position the display in the operator's view.

6. The display device of claim 1 wherein the operator body prop is further comprised of keyboard.

7. A wearable electronic display device and computer remote control system comprised of:
a) a display panel comprised of a front side including an electronic display, a back side, a display panel attachment edge, one or more manual display controls and one or more display/control radio telecommunication units;
b) an operator body prop comprised of an operator body prop attachment edge and an operator body prop bottom end, wherein the operator body prop attachment edge is pivotally attached to the display panel attachment edge;
c) one or more strap attachments attached to the display device at a hinge area near the attachment of the display panel attachment edge to the operator body prop attachment edge, wherein the strap attachment is configured to attach a strap to the display device and suspend the wearable electronic display device by the strap from a head/neck/shoulder area of an operator while the operator body prop extends between the display panel and a front torso area of the operator and the electronic display in an operating position is in the view of the operator; and
d) one or more remote radio telecommunication units configured to electrically connect to a remote separate computer and radio telecommunicate information with one or more display/control radio telecommunication units.

8. The display and control system of claim 7 further comprised of an operator body interface on or near the operator body prop bottom end, the operator body interface configured to temporarily hold the operator body prop bottom end to the front torso area of the operator.

9. The display and control system of claim 7 wherein the manual display control is located on one of the display panel back side and the display panel electronic display.

10. The display and control system of claim 7 further comprised of a computer electrically connected to one or more remote radio telecommunication units, the computer and remote radio telecommunication unit located in the same housing.

11. The display and control system of claim 7 wherein and remote radio telecommunications unit telecommunicates one of display information, manual control information, audio information and keyboard information with the display/control radio telecommunications unit.

12. The display and control system of claim 7 further comprised of a bottom end adjustment mechanism configured to increase a length of the operator body prop to better position the display in the operator's view.

13. The display device of claim 7 wherein the operator body prop is further comprised of keyboard.

14. A wearable support frame for an electronic display panel comprised of:
a) a grasping part comprised of a grasping part bottom end and configured to hold an electronic display panel;
b) an operator body prop comprised of an operator body prop attachment edge and an operator body prop bottom end, wherein the operator body prop attachment edge is attached to the grasping part bottom end; and
c) one or more strap attachments attached to the support frame near the attachment of the grasping part bottom end to the operator body prop attachment edge, wherein the strap attachment is configured to attach a strap to the support frame and suspend the wearable support frame by the strap from a head/neck/shoulder area of an operator while the operator body prop extends between the grasping part and the front torso area of the operator and a display of the electronic display panel is in the view of the operator.

15. The support frame of claim 14 further comprised of an operator body interface on or near the operator body prop bottom end, the operator body interface configured to temporarily hold the operator body prop bottom end to the front torso area of the operator.

16. The support frame of claim 14 wherein the junction between the grasping part bottom end and the operator body prop attachment edge is configured to adjust the viewing angle of the display panel.

17. The support frame of claim 14 wherein the grasping part bottom end and the operator body prop attachment edge are pivotally attached using a hinge.

18. The display device of claim 14 further comprised of a bottom end adjustment mechanism configured to increase a length of the operator body prop to better position the display in the operator's view.

19. A wearable holder for a computer with two pivotally attached panels comprised of:
a) a holder comprised of a top end, a bottom edge, a right edge, a left edge and a back wall including a top end and an inside surface;
b) one or more computer body panel attachments attached to the holder and configured to hold a first panel of the computer with two pivotally attached panels to the holder while a second panel of the computer with two pivotally attached panels pivots on the first panel near the top end of the holder into an operating position;
c) one or more strap attachments attached to the holder, wherein the strap attachment is configured to attach a strap to the holder near the top end of right edge and near the top end of left edge and suspend the holder by the strap from a head/neck/shoulder area of an operator while the holder extends between the strap attachment and a front torso area of the operator and a display on second panel of the computer with two pivotally attached panels in an operating position is in the view of the operator; and
d) an operator body interface on or near the holder bottom edge, the operator body interface configured to temporarily hold the holder bottom edge to the front torso area of the operator.

20. The wearable holder of claim 19 further comprised of one or more attachments on the holder and matching the body panel, wherein the attachments hold the body panel to the holder.

21. The wearable holder of claim 19 wherein the computer body panel attachment is a socket comprised of the back wall, a bottom wall, a front wall and one or more side walls.

22. The wearable holder of claim 19 further comprised of a pivoting cover, wherein the cover covers the back wall inside surface while in closed storage position.

23. The wearable holder of claim 19 further comprised of a bottom end adjustment mechanism configured increase a length of the holder to better position the display in the operator's view.

24. A wearable electronic computing device comprised of:
a) a display panel comprised of a front side including an electronic display, a back side and a display panel attachment edge;
b) a body panel comprised of a body panel attachment edge and a body panel bottom end, wherein the body panel attachment edge is pivotally attached to the display panel attachment edge;
c) a holder comprised of a top end, a bottom edge, a right edge, a left edge and a back wall including a top end and an inside surface, wherein the holder fits the body panel;
d) one or more body panel attachments attached to the holder and configured to hold the body panel to the holder, wherein the body panel attachment edge is positioned near the top end of the holder;
e) one or more strap attachments attached to the holder, wherein the strap attachment is configured to attach a strap to the holder near the top end of the holder right edge and near the top end of the holder left edge and suspend the holder by the strap from a head/neck/shoulder area of an operator while the holder extends between the strap attachment and a front torso area of the operator and the electronic display in an operating position is in the view of the operator; and
f) an operator body interface on or near the holder bottom edge, the operator body interface configured to temporarily hold the holder bottom edge to the front torso area of the operator.

25. The computing device of claim 24 further comprised of a manual computer control on one of the display panel back side and the display panel electronic display.

26. The computing device of claim 24 further comprised of a keyboard on the body panel.

27. The computing device of claim 24 further comprised of one of a radio transmitter and a radio receiver.

28. The computing device of claim 24 further comprised of an electrical connection between the display panel and the body panel.

29. The computing device of claim 24 further comprised of a bottom end adjustment mechanism configured increase a length of the holder to better position the display in the operator's view.

30. A wearable electronic computing device comprised of:
a) a display panel comprised of a front side including an electronic display, a back side and a display panel attachment edge;
b) a body panel comprised of a body panel attachment edge and a body panel bottom end, wherein the body panel attachment edge is pivotally attached to the display panel attachment edge; and
c) one or more strap attachments attached to the computing device at a hinge area near the attachment of the display panel attachment edge to the body panel attachment edge, wherein the strap attachment is configured to attach a strap to the computing device and suspend the wearable electronic computing device by the strap from a head/neck/shoulder area of an operator while the body panel extends between the display panel and a front torso area of the operator and the electronic display in an operating position is in the view of the operator.

31. The computing device of claim 30 further comprised of an operator body interface on or near the body panel bottom end, the operator body interface configured to temporarily hold the body panel bottom end to the front torso area of the operator.

32. The computing device of claim 30 further comprised of a manual computer control located on one of the display panel back side and display panel display.

33. The computing device of claim 30 further comprised of one of a radio transmitter and a radio receiver for computer remote control.

34. The computing device of claim 30 further comprised of a bottom end adjustment mechanism configured to increase a length of the body panel to better position the display in the operator's view.

35. The computing device of claim 30 further comprised of a keyboard on the body panel.

36. The computing device of claim 30 further comprised of an electrical connection between the display panel and the body panel.

37. A wearable electronic computing device comprised of:
a) a display panel comprised of a top edge, a bottom edge, a right edge, a left edge, a front side including an electronic display and a back side opposite the front side;
b) one or more strap attachments attached to the display panel, wherein the strap attachment is configured to attach a strap to the display panel near the display panel right edge and near the display panel left edge and suspend the display panel by the strap from a head/neck/shoulder area of an operator while the display panel extends between the strap attachment and a front torso area of the operator and the electronic display in an operating position is in the view of the operator, and
c) an operator body interface on or near the display panel bottom edge, the operator body interface configured to temporarily hold the display panel bottom edge to the front torso area of the operator.

38. The computing device of claim 37 further comprised of operator apparel including one or more attachable objects matching the operator body interface on the display panel.

39. The computing device of claim 37 further comprised of a manual computer control on one of the display panel back side and the display panel's electronic display.

40. The computing device of claim 37 further comprised of one of a display top edge spacer and display bottom edge spacer configured to hold the display away from an operator's front torso area while in a temporary storage position.

41. The computing device of claim 37 further comprised of one or more thumb guards to protect the display from finger smudging.

42. The computing device of claim 37 further comprised of an electrical connection for external equipment, the electrical connection configured to be waterproof.

43. The computing device of claim 37 further comprised of one of a radio transmitter and a radio receiver for computer remote control.

44. The computing device of claim 37 further comprised of a bottom end adjustment mechanism configured to increase a length of the display panel to better position the display in the operator's view.
